(19) United States
(12) Patent Application Publication
(10) Pub. No.: US 2009/0018934 A1
(43) Pub. Date: Jan. 15, 2009

(54) System and Method for defense ID theft attack security service system in marketing environment

(76) Inventors: Chaorong Peng, Selma, NC (US); John Hortis, Selma, NC (US)

Correspondence Address: Chaorong Peng, 702 Howell Street, Selma, NC, 27578, US

(21) Appl. No.: 11/749,062

(22) Filed: May 15, 2007

(51) Int. Cl. G06Q 10/00; G06Q 20/00

(52) U.S. Cl. 705/30

(57) ABSTRACT

Each service system with a variety of databases in marketing environment maintains and audits purchasing transaction data to look for ID theft and transmits suspicion events to security service system which is attached to marketing environment. Security service system maintains status data and identifies information including biometric identity, portable device identity, and message to defeat ID-theft attacking. Identifying events is transmitted to service systems for derived information to reflect operation. Services systems include Insures Service Systems, Bank Service Systems, Business Service Systems, and Portable Devices under Security Service Systems monitoring in marketing environment. And also a portable device with a local CPU, memory, I/O interface, wireless network and a host interface provides user for purchasing transaction with merchant. A portable device retains pertinent purchasing transaction data and establishes personal account in memory to aid person analyzes with the collected data and identify potential ID theft attacks in the marketing environment.

### FIELD OF THE INVENTION

The present invention relates generally to prevent and counterattack ID theft attack security service system in marketing environment and in particular to utilize a portable device for establishment automatic management of personal account regarding pertinent purchasing transaction with merchant. More particularly, the present invention relates to a method, system and program product for monitoring, detection, and defeat attacking from ID theft without victim knowledge during purchasing transaction.

### BACKGROUND

Today, companies need to take security very seriously because the expectations of their customers, and the marketplace in general, are on the increase. Companies that do not take it seriously do so at their own peril. Where large sums of money are concerned, it is advisable to trust no one. That is a statement that no business would ever want to hear from its customers. Millions of account records are lost or stolen each year because of the vulnerability of the security system and methods of protection of the personal information of the customer. Many customers become victims of ID theft each year. Incredible losses of money for each person from identity fraud per year significantly increase, and it is very difficult to resolve these identity fraud claims. There are horror stories of many identity fraud victims taking months, even years to resolve their cases and re-establish their reputations and credit ratings.

Identity theft, a pernicious crime that harms consumers and our economy, occurs when individuals identifying information is used without authorization in an attempt to commit fraud or other crimes. Identity thieves utilize different ways to steal personal information.

A). Identity thieves use illegal access through the Internet to data contained in a computer system by a person(s) external to the breached entity.
B). Identity thieves can use the theft of computers, computer equipment (including computer data storage media), or paper files to obtain identifiers information.
C). Identity thieves can use machines that allow sensitive personal information to be viewed by those who should not have access (for example, printing of Social Security Numbers on address labels, inadvertently making sensitive personal information accessible on Internet sits that can be viewed by the general public, or not properly disposing of files containing sensitive personal information).
D). Identity thieves can use financial account identifiers, such as credit card or bank account numbers, to commandeer individuals existing accounts to make unauthorized charges or withdrawals.
E). Identity thieves can use accepted identifiers like Social Security Numbers (“SSN's”) to open new financial accounts and incur charges credit in an individual's name, but without that victim knowledge.
F). Identity thieves can attack a customer's credit card to steal credit card identity in public places.
G). Identity thieves can use data storage media containing sensitive personal information lost in the process of transferring the media to another location.

This creating significant security vulnerability since the user's personal information appears on a loan application. Names, social security numbers, birth dates, passwords, or credit card numbers, etc., can be captured by the identity thieves who then choose victims who personal information is later abused by hostile parties. Attacks of this sort have happened in our lives.

The victims are not limited by to any particular area. Identity theft is a worldwide issue because of failure of the system and methods used between the clients and the companies.

An identity thief is also called an ID-theft. Their identity can be an insurant, merchant, banker, security officer and customer, etc. It is very hard to identify whom the ID-theft is where the attack will come from. ID-theft utilizes the significant breaches in the system and methods which generate ID-theft attacks as following detail:
1). ID-theft can pretend to be the customer and utilize stolen credit card identity to make a transaction with the merchant. For example, to purchase goods/services online or by telephone. The merchant then transmits receipt of customer to the bank. There is no system to provide special service to identify whether this receipt is valid before victim received statement regarding charges from the bank.
2). ID-theft can be the employee or merchant in Business Company and abuse the personal information including credit card identity of the customer to transmit receipt of victim to the bank without victim's knowledge. There is no system to provide special service to identify whether this receipt is valid before victim received statement regarding charges from the bank.
3). ID-theft can be employee to work in Insurance Company and abuse personal information with some dishonest employees in Business Company together. A receipt of victim is transmitted to the bank. There is no system to provide special service to identify whether this receipt is valid before victim received statement regarding charges from the bank.
4). ID-theft can be employee to work in Bank Company and change the statement of the victim. There is no system to provide special service to identify whether these statement charges are valid before victim received statement charges from the bank.
5). ID-theft can utilize software technology to access computers of bank service system to transfer money from target account to another account. There is no system to provide special service to identify whether this transfer information is valid before victim received transfer statement from the bank.
6). ID-theft can utilize technology and abuse personal information and password to withdraw money from ATM machine. There is no system to provide special service to identify whether this withdrawal information is valid before victim received withdrawal statement from the bank.
7). Because the credit card machines or ATM machines are public machines for any one to use, ID-theft stolen personal information and password, and then it is very easy successful to abuse personal information and password for ID-theft without victim knowledge. There is no personal device to provide special service that utilizes personal device instead of public machine to identify and defend against ID-theft attack.
8). The ID-theft attacking is easy successful, also because victim received statement charges from the bank too late. There is no personal device to provide special service that helps victim to identify and defend against ID-theft attack immediately.
9). Victim may forget receipt information that she/he purchased transaction with merchant such as she/he loses the receipt information from merchant. There is no personal device to provide special service that stores receipt information and manages the personal account of victim to identify and defend against ID-theft attack.

### SUMMARY OF THE INVENTION

However, according to transmitting personal and credit card information with public device or machine such as credit card machine, ATM machine etc, since same public device or machine are provided to operator and cause any type of data by manipulating a controller—operator, there may be cases where data having false contents are transmitted by operator.

Moreover, It is very easy to forget receipt, especially if purchasing a rich array of product person more than perhaps they are age. Thus, it is very difficult to refrain from any payment including some counterfeit receipt data after one month.
During Customers purchase pertinent transaction with merchant, there are no security service systems to prevent and defend against ID theft attack. It is indecisive factor for security service system in marketing environment. Thus, it is impossible for service system to monitor process, collate relative data and analyze data during purchasing transaction process.

Therefore, the present invention addresses or solves the above and/or other problems in the related system and art methods as following:

Preferred according to the present invention service systems including service systems such as payer's bank service system, payee's bank service system, insures service system, business service system and security service system are provided to customer who obtains service from present invention. In this present invention, a portable device is provided to general relative present invention service systems and methods for enhancing defense ID-theft attack in marketing environment. The portable device is called an Automatic Management Personal Account device (AMPA device). AMPA device to be used by customer for purchasing goods/service; storing information which include credit card information, personal account information, receipt information; and calculating total charges fee and account balance etc.; and creating Electrical Text for payment or withdrawal with ATM machine to defense attack from ID theft using public device. Moreover, after person purchased goods/service, person will receive and respond receipt data immediately to prevent and defense potential ID theft attack.

Furthermore, according to the present invention system and art method, security service systems has service system databases to store data which are needed to provide the desired security service system functionality and may include, for example, received purchasing transaction information, or maintained transaction information from other service systems or personal device. When a question is issued by someone such as a customer, banker, insurant or merchant about the problem which may be attacked by potential ID-theft during purchasing transaction and/or payment processing/or withdrawal processing, the stored data in security service system database must be evidenced and identified for pertinent purchasing transaction so as to cause the security service system to indicate the question point at issue and defend against ID-theft attack. And also security service system establishes biometric identity database to store data which are needed to identify authority person having using registered personal portable device to prevent ID theft attack before purchasing transaction.

1. The present invention provides Defense ID-theft attack security service system in which it is determined whether user uses an AMPA device having registered, so that only a registered AMPA device can be utilized to purchase transaction in marketing environment. In accordance with the invention, users are allowed the authority to utilize the registered AMPA device through entrance into an arbitrary place, or the like so the AMPA device can be conveniently used.

According to a first aspect of the present invention, there is provided insures service system in Defense ID-theft attack security service system to provide a specific responsible service to offer unique AMPA device to customer and issue authority user having the use registered AMPA device. And moreover, insures service system provides service station which is called register AMPA device service. So that customer can obtain specific services in registering AMPA device or solution problem about AMPA device at register AMPA device service.

A determination AMPA identity is transmitted from insures service system to security service systems and it is stored in system database of security service system to help security service system future identifying whether the AMPA device, which is used by a customer, having been registered. The specific service is provided in response to an AMPA device having registered issued from an AMPA device user who has been determined as having the user authorized or from other service system in Defense ID-theft attack security service system.

With such a configuration, a determination device as a part of security service system can determine whether the AMPA device having registered to be used for purchasing transaction in marketing environment. If the AMPA device has been registered, the security service system can provide the specific service in response to the AMPA device having been registered issued from an AMPA device user or from other service system.

A person not having a registered AMPA device cannot be allowed to use for purchasing transaction in marketing environment. Only a registered AMPA device is allowed to use purchasing transaction. Thus, it is possible to restrict use of the service by unqualified AMPA device, thereby helping to reduce or prevent the occurrence of ID-theft attack.
2. In order to first aspect of the present invention, the second aspect of the present invention provides a security service system to determine whether user who has authority utilizes a registered AMPA device, so that only user having the use authority can utilize a registered AMPA device for pertinent purchasing transaction.

According to a second aspect of the present invention, there is provided a security service system to provide a specific service in response to the biometrics identity such as signature identity issued from a registered AMPA device of user having the use authority. A determination device as a part of security service system identifies to determine whether a registered AMPA device of user has the use authority based on the biometrics identity information which is stored in system database of security service system. The specific service is provided in response to biometrics identity issued from an AMPA device of user who has been determined as having the use authority to access memory of a registered AMPA device.

According to first aspect of the present invention, insures service system provides special service such as register AMPA device service provides special service in responsive to register AMPA device and also transmitted biometrics identity of user to security service system

With such identifying, a determination device as a part of security service system can determine whether the user has the use authority of registered AMPA device. If the user has the use authority, the security service system can provide specific service in response to biometrics identity issued from registered AMPA device of user who can use the registered AMPA device to purchasing transaction in marketing environment.

Since a person having no the use authority cannot be allowed to obtain service in defense ID-theft attack security service system and also to access into personal account file which is stored in memory of AMPA device, only an authentic person is allowed to have the use authority. Thus, it is possible to restrict use of the service by ID-theft persons, thereby helping to reduce or prevent the occurrence of ID-theft attack.

3. In the present invention there is provided an embodiment device of registered an AMPA device wireless interface for user wireless communication with Defense ID-theft attack security service system, so that the receipt information for evidence to prove that customer had purchasing transaction with merchant is transmitted to a registered an AMPA device of only users having the use authority to verify and respond to receipt information issued from payee's bank service system. According to a third aspect of present invention, there is provided a payee's bank service system to provide a special service in respond to receipt information issued from business service system which provides purchasing goods/service to customer. And also payee's bank service system retransmits receipt information to an AMPA device of user. An authorized user verified receipt information which is received from the payee's bank service system to confirm whether the receipt information is valid.

With such confirmation, an authorized user who used a registered an AMPA device can verify whether this receipt information is her/his purchasing goods/service receipt. If the receipt information is valid, the authorized user can utilize her/his registered AMPA device to respond receipt information which has been confirmed as confirmed receipt information to payee's bank service system and transmit confirmed receipt information to security service system. In other words, even if an ID-theft can successfully fool server who is employee in business service system to transmit forge receipt information to payee's bank service system, however, the ID-theft purchased transaction with merchant processing will be interrupted by confirmed receipt information from victim who is an authorized user.

Since receipt information cannot be allowed to confirm by authorized user who did not purchase goods/service or receipt information is changed in order to receipt information from payee's bank service system, only receipt information is allowed to confirm by authorized user who purchased good/service based on the receipt information from the payee's bank service system. Thus, it is possible to restrict use of the service by ID-theft, thereby helping to reduce or prevent the occurrence of ID-theft attack.

4. Furthermore, according to a four aspect of the present invention, there is provided security service system to provide special service in reducing payee's bank controlling payment process. Insures service system and business service system received confirmed receipt information from the security service system separately. Only the confirmed receipt data from security service system is used to make payment processes between merchant and insurant.

With payee's bank service system is not able to transmit confirmed receipt information to insures service system and business service system. Even if an ID-theft can successfully change confirmed receipt information in payee's bank service system, however, the ID-theft cannot change payment successfully process between merchant and insurant.

Since changed confirmed receipt information in payee's bank service system did not effect valid payment process between insurant and merchant. Thus, it is possible to restrict abusing of the service system by ID-theft, thereby helping to reduce or prevent the occurrence of ID-theft attack.

5. Furthermore, according to a five aspect of the present invention, there is provided insures service system to provide special service in determination valid confirmed receipt information. A determination device as a part of insures service system compares confirmed receipt information which is received from payee's bank service system with confirmed receipt information which is received from security service system to determine whether the confirmed receipt information is valid. Only matched confirmed receipt data is used to make payment processing between insurant and payee's banker.

With such a determination, a determination device as a part of insures service system can verify whether confirmed receipt information is valid. If the confirmed receipts information is valid, payment processing between the insurant and payee's bank will be successful. In other words, even if an ID-theft can utilizes technology successfully accessing payee's bank service system or security service system to change confirmed receipt data of AMPA device of user, however, the false confirmed receipt data will be detected by a determination device as a part of insures service system which ensures successful payment between insurant and payee's banker.

Since false confirmed receipt information in security service system or in payee's bank service system cannot be allowed to be valid confirmed receipt information for payment receipt data between insurant and payee's banker. Thus, it is possible to restrict abusing of the service system by ID-theft, thereby helping to reduce or prevent the occurrence of ID-theft attack.

6. According to a six aspect of the present invention, there is provided a total current charges data acquisition device to acquire total amount data information according to confirmed receipt information which is stored in receipt file in memory of AMPA device of user.

There is provided a total current charges relationship calculation device of an AMPA device to calculate the total amount of confirmed receipt data relationships between the first and second confirmed receipt data on the acquired total current charges data which is stored in Total Charges File in memory of an AMPA device.

An AMPA device sets electrical files which stores total current charges data in Total Charges File of memory of an AMPA device to compare with received statement in addition to total current charges data from payee's bank service system.

A determination device of an AMPA device is configured to determine whether the total current charges data from payee's bank service system is valid.

With such a determination, determination device of an AMPA device can determine whether total current charges are matched. If the total current charges are matched, it is the successfully processing payment between the customer and payee's banker. In other words, even if an ID-theft can utilizes technology successfully accessing payee's bank service system to change statement of victim, however, the false statement will be detected by a determination device of AMPA device of user which ensures successful payment between an AMPA device of user and payee's banker.

Since false statement in addition to total current charges from payee's bank service system cannot be allowed to be valid total current charges for payment receipt between an AMPA device of user and payee's banker. Thus, it is possible to restrict abusing of the service system by ID-theft, thereby helping to reduce or prevent the occurrence of ID-theft attack.

7. According to a seven aspect of the present invention, there is provided an account balance data acquisition device of an AMPA device acquires withdrawal data from ATM withdrawal file and payment data from electrical payment check file separately. The data of files are stored in memory of an AMPA device of user.

There is provided an account balance relationship calculation device of an AMPA device calculates the account balance relationships between the previous balances data and payment & withdrawal data on the acquired new balance data which are stored in personal bank account file in memory of an AMPA device.

The AMPA device is configured to determine whether the new balance data information is matched from the payee's bank service system and payer's bank service system based on the new balance data information that is stored in personal bank account file in memory of an AMPA device.

With such a determination, a determination device of an AMPA device can determine whether new balance is matched. If the new balance is matched, then, a new balance is confirmed to be store in personal bank account file of memory of AMPA device. It is that recording successful payment and withdrawal history between an AMPA device of user and banker including payee's bank and payer's bank. In other words, even if an ID-theft can utilizes technology successfully accessing payee's bank service system or payer's bank service system to change statement of victim, however, the false statement will be detected by a determination device of AMPA device of user which helps an AMPA device of user to audit personal account information at any time.

Since no matched new balance from payee's bank service system or payer's bank service system cannot be allowed to be valid new balance to be stored in personal bank account file. Thus, it is possible to restrict abusing of the service system by ID-theft, thereby helping to reduce or prevent the occurrence of ID-theft attack.

8. In order to Electrical payment data and Electrical withdrawal data be stored in memory of an AMPA device and also be transmitted to service systems requiring, an AMPA device of user needs to create electrical payment check data and electrical withdrawal data with AMPA device.

According to an eight aspect of the present invention, there is provided an electrical bank account file which is provided by payer's bank service system is stored in memory of an AMPA device to provide digital representation of image data of payer's bank account information for Electrical Payment Check (EPC) or Electrical Withdrawal (EWD) when the customer wants to create EPC or EWD with a registered AMPA device. The bank account file includes payer's bank information about payer's bank name; payer's bank website; payer's bank telephone and personal account number etc.

And also there is provided an electrical credit card file which is provided by payee's bank service system is stored in memory of an AMPA device to provide digital representation of image data of payee's bank credit card information for purchasing goods/service or for Electrical Payment Check (EPC) when the customer wants to create EPC with a registered AMPA device. The credit card file includes payee's bank information about payee's bank name; payee's bank website; payee's bank telephone; credit card number and credit card expire time etc.

9. In order to payment or withdrawal requiring, letter number and data number are needed to be digital represent image data to write in Electrical Text such as payment or withdrawal.

According to a nine aspect of the present invention, in a preferred embodiment of invention, there is provided letter number information are stored in letter number file in memory of an AMPA device to provide a digital represent image data in letter number; and also there is provided data number information are stored in data number file to provide a digital represent image data in data number.

10. According to a ten aspect of the present invention, there is provided an AMPA device of user utilizes software suppose to create Electrical Payment Check (EPC) which is a digital represent image Payment Check data. EPC as Electrical Text is transmitted to the payee's bank service system, security service system and payer's bank service system over wireless network. And payee's bank will obtain payment from payer's bank according to this digital represent image data of EPC.

In a preferred embodiment of invention a method to create EPC by the steps comprising: digital credit card number, payee's bank information, payment date information, payer's bank information, digital personal bank account number, letter number, digital number of the EPC, user's signature.

11. According to an eleven aspect of the present invention there is provided there is provided an AMPA device of user utilizes software suppose to create an Electrical Withdrawal (EWD) which is a digital represent image withdrawal data. And EWD as Electrical Text is transmitted to payer's bank service system and security service system. And payer's bank service system can send money to Changing ATM machine that is connected with an AMPA device of user according to this digital represent image data of EWD.

In a preferred embodiment of invention a method to create EWD by the steps comprising: payer's bank information, digital personal account number, withdrawal data information, letter number, and digital number of the EWD, user's signature.

12. In order to present invention aspect twelve, an aspect of present invention there is provided an AMPA device of user to transmit EPC information to payer's bank service system which provided personal account number and is used to payment by an AMPA device of user; to payee's bank service system which provided credit card number and is used to purchase transaction with merchant by an AMPA device of user; and to security service system.

The security service system provides a special service in respond to EPC information issued from AMPA device of user to payer's bank service system. A determination device as a part of security service system identifies whether EPC is valid in order to process two steps. First step: A determination device as a part of security service system identifies whether AMPA device is registered; second step: A determination device as a part of security service system identifies whether user's signature is an authorized user who having authorized the use this registered AMPA device.

With such some identified, a determination device as a part of security service system can identify whether EPC is valid. If all identifying information is valid, the security service system transmitted a valid EPC to payer's bank service system. Payment processing between an AMPA device of user and payee's banker will be successful. In other words, even if an ID-theft can create and transmit forge EPC to payee's bank service system and security service system without victim knowledge, however, the forge EPC will be detected by a determination device as a part of security service system to ensure successful payment between an AMPA device and payee's bank.

Since EPC cannot be allowed to obtain payment from payer's bank service system by security service system that identify EPC information is invalid if one of two steps fail. Only all two steps identifying information are valid by security service system based on relative databases information. Thus, it is possible to restrict abusing of the service system by ID-theft, thereby helping to reduce or prevent the occurrence of ID-theft attack.

Moreover, continuing this present invention there is provided a payer's bank service system to provide a special service in responds to valid EPC issued from an AMPA device of user, security service system and payee's bank service system separately. This special service provides two steps to identify whether EPC from payee's bank service system or an AMPA device of user is valid. A determination device as a part of payer's bank service system identifies whether EPC from security service system and from AMPA device of user are matched. If the EPC are matched to be valid, then, a determination device as a part of payer's bank service system continue identifies whether this valid EPC is match with EPC form payee's bank service system. Only matched EPC will be valid to deposit money in account of payee's bank.

With such some identified, a determination devices of payer's bank service system can identify whether EPC is valid. If all identifying information is valid, payer's bank service system will transfer money from personal account to payee's bank account according to valid EPC. Transfer funds processing between payer's bank and payee's bank will be successful. In other words, even if an ID-theft can utilizes technology to access payee's bank service system or security service system to change EPC data under victim blinding, however, the changing EPC will be detected by a determination device as a part of payer's bank service system to ensure successful transfer funds between payer's bank service system and payee's bank service system.

Since invalid EPC cannot be allowed to obtain payment processing by a determination device of payer's bank service system which identifies EPC information did not match based on the EPC information from security service system, payee's bank service system and an AMPA device of user. Only the all matched EPC is allowed to be valid by a determination device of payer's bank service system to process payment. Thus, it is possible to restrict abusing of the service system by ID-theft, thereby helping to reduce or prevent the occurrence of ID-theft attack.

13. According to a thirteen aspect of present invention there is provided an AMPA device of user to transmit Electrical WithDrawal (EWD) to payer's bank service system and to security service system separately. The security service system provides a special service in respond to EWD information issued from AMPA device of user to payer's bank service system. A determination device as part of security service system identifies whether EWD is valid in order to process two steps. First step: a determination device as part of security service system identifies whether AMPA device is registered; second step: a determination device as a part of security service system identifies whether user's signature is an authorized user who having authority the use this registered AMPA device.

With such some identified, a determination device as part of security service system can identify whether EWD is valid. If all information is valid, the security service system transmitted a valid EWD to payer's bank service system. Withdrawal processing between an AMPA device of user and payer's bank will be successful. In other words, even if an ID-theft can create and transmit forge EWD to payer's bank service system and security service system without victim knowledge, however, the forge EWD will be detected by a determination device as a part of security service system to ensure successful withdrawal between an AMPA device and payer's bank.

Since invalid EWD cannot be allowed to withdraw from Changing ATM machine by security service system which identifies EWD information is invalid if one of two steps is fail, only all two steps information is valid by security service system based on relative databases information to process withdrawal from Changing ATM machine. Thus, it is possible to restrict abusing of the service system by ID-theft, thereby helping to reduce or prevent the occurrence of ID-theft attack.

Moreover, continuing this present invention there is provided a payer's bank service system to provide a special service in responds to valid EWD issued from security service system. This special service provides a determination device as a part of payer's bank service system to identify whether EWD from security service system is matched with EWD from an AMPA device of user. Only the matched EWD is valid to allow an AMPA device of user for withdrawing money from Changing ATM machine. Withdrawal processing between an AMPA device of user and payer's bank will be successful. In other words, even if an ID-theft can utilize technology to access payer's bank service system or security service system to change EWD data under victim blinding, however, the changing EWD will be detected by a determination device as a part of payer's bank service system to ensure successful withdrawal between an AMPA device of user and payer's bank.

Since invalid EWD cannot be allowed to withdraw money from Changing ATM machine by determination device of payer's bank service system to identify EWD information from an AMPA device of user did not match based on the EWD information from security service system. Only the matched EPC is allowed an AMPA device of user to withdraw money from Changing ATM machine by determination device of payer's bank service system. Thus, it is possible to restrict abusing of the service system by ID-theft, thereby helping to reduce or prevent the occurrence of ID-theft attack.

14. In order to previous present invention mention, a fourteen aspect present invention there is provided an AMPA device to provide special private service device instead of the public service machine—such as credit card machine for customer to purchase transaction with merchant.

With such special private service device, a person purchased transaction with merchant only using his/her AMPA device. This special private service provided a new unique identity to identify whether authorized user purchases goods/service. Even if ID-theft stolen personal information, credit card identity etc, however, ID-theft attack will be defeated without a registered AMPA device.

Since a person could not be allowed to purchase transaction without an AMPA device or unauthorized using AMPA device even if this person had all personal information. Thus, it is possible to restrict use of the service by ID-theft, thereby helping to reduce or prevent the occurrence of ID-theft attack.

15. In order to previous present invention mention, a fifteen aspect present invention there is provided a Changing Gas Machine to provide special private service machine for customer to obtain gasoline. This Changing Gas Machine only provides a display and a host interface without credit card input.

With such special private service machine, a person who obtains gasoline must use an embodiment device—host interface of his/her AMPA device to connect with host interface of Changing Gas Machine via a cable. This special private service provides a new unique identity to identify whether authorized user takes gasoline. Even if ID-theft stolen personal information, credit card identity etc, however, ID-theft attack will be defeated without a registered AMPA device.

Since a person could not be allowed to takes gasoline without an AMPA device or unauthorized using AMPA device even if this person had all personal information. Thus, it is possible to restrict abusing of the service system by ID-theft, thereby helping to reduce or prevent the occurrence of ID-theft attack.

16. In order to previous present invention mention, a sixteen aspect present invention there is provided a Changing ATM machine to provide special private service machine for customer to withdrawal money. This Changing ATM machine only provides a money output and a host interface without keyboard input and credit card input.

With such special private service machine, a person who withdraws money must use an embodiment device—host interface of his/her AMPA device to connect with host interface of Changing ATM machine via a cable. This special private service provides a new unique identity to identify whether authorized user withdraws money. Even if ID-theft stolen personal information, credit card identity and passwords etc, however, ID-theft attack will be defeated without a registered AMPA device.

Since a person could not be allowed to withdraw money without an AMPA device or unauthorized using AMPA device even if this person had all personal information. Thus, it is possible to restrict abusing of the service system by ID-theft, thereby helping to reduce or prevent the occurrence of ID-theft attack.

### BRIEF DESCRIPTION OF THE DRAWINGS

FIG. 1: System component: is depicts a diagram illustrating of security service system for defense ID-theft attack events in purchasing goods/services across an enterprise communication system, in accordance with an embodiment of the present invention.

FIG. 2A: depicts a diagram illustrating of Business Services System Database.

FIG. 2B: depicts a diagram illustrating of Payee's Bank Services System Database.

FIG. 2C: depicts a diagram illustrating of Payer's Bank Services System Database.

FIG. 2D: depicts a diagram illustrating of Insures Services System Database.

FIG. 2E: depicts a diagram illustrating of Security Services System Database.

FIG. 3A: depicts a diagram illustrating of an AMPA device model.

FIG. 3B: brief AMPA module: is a functional block diagram of an AMPA device, in accordance with an exemplary embodiment of the present invention.

FIG. 4A: depicts a block diagram illustrating Personal Account File.

FIG. 4B: depicts a block diagram illustrating Identity File.

FIG. 4C: depicts a block diagram illustrating Number File.

FIG. 4D: depicts a block diagram illustrating Digital Number.

FIG. 4E: depicts a block diagram illustrating Letter Number.

FIG. 4F: depicts a block diagram illustrating Credit Report file.

FIG. 4G: depicts a block diagram illustrating Message File.

FIG. 4H: depicts a block diagram illustrating Message Display.

FIG. 4I: depicts a block diagram illustrating Respond Message.

FIG. 4J: depicts a block diagram illustrating Credit Card Identity File.

FIG. 4K: depicts a block diagram illustrating Credit Card Identity Information

FIG. 4L: depicts a block diagram illustrating Receipt File.

FIG. 4M: depicts a block diagram illustrating Receipt Information.

FIG. 4N: depicts a block diagram illustrating Total Charges File.

FIG. 4O: depicts a block diagram illustrating Total Charges Information.

FIG. 4P: depicts a block diagram illustrating Electrical Payment Check (EPC) File.

FIG. 4Q: depicts a block diagram illustrating EPC Information.

FIG. 4R: depicts a block diagram illustrating Confirmed EPC Information.

FIG. 4S: depicts a block diagram illustrating Sent EPC Information.

FIG. 4T: depicts a block diagram illustrating Creating Payee's Bank Information

FIG. 4U: depicts a block diagram illustrating Creating Payment Date in EPC.

FIG. 4V: depicts a block diagram illustrating Creating Letter Number Data in EPC.

FIG. 4W: depicts a block diagram illustrating Creating Digital Number Data in EPC.

FIG. 4X: depicts a block diagram illustrating Creating Payer's Bank Information in EPC.

FIG. 4Y: depicts a block diagram illustrating Creating Payer's Signature in EPC.

FIG. 4Z: depicts a block diagram illustrating Creating Payer Sign Signature in EPC.

FIG. 5A: depicts a block diagram illustrating Creating Electrical Payment Check (EPC).

FIG. 5B: depicts a block diagram illustrating ATM EWD File.

FIG. 5C: depicts a block diagram illustrating ATM EWD Account

FIG. 5D: depicts a block diagram illustrating Confirmed EWD Information.

FIG. 5E: depicts a block diagram illustrating Sent EWD Information.

FIG. 5F: depicts a block diagram illustrating Creating Payer's Bank Information in EWD.

FIG. 5G: depicts a block diagram illustrating Creating Letter Number in EWD.

FIG. 5H: depicts a block diagram illustrating Creating Digital Number in EWD.

FIG. 5I: depicts a block diagram illustrating Creating Withdrawer's Signature in EWD.

FIG. 5J: depicts a block diagram illustrating Creating Withdrawer Sign Signature in EWD.

FIG. 5K: depicts a block diagram illustrating Creating Electrical WithDrawal (EWD).

FIG. 6A: depicts a block diagram illustrating Personal Bank Account File.

FIG. 6B: depicts a block diagram illustrating Bank Account Information.

FIG. 6C: depicts a block diagram illustrating Bank Account Balance Information.

FIG. 7A: depicts a diagram illustrating of Register AMPA device service.

FIG. 7B: depicts a flowchart illustrating the process of Register an AMPA device service.

FIG. 8A: depicts a flowchart illustrating the process of Security Service System Identifying an AMAP identity.

FIG. 8B: depicts a flowchart illustrating the process of Security Service System Identifying an authorized user.

FIG. 8C: depicts a flowchart illustrating the process of Security Service System Identifying a Message.

FIG. 8D: depicts a flowchart illustrating the process of Security Service System dealing with Black List database.

FIG. 9A: depicts a diagram illustrating of an AMPA device of user Accessing into Personal Account File.

FIG. 9B: depicts a flowchart illustrating the process of An AMPA device of user Accessing into Personal Account File.

FIG. 10A: depicts a flowchart illustrating the process of an AMPA device of user Application Credit Card Identity.

FIG. 10B: depicts a flowchart illustrating the process of Security Service System Identifying application credit card Message in order to black list database.

FIG. 10C: depicts a flowchart illustrating the process of Payee's Bank Service System Identifying Credit Card Identity.

FIG. 10D: depicts a flowchart illustrating the process of an AMPA device of user Application Personal Account Identity.

FIG. 10E: depicts a flowchart illustrating the process of Security Service System Identifying application Personal Account Message.

FIG. 10F: depicts a flowchart illustrating the process of Payer's Bank Service System Refusing Application Personal Account.

FIG. 11A: depicts a diagram illustrating of Purchasing Transaction Method.

FIG. 11B: depicts a flowchart illustrating the process of Payee's Bank Service System Identifying Credit Card Identity in Purchasing Transaction with merchant at shop or Gas Station.

FIG. 11C: depicts a flowchart illustrating the process of Bank Service System Identifying Credit Card Identity in Purchasing Transaction with merchant online or Telephone

FIG. 12A: depicts a diagram illustrating process of an AMPA of user Respond Receipt issued from Payee's Bank Service System.

FIG. 12B: depicts a flowchart illustrating the process of an AMPA device of user Respond Receipt issued from Payee's Bank Service System.

FIG. 12C: depicts a flowchart illustrating the process of Security Service System dealing with Confirmed Receipt issued from an AMPA device.

FIG. 12D: depicts a flowchart illustrating the process of Business Service System dealing with Denied/Cancelled Receipt issued from Payee's Bank Service System.

FIG. 12E: depicts a flowchart illustrating the process of Security Service System dealing with No Respond Receipt information from an AMPA device of user.

FIG. 12F: depicts a flowchart illustrating the process of Insure Service System Identifying Confirmed Receipt issued from Security Service System and Payee's Bank Service System.

FIG. 12G: depicts a flowchart illustrating the process of Security Service System dealing with complain message appending Invalid Confirmed Receipt issued from Insure Service System.

FIG. 13A: depicts a diagram illustrating of Merchant obtaining Payment.

FIG. 13B: depicts a flowchart illustrating the process of Merchant obtaining Payment

FIG. 13C: depicts a flowchart illustrating the process of Security Service System dealing with Merchant Complain Message.

FIG. 14A: depicts a diagram illustrating of Insurant obtaining Payment.

FIG. 14B: depicts a flowchart illustrating the process of Insurant obtaining Payment.

FIG. 14C: depicts a flowchart illustrating the process of Security Service System dealing with Insurant Complain Message.

FIG. 15A: depicts a diagram illustrating of Payee's Bank obtaining Payment.

FIG. 15B: depicts a flowchart illustrating the process of Payee's Bank obtaining Payment.

FIG. 15C: depicts a flowchart illustrating the process of Security Service System dealing with an AMPA device of user Complain Message.

FIG. 16A: depicts a flowchart illustrating the process of an AMPA device of user transmitting Electrical Payment Check (EPC).

FIG. 16B: depicts a flowchart illustrating the process of Security Service System identifying Electrical Payment Check (EPC).

FIG. 16C: depicts a flowchart illustrating the process of Payer's Bank Service System identifying Electrical Payment Check (EPC).

FIG. 17A: depicts a diagram illustrating of Credit Report.

FIG. 17B: depicts a flowchart illustrating the process of Credit Report.

FIG. 18A: depicts a diagram illustrating of Withdrawal Money with An AMPA device from ATM Machine.

FIG. 18B: depicts a flowchart illustrating the process of an AMPA device of user transmitting Electrical WithDrawal (EWD) Information to Service System.

FIG. 18C: depicts a flowchart illustrating the process of Security Service System Identifying Electrical WithDrawal (EWD).

FIG. 18D: depicts a flowchart illustrating the process of Payer's Bank Service System Identifying Electrical WithDrawal (EWD).

FIG. 18E: depicts a flowchart illustrating the process of an AMPA device of user responds receipt of withdrawal process.

FIG. 18F: depicts a flowchart illustrating the process of security service system deal with confirmed receipt of WithDrawal process.

FIG. 18G: depicts a flowchart illustrating the process of payer's bank service system dealing with denied receipt process.

FIG. 18H: depicts a flowchart illustrating the process of Security Service System dealing with no respond process.

### DETAILED DESCRIPTION OF THE INVENTION

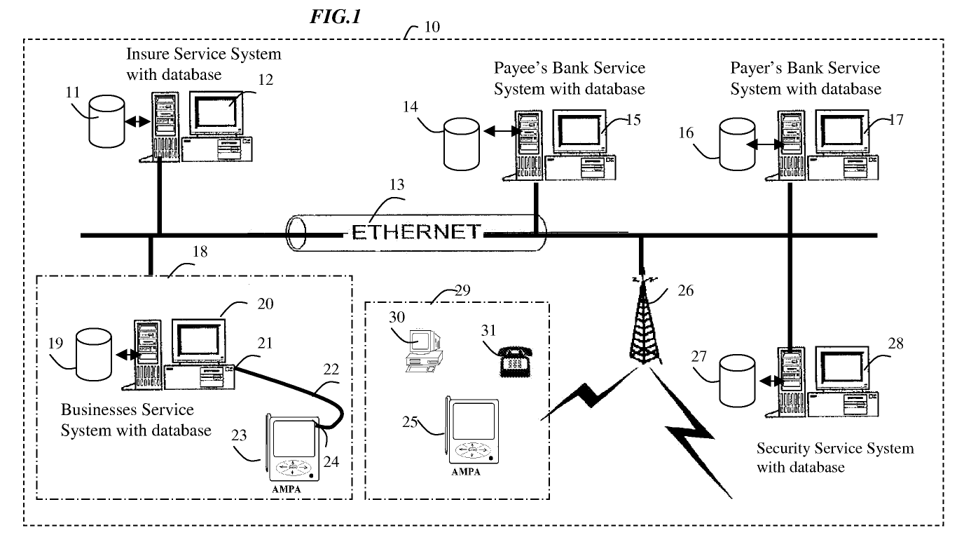

FIG. 1: shows a present invention defense ID-theft attack security service system diagram of an exemplary service system architecture generally at 10 that is capable of implementing various features described below: Wireless Local Area Networks (WLANs) offer a quick and effective extension of a wired network or standard local area network (LAN). FIG. 1 depicts a typical LAN 10 including both wired and wireless components. The wired and wireless component depicted in FIG. 1 includes a variety of connection service systems: Insures service system 12 with network accessible data storage 11 components; Payee's Bank service system 15 with network accessible data storage 14 component; Payer's Bank service system 17 with network accessible data storage 16 component; Security service system 28 with networks accessible data storage 27 components. Business service system 20 with network accessible data storage 19 component; A Service system communicates with other service system over wired network (e.g., Ethernet 13). By simply installing access points 26 to the wired network (e.g., Ethernet 13), for a portable device 23 or 25 is called AMPA device with WLAN cards (not shown in diagram) can connect with wired network at broadband speeds to communicate with service systems such as payee's bank service system, payer's bank service system and security service system. A plurality of service is provided to portable device—AMPA device (23 or 25) which can be incorporated in the architecture: a customer purchases goods/service can use a portable device (23 or 25), and businesses service system 20 provides service system to merchant (no illustration) who offers goods/service.

The portable device (e.g. AMPA device 23 or 25) communication with businesses service system 20 has two different ways: One way is that a host interface of portable device (e.g., AMPA device 23) to connect with host interface of computer or machine in businesses service system via cable for wired communication. For example at diagram 18 illustration that business service system 20 communication with AMPA device 23 via cable 22 between host interface 21 of computer of business service system 20 and host interface 24 of an AMPA device 23. So that an AMPA device of user transmits credit card information to business service system 20 via host interface 24, cable 22 and host interface 21.

Another way is that merchant offers goods/service over Internet or by telephone, and AMPA device of user utilizes computer online or by telephone to communication with business service system. For example shown in diagram 29 illustrations that an AMPA device 25 of user utilizes computer 30 or telephone 31 communications with businesses service system 20 over Internet 30 or by telephone 31.

Each service system includes one and more resources. Exemplary resources can include, without limitation, scanners, tape drives, laser pointers etc. Such databases of each service system can be operated by and/or associated with service system for which authentication is desired.

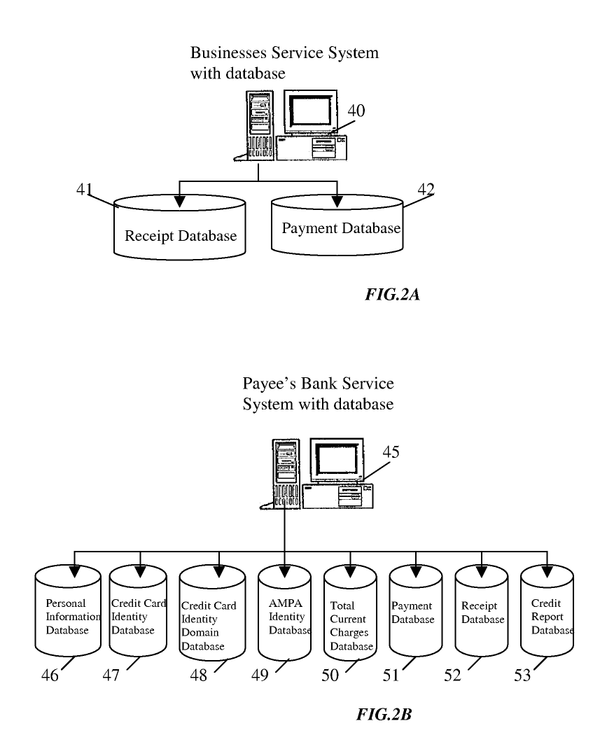

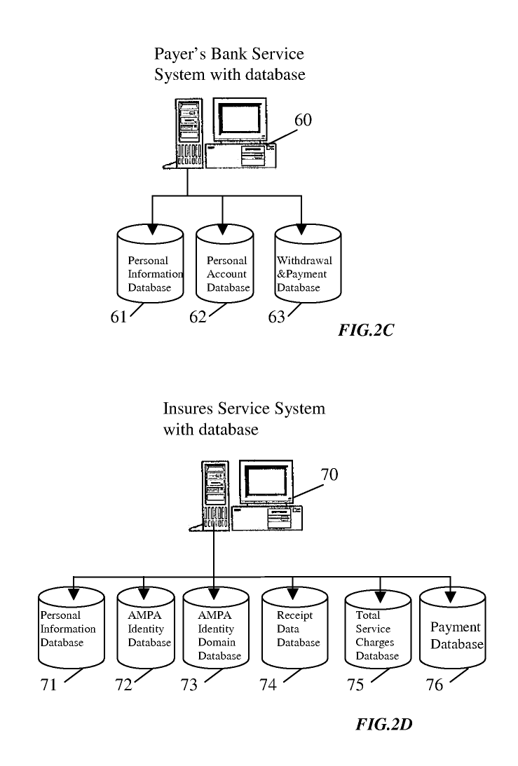

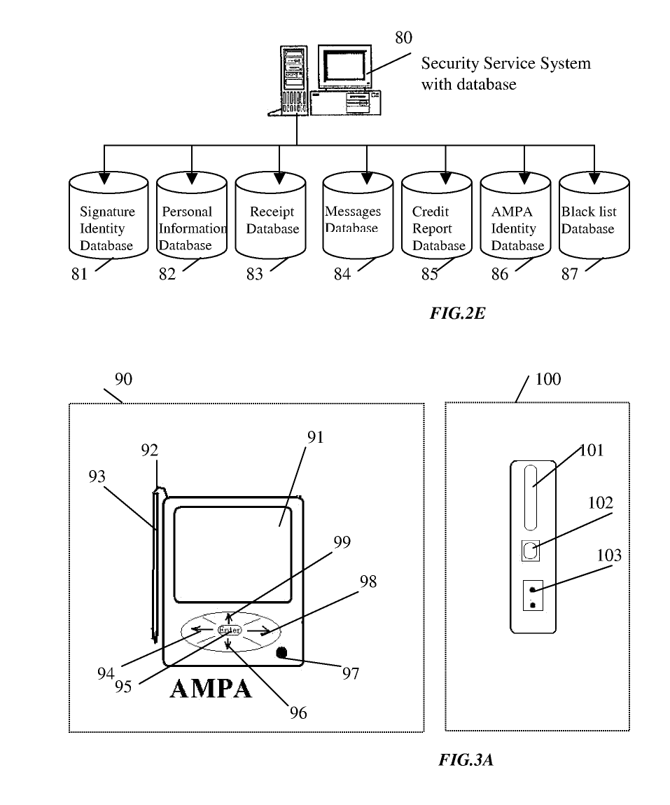

FIG. 2A: A plurality of database systems of the businesses service system 40 is provided to store purchasing transaction information which an AMPA device of user purchases goods/service with merchant. And in order to store purchasing transaction information, merchant obtains payment.

Business service system 40 provides computer with system database to merchant. System databases include receipt database 41 that merchant maintains receipt information of an AMPA device of user and payment database 42 that merchants obtain payment information.

FIG. 2B: A plurality of database systems of payee's bank service system is provided to establish personal credit card information and store purchasing goods/service history for obtaining payment or making payment. System database of payee's bank service system 45 include: 1) Personal information of customer which includes personal Social Security Number (SSN), Driver's License, Birthday etc are stored in system database 46 to identify a customer who uses an AMPA device; 2) Credit card identity information including black list are stored in system database 47 to ensure an AMPA device of user has unique credit card identity and also release credit card identity according to black list; 3) Credit card identity domain are stored in system database 48 to ensure that each payee's banks service system 45 has own unique credit card identity domain to provide unique credit card identity for an AMPA device of user; 4) AMPA identity information of an AMPA device of user including IP address of AMPA device are stored in system database 49 so that payee's bank service system 45 communicate with AMAP device over wireless network communication; 5) Total current charges data of an AMPA device of user are stored in system databases 50 to provide payment information to an AMPA device of user each month; 6) Payment data including received payment and made payment data are stored in system database 51 to evaluate credit according to payment information of an AMPA device of user and assures payment; 7) Receipt information are stored in system database 52 to calculate total current charges; 8) Credit report information is stored in system database 53 to evaluate customer's credit.

FIG. 2C: A plurality of database systems of Payer's bank service system 60 is provided to establish personal account in payer's bank and also records customer who uses an AMPA device (no illustration) payment and withdrawal history. Payer's bank service system 60 responsively transfers funds from account of payer to payee's bank in order to payment check and withdraws money from account of withdrawer using Changing ATM machine (no illustration) to withdrawer who uses an AMPA device (no illustration). System database of Payer's bank service system 60 include: 1) Personal information of customer includes personal Social Security Number (SSN), Driver's License, Birthday etc are stored in system database 61 to identify a customer; 2) Personal account information of an AMPA device of user including black list are stored in system database 62 to ensure that an AMPA device of user (no illustration) has unique account identity and release account identity according to black list; 3) Payment or withdrawal data are stored in system database 63 to assure payment to payee's bank or withdrawal service for an AMPA device of user.

FIG. 2D: A plurality of database systems of insures service system 70 is provided to maintain unique AMPA identity for an AMPA device of user (no illustration) and assure payment to merchant (no illustration) in order to data in system database. System database of payer's bank service system 70 include: 1) personal information of customer includes personal Social Security Number (SSN), Driver's License, Birthday etc are stored in system database 71 to identify a customer; 2) AMPA Identity including black list are stored in system database 72 to ensure unique AMPA identity for an AMAP device of user and release AMPA identity according to black list; 3) AMPA identity domain are stored in system database 73 to ensure insures service system has unique AMAP identity domain; 4) Received receipt information are stored in system database 74 to provide payment information; 5) Total service charges are stored in system database 75 to calculate service fee for each customer who used AMPA device to purchase goods/service; 6) Payment data including received payment and made payment are stored in system database 76 to retain payment information history.

FIG. 2E: A plurality of database systems of Security service system 80 is provided to ensure an authority user having the use a registered AMPA device during purchasing goods/service in defense ID-theft attack security service system and to assure transmitting data with identification information to third service system in order to store data in system database. System database of security service system 80 include: 1) Signature identity information are stored in system database 81 to identify biometric identity such as signature for each customer who has authority the use AMPA device. 2) Personal information including personal SSN, Driver's license, Birthday etc is stored in system database 82 to identify an AMPA device of user identity. 3) Received receipt information are stored in system database 83 to identify receipt from authority user having the use registered AMPA device; 4) Messages which includes complain message from third service system are stored in system database 84 to solution problem; 5) Credit report data are stored in system database 85 to reevaluate credit report information for AMPA device of users; 6) AMPA identity are stored in system database 86 to identify whether a registered AMAP device is used by an authored user; 7) Black list are stored in black list database 87 to ensure that an AMPA device of user in black list could not obtain service in defense ID-theft attack security service system.

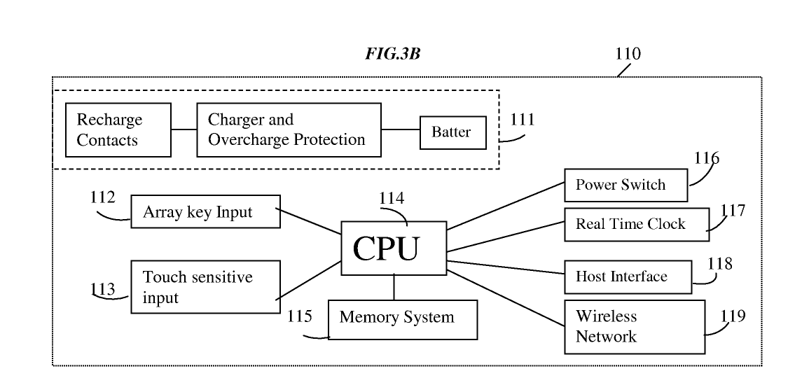

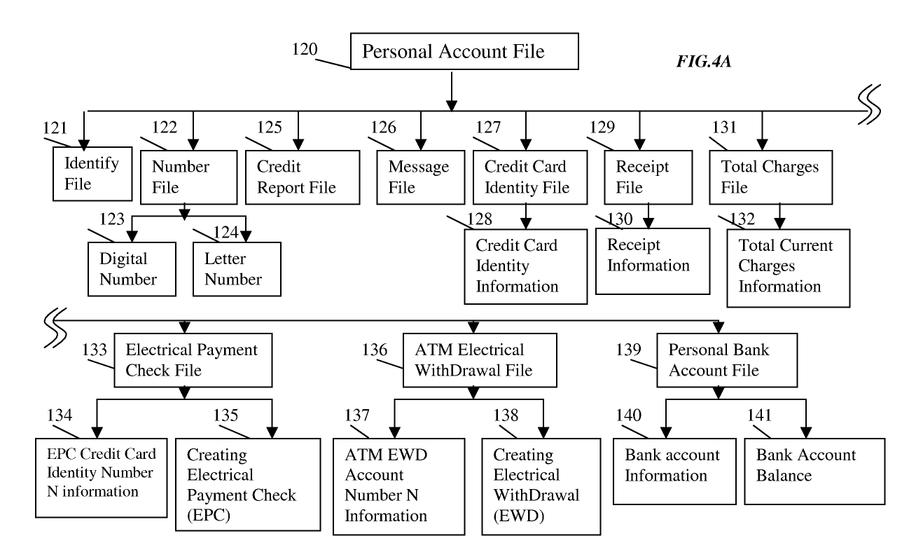

FIG. 3A: present invention in FIG. 3A diagram illustration an AMPA device model in the frond of face 90 and the rights sit of face 100. In the frond of face 90 depicts a diagram illustrating of AMPA device function component. The display is preferably a digital number type display having a touch sensitive surface 91. An embodiment of device said a stylus pen 93 is also shown in the frond of face 90 of an AMPA device and the stylus pen 93 is located in a pen slot 92 when not in use. In a preferred embodiment, in the frond of face 90 of an AMPA device shown a limit number of buttons for performing various user functions comprising: “Left” key 94 to move text left way; “Right” key 98 to move text right way; “Up” key 99 to move text up way; “Down” key 96 to move text down way; And the “Enter” key 95 to “add” an item which is selected by a user to a correspond file. In the frond of face 90 of an AMPA device shows that a commercial transmission “on/off” butter 97. In the preferred embodiment illustrated the right sit of face 100 of an AMPA device. The rights sit of face 100 of an AMPA device shows that the wireless network interface 101 might communicate over a wireless wide area network and/or a local area network. An embodiment of device of host interface 102 of an AMPA device communicates with another host interface of computer or machine in businesses service system via cable (no illustration). And an adapter 103 is for charging electrical.

FIG. 3B: in this present invention there is provided a portable device which is called an Automatic Management Personal Account (AMPA) device to allow purchasing goods/service for customer who uses AMPA device and to maintain purchasing transaction data in memory of AMPA device defense ID theft attack. An exemplary system for implementing the present invention includes a general purpose AMPA device 110 in the Defense ID-theft attack security service system.

The basic subcomponent system of an AMPA device shows in FIG. 3B. As shown, the system includes a CPU 114 controlling an AMPA device processes. Memory system 115 may include volatile random access memory (RAM) and nonvolatile ROM. Memory management control system may store electrical files including personal account file (no illustration). As an alternative searching mechanism, the customer could search history of personal account information, credit card identity, and messages etc by a hierarchical subject matter categorization. Under this approach, the information could be organized in logical groups and subgroups. For example, if an AMPA device of user wants to search credit card identity information, she/he could enter personal account file, then, scroll through this list and click Credit Card File to provide credit card identity information that are available. A host interface 118 employing preferred alternative embodiment of wherein an AMPA device 110. An AMPA device of user uses the system components during purchasing transaction. For example, An AMPA device of user provides credit card identity information having encoded AMAP identities which are stored in memory system 115 to business service system via host interface with cable. To use an AMPA device, An AMPA device of user must access to an entrance processes. An AMPA device of user signs signature identity with stylus on touch screen. Touch sensitive input 113 captures digital represent image data of signature identity into CPU 114. Digital represent image data of signature identity, which is processed under CPU 114 controlling via wireless network interface 119, is transmitted to security service system that scans signature identity database in system database to confirm that a corresponding signature data of an AMPA device of user who is authority having the use a registered AMPA device. An AMPA device of user will receive approval message via wireless network interface 119 and enter personal account file in memory system 115. A battery overcharge 111 protect circuit is also included shown 110 in FIG. 3B. a real time clock 117 provides real time embodding in each message which is received or sent by AMPA device 110. AMPA device 110 communicates with a Central Personal Unit (CPU) 114 through wireless network interface 119 with a wireless radio (no illustration). The wireless radio might communicate over wireless widens area network and or a local area network. Symbol SPECTRUM24™ PCMCIA type II card communicating over a local area network employing a frequency-hopping communication system conforming to the IEEE 802.11 standard. The standard is available from IEEE Standards Department, 445 Hoes Lane, P.O. Box 1331, Piscataway, N.J. 08855-1331. The standard is incorporated herein by reference and shall not be further discussed.

Array keys input 112 which connects CPU 114 controls text moving via CPU 114 controlling.

Touch sensitive input 113 which connects CPU 114 capture input digital data into CPU 114 or display electrical text from CPU 114.

Power switch 116 which connects CPU 114 turns on/off power via CPU 114 controlling.

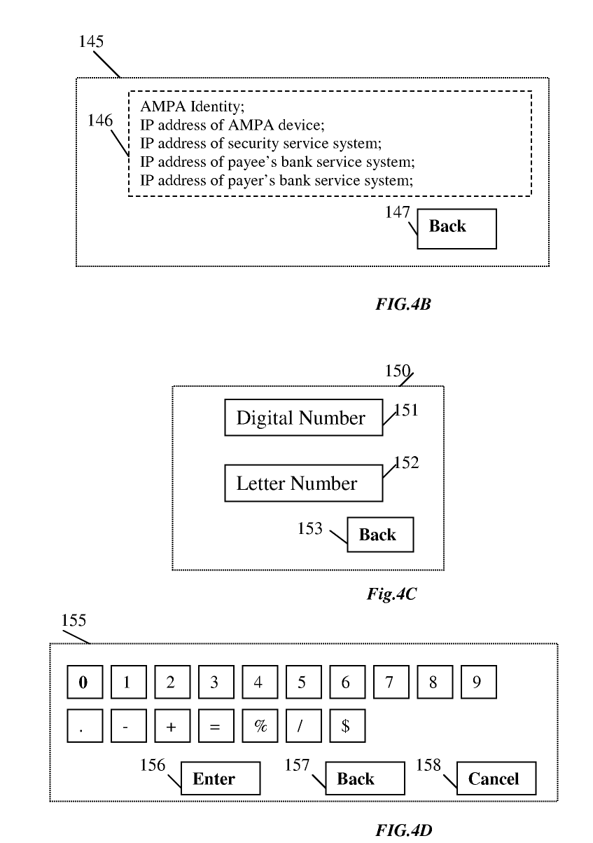

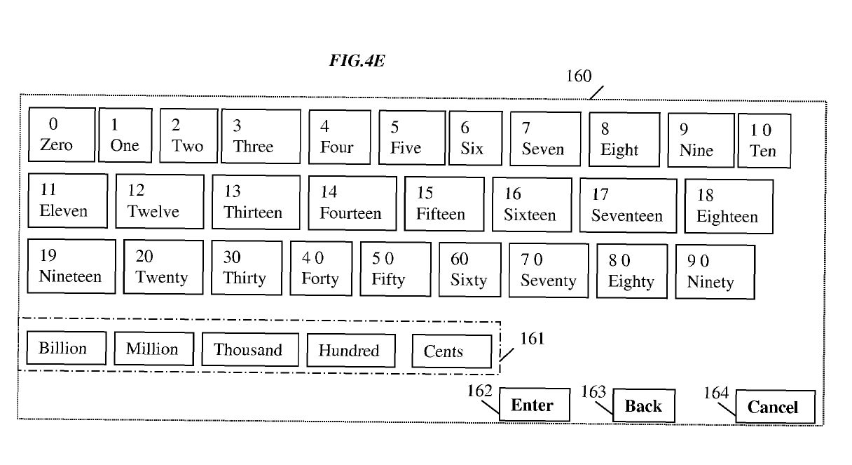

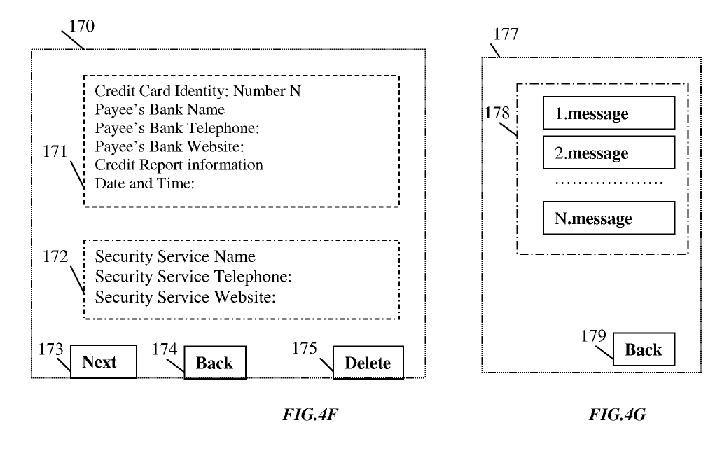

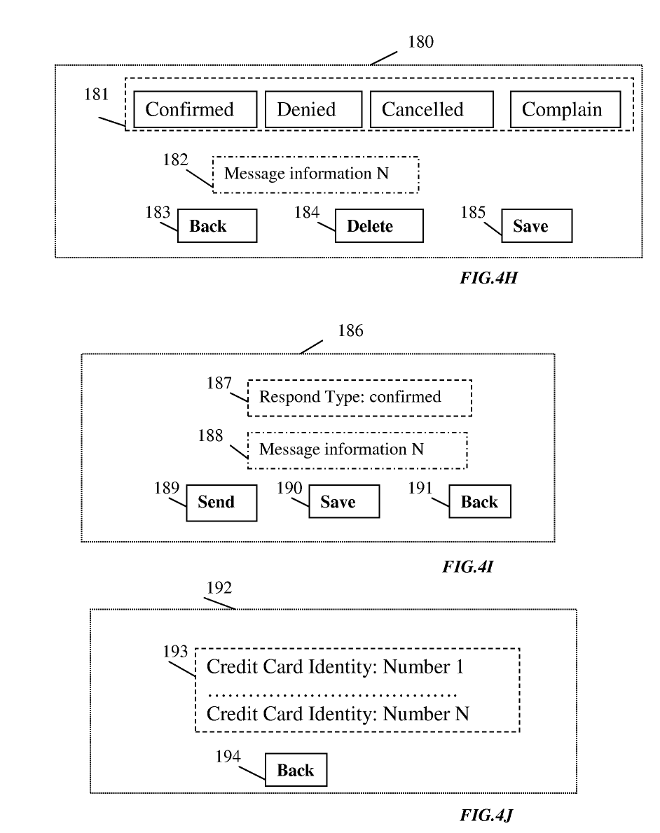

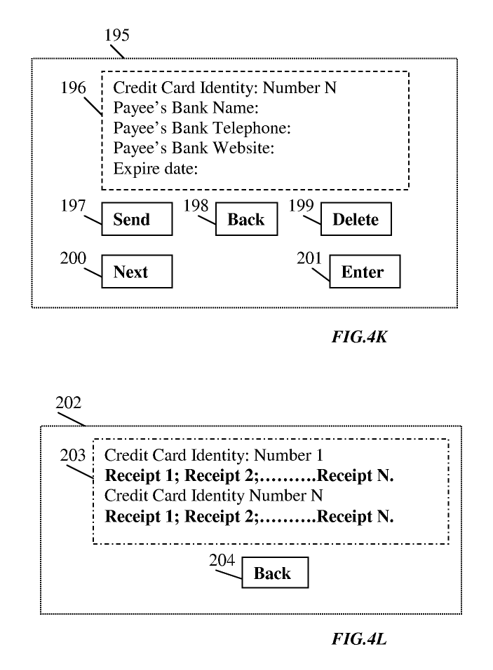

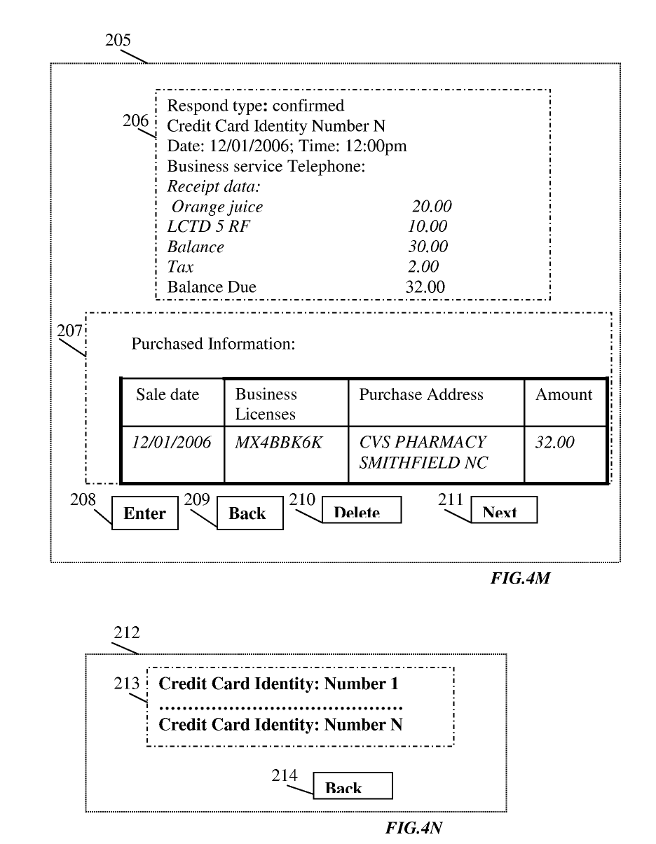

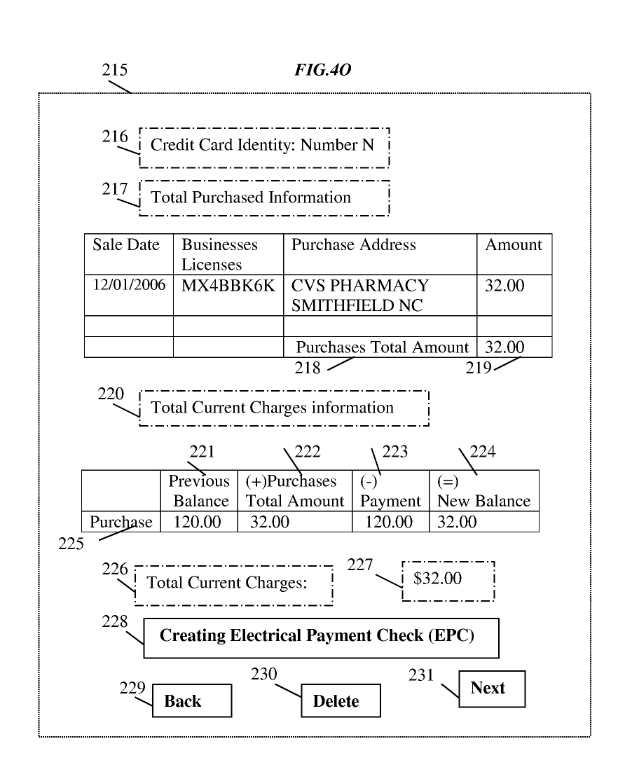

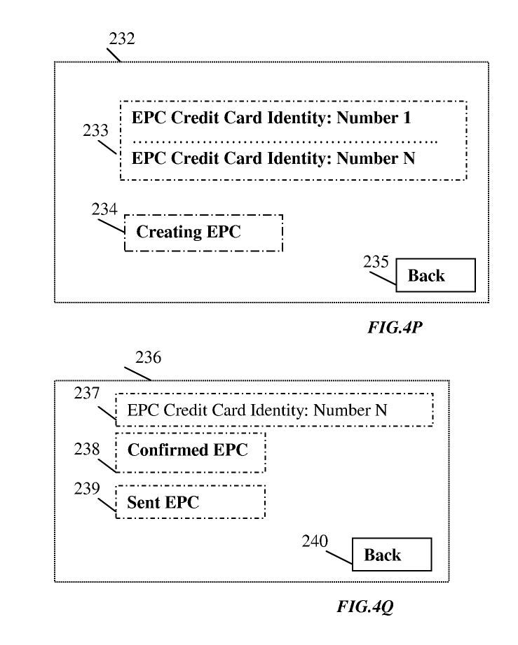

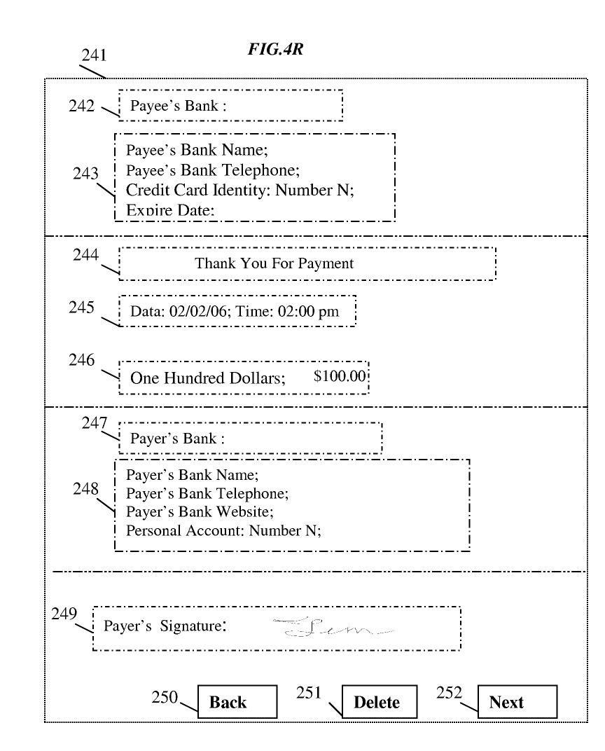

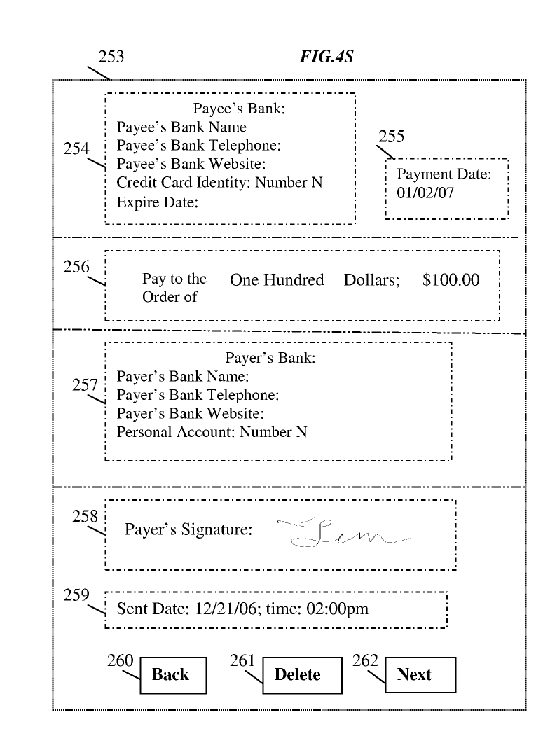

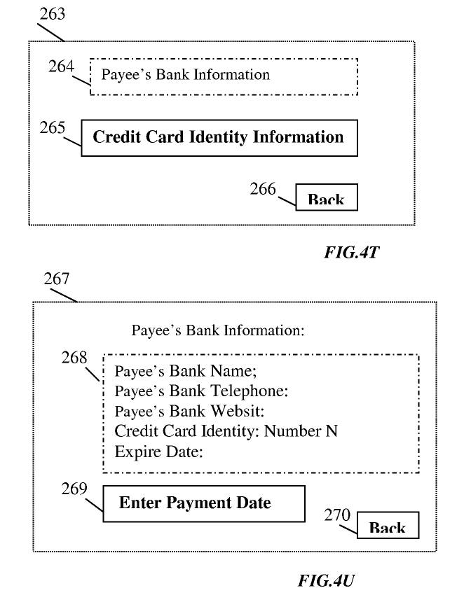

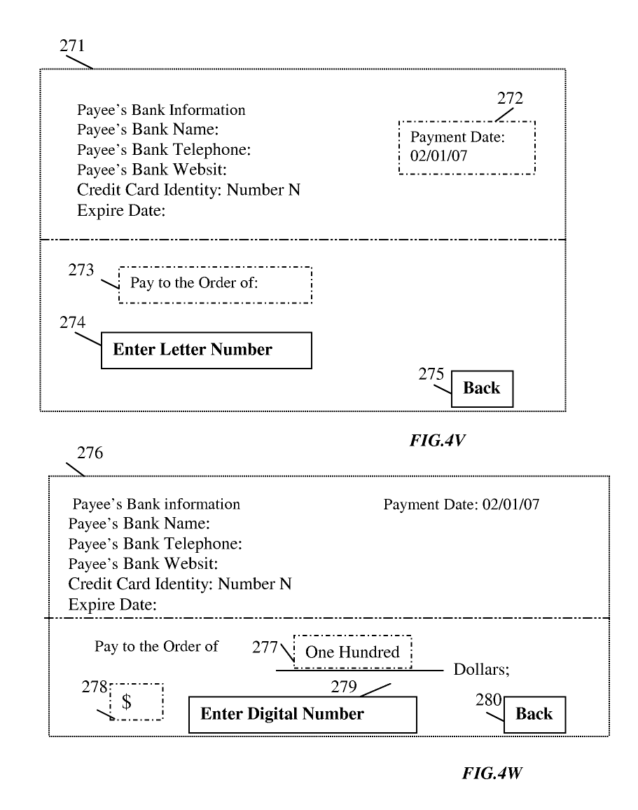

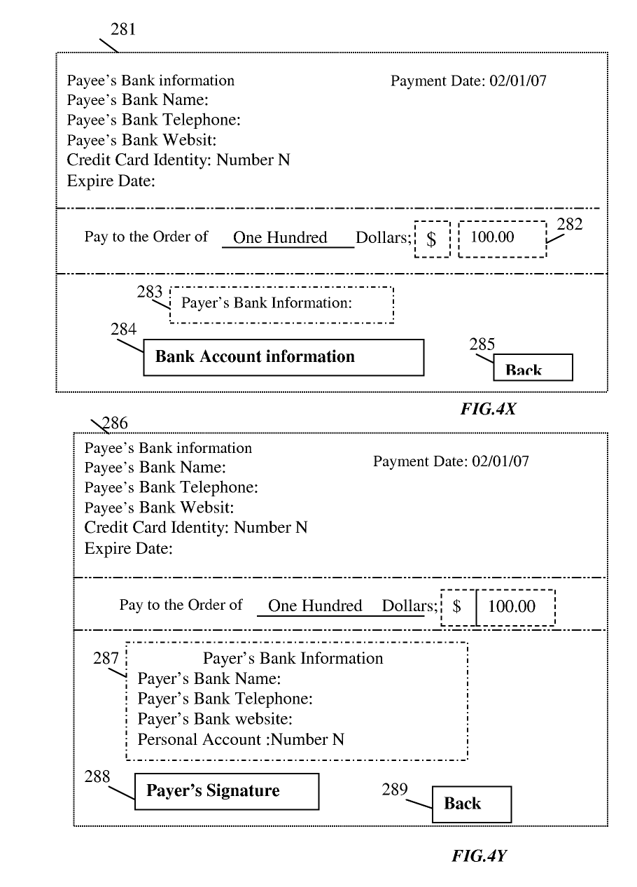

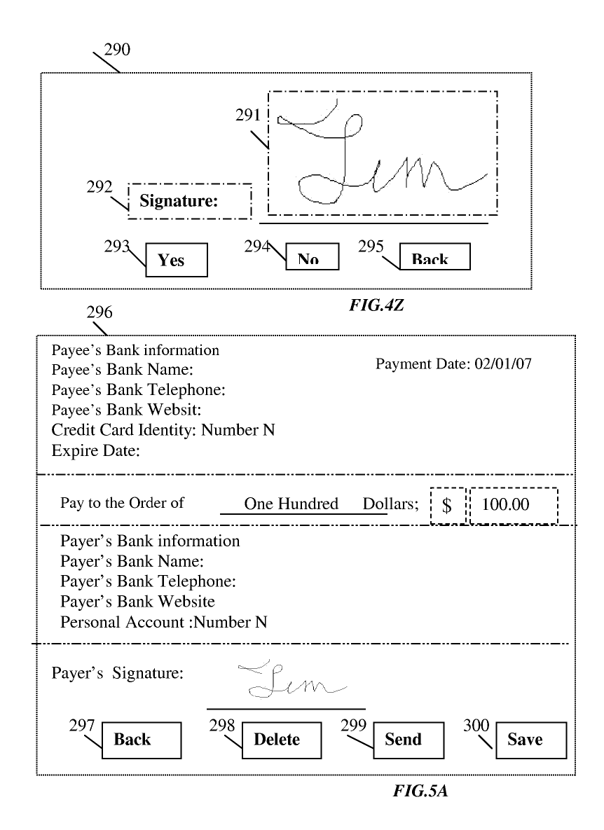

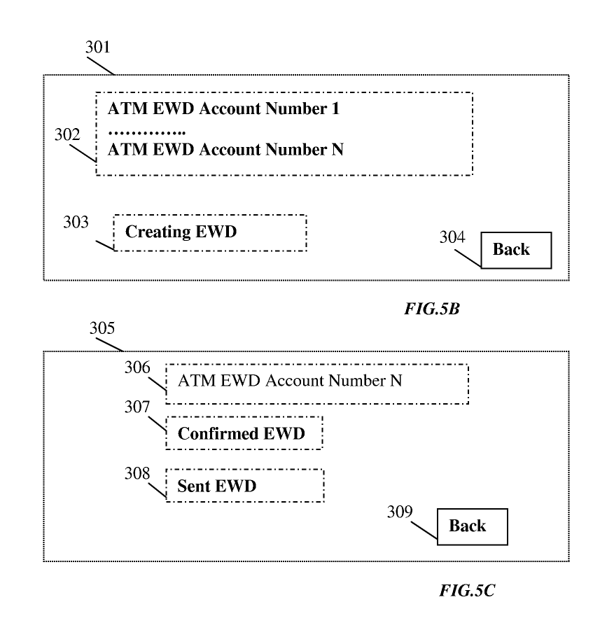

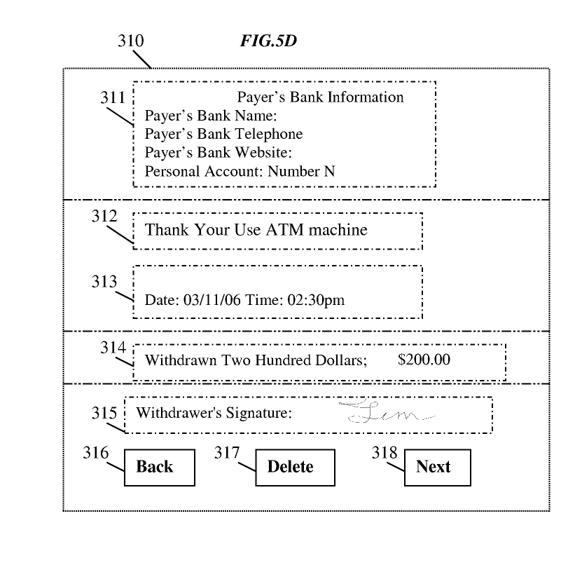

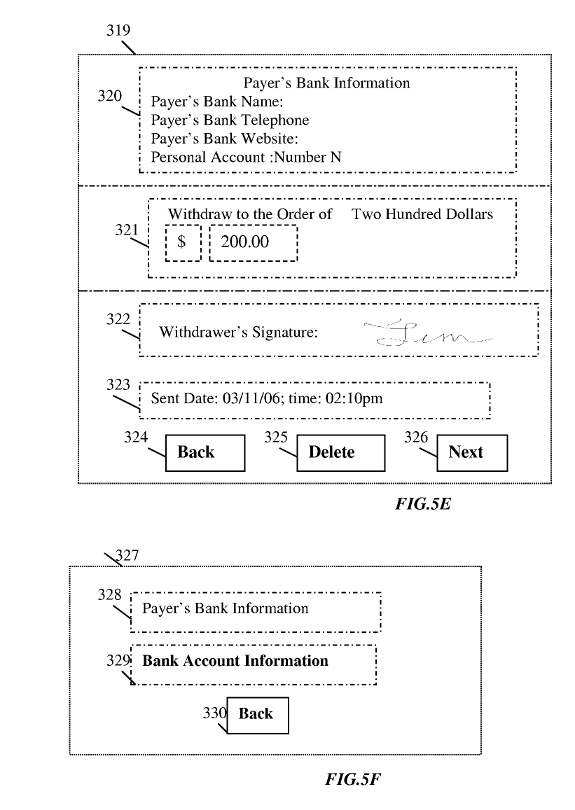

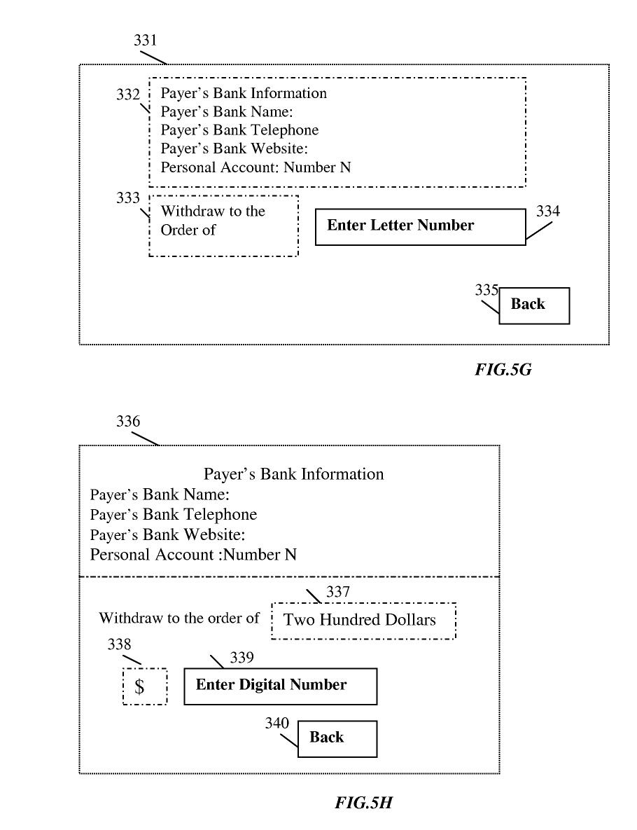

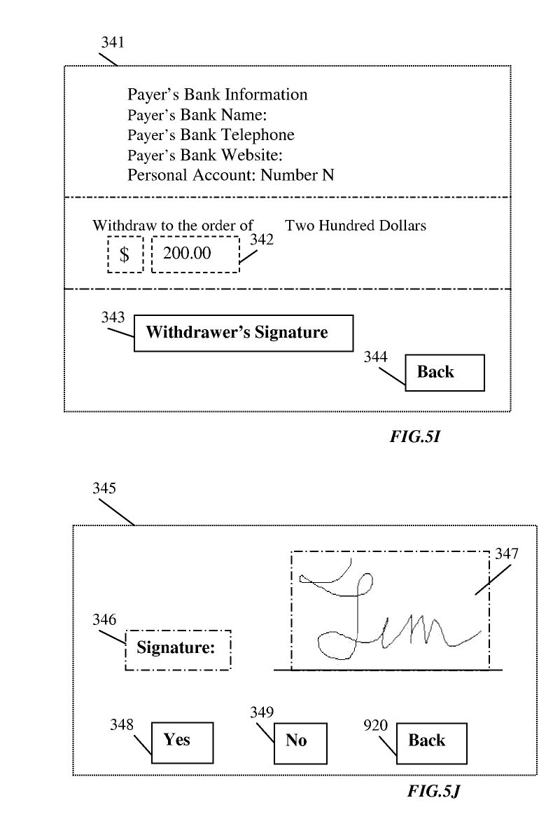

FIG. 4A: present invention there is provided an AMPA device to store Personal Account File which person can maintain, calculate and search information which includes receipt information, credit card information, personal bank account information etc. And an AMPA device of user can verify whether received information is valid in order to store digital data in personal account information in memory of an AMPA device. And an AMPA device utilizes software program to create Electrical Payment Check (EPC) for payment to payee's bank and to create Electrical WithDrawal (EWD) for withdrawal money from ATM machine such as Changing ATM machine. Personal Account File 120 comprising: Identify File 121: storing AMPA identity to illustrate that is a registered AMPA device; storing source address including AMPA IP address information and also destination IP address of service systems for communication with wireless network. Each packet is transmitted from AMPA device to destination appending to AMPA identity, source IP address and destination IP address.

Number File 122: storing Digital Number 123 to create digital represent image data of digital data embedding in Electrical Text such as Electrical Payment Check or Electrical WithDrawal; And storing Letter Number 124 to create digital represent image data of letter data embedding in Electrical Text such as Electrical Payment Check or Electrical WithDrawal.

Credit Report File 125: storing credit report information from security service system to elevate credit degree of an AMPA device of user depend on an AMPA device action behavior during purchasing transaction session. Message File 126: storing messages from service systems. An AMPA device of user receives message from service systems over wireless network communication. And an AMPA device of user can respond message issued to service systems with an AMPA device or saves messages into a corresponding file to be personal account information in memory of an AMPA device of user so that an AMPA device of user is very convenient to search purchasing transaction history. Credit Card Identity File 127: storing credit card identity information 128 from payee's bank service system. and an AMPA device of user can choose credit card identity information to purchase transaction with merchant and creates credit card information embedding in Electrical Text such as Electrical Payment Check or Electrical WithDrawal. Receipt File 129: storing receipt information 130 from payee's bank service system. And an AMPA device of user can responding receipt message with respond type such as confirmed receipt, denied receipt and cancelled receipt to service systems in order to purchasing transaction events and saves respond receipt information in Receipt File 129. Total Charges Files 131: storing total current charges information 132 that is calculated by software program in an AMPA device in order to receipt information 130 to identify whether statement from payee's bank is valid. Electrical Payment Check File 133 comprising: storing Electrical Payment Check (EPC) credit card identity Number N information 134 to search confirmed EPC and sent EPC history; and also entering Creating Electrical Payment Check (EPC) 135 step to create Electrical Payment Check (EPC). ATM Electrical WithDrawal (EWD) File 136 comprising: ATM EWD Account Number N information 137 to search confirmed EWD And sent EWD history; and also enters Creating Electrical WithDrawal (EWD) 138 step to create Electrical WithDrawal. Personal Bank Account File 139 comprises: Bank Account Information 140 and Bank Account Balance 141. Bank Account Information 140: storing bank account information from payer's bank service system. An AMPA device of user can choose personal account information to create bank account information embedding in Electrical Text such as Electrical Payment Check or Electrical WithDrawal. Bank account balance 141: storing bank account balance information which is calculated by software program of an AMPA device in order to store data in EPC Credit Card Identity Number N information 134 and ATM EWD Account Number N information 137 to identify whether the statement from bank is valid.

FIG. 4B: continuing illustration reference present invention “Personal Account File 120 in FIG. 4A”. An AMPA device of user touches “Identity File” key 121 in FIG. 4A to enter Identity File 145 diagram in FIG. 4B. In this present invention FIG. 4B diagram illustration. Identity File 145 comprising: AMPA identity, IP address of AMPA device, IP address of security service system, and IP address of bank service systems include payer's bank service system and payee's bank service system 146. And “Back” key 147. In 146 diagrams, AMPA Identity and IP address of AMPA devices are provided by insures service system to an AMPA device of user. IP address of security service system is provided by security service system to an AMPA device of user. IP address of payee's bank service system is provided by payee's bank service system which provides credit card identity information to an AMPA device of user. IP address of payer's bank service system is provided by payer's bank service system which provides bank account information to an AMPA device of user. Stored data in identity file is nonvolatile in memory and the user could not change them. An AMPA device of user transmits packets appending AMPA identity and AMPA IP address and also corresponding to IP address of destination service system. An AMPA device of user touches “Back” key 147 in FIG. 4B to back “Personal Account File 120” in FIG. 4A.

FIG. 4C: continuing reference present invention “Personal Account File 120” in FIG. 4A. An AMPA device of user touches “Number File” key 122 in FIG. 4A to enter Number File 150 diagram in FIG. 4C. In this present invention FIG. 4C diagram illustration. Number File 150 in FIG. 4C comprises: “Digital Number” key 151, “Letter Number” key 152 and “Back” key 153. An AMPA device of user touches “Back” key 153 in FIG. 4C to back “Personal Account File 120” in FIG. 4A. “Digital Number” key 151 is provided to an AMPA device to enter digital represent image data of digital number data information. For example: An AMPA device of user touches “Digital Number” key 151 to display digital represent image data of digital number information diagram 155 in FIG. 4D. “Letter Number” key 152 is provided to an AMPA device to enter digital represent image data of letter number data information. For example: An AMPA device of user touches “Letter Number” key 152 to display digital represent image data of letter number information diagram 160 in FIG. 4E.

FIG. 4D: continuing reference present invention “Number File” 150 in FIG. 4C. An AMPA device of user touches “Digital Number” key 151 in FIG. 4C to enter digital represent image data of digital number information 155 in FIG. 4D. In this present invention FIG. 4D diagram illustration. Digital Number 155 comprising: digital number from “0 to 9” key and some “sign” key. And “Enter” key 156, “Back” key 157 and “Cancel” key 158. Digital Number creates digital represent image data such as payment date or digital data of payment amount data embedding in Electrical Text such as Electrical Payment Check (EPC) or digital data of withdrawal amount data in Electrical WithDrawal (EWD). For example1: creating digital represent image data of digit date in digital number such as 12/02/07 in Electrical Text: An AMPA device of user touches “Digital Number” key 155 in FIG. 4D to choose key: “1, 2,/, 0, 2,/, 0, 7” then, touching “Enter” key 156 with stylus on touch screen of an AMPA device to embed digital represent image data of digital number “12/02/07” in Electrical Text. For example 2: creating payment amount digital represent image data of digital number $100.00 in EPC: An AMPA device of user touches “Digital Number” key “$, 1, 0, 0,” in 155 FIG. 4D to create digital represent image data of digital number $100.00, then touch “Enter” key 156 with stylus on touch screen of an AMPA device to embed digital represent image data of digital number $100.00 in Electrical Text such as Electrical Payment Check (EPC). An AMPA device of user touches “Enter” key 156 to embed digital data in Electrical Text. An AMPA device of user touches “Cancel” key 158 to delete digital data which an AMPA device of user chose before. An AMPA device of user touches “Back” key 157 to back “Number File 150” in FIG. 4C. An AMPA device of user touches “sign” and “digital data” key in 155 to calculate data and display will show result of data on touch screen.

FIG. 4E: continuing reference present invention “Number File” 150 in FIG. 4C. An AMPA device of user touches “Letter Number” key 152 in FIG. 4C to enter digital represent image data of letter number information 160 in FIG. 4E. In this present invention FIG. 4E diagram illustration. “Letter Number” key 160 in FIG. 4E comprising: digital represent image data of letter number from “Zero to Nineteen and Twenty, Thirty, Forty, Fifty, Sixty, Seventy, Eighty, Ninety” key and also unit include “Billion, Million, Thousand, Hundred, Cents” keys 161 and “Enter” key 162, “Back” key 163, and “Cancel” key 164. Letter Number creates digital represent image data of letter number data in Electrical Text such as payment amount data of letter number data embedding in Electrical Payment Check (EPC) or withdrawal data of letter number data embedding in Electrical WithDrawal (EWD). For example3: creating “One Hundred” digital represent image data of letter number data for payment amount in an EPC. An AMPA device of user touches “one” key in 160 and “Hundred” key in 161, then touch “Enter” key 162 with stylus pen on touch screen to embed “One Hundred” digital represent image data of letter number data in Electrical Text such as EPC. An AMPA device of user touches “Back” key 163 in FIG. 4E to back “Number File” 150 in FIG. 4C. AMPA devices of user touches “Cancel” key 164 to delete digital represent image data of letter number data in Electrical Text which user chose before.

FIG. 4F: continuing reference present invention “Personal Account File 120” in FIG. 4A. An AMPA device of user touches “Credit Report File” 125 key in FIG. 4A to enter Credit Report File 170 diagram in FIG. 4F. In this present invention FIG. 4F diagram illustration. Credit Report File 170 in FIG. 4F comprising: credit report information 171, security service information 172 and “Next” key 173, “Back” key 174 and “Delete” key 175. Credit Reports Information 171 is provided by security service system including: Credit card identity number N; Payee's Bank name is that provides credit card identity number N to an AMPA device of user; And Payee's Bank telephone number is that the Payee's bank can communicate with an AMPA device of user by telephone; Payee's Bank website provides that an AMPA device of user can search more Payee's bank information online; Credit Report Information is issued from security service system with credit report time and date; Security service information 172 including: Security Service Name is that elevates credit degree and transmits credit report to an AMPA device of user; Security Service Telephone number is that an AMPA device of user can communicate with security service by telephone; Security service website provides that an AMPA device of user can search more security service information online. An AMPA device of user touches “Next” key 173 to search next Credit Report information under next credit card identity number. An AMPA device of user touches “Back” key 174 in FIG. 4F to back “Personal Account File 120” in FIG. 4A. An AMPA device of user touches “Delete” key 175 to delete credit report information 171 or 172 from memory of an AMPA device of user.

FIG. 4G: continuing reference present invention “Personal Account File 120” in FIG. 4A. An AMPA device of user touches “Message File” key 126 in FIG. 4A to enter “Message File” 177 diagram in FIG. 4G. In this present invention FIG. 4G diagram illustration. An AMPA device of user receives message from service systems over wireless network and stores message in Message File 177. “1 to N message” key 178 is provided to an AMPA device of user for chooses message which she/he wants to read message information. For example: An AMPA device of user touches “message N” key in 178 to display message (N) information diagram 180 in FIG. 4H. An AMPA device of user touches “Back” key 179 in FIG. 4G to back “Personal Account File 120” in FIG. 4A.

FIG. 4H: continuing reference present invention “Message File” key 178 in FIG. 4G. An AMPA device of user touches “message N” key in 178 to display message (N) information diagram 180 in FIG. 4H. In this present invention FIG. 4H diagram illustration. Message N information diagram 180 in FIG. 4H comprising: “Responding Type” key 181, message information N 182, “Back” key 183, “Delete” key 184 and “Save” key 185. “Responding Type” key 181 comprising: “confirmed, denied, cancelled and complain” key. To choose one of responding type depends on an AMPA device of user decision. An AMPA device of user receives receipt message from bank service system including payee's bank service system and payer's bank service system and respond message with responding type to third service system. For example: An AMPA device of user receives Message information N 182 and wants to respond message N 182 with responding type to third service system. And if an AMAP device of user decided to choose responding type such as confirmed, then display responding message N 182 with confirmed diagram 186 in FIG. 4I. An AMPA device of user touches “Back” key 183 in FIG. 4H to back “Message File 177” in FIG. 4G. An AMPA device of user touches “Delete” key 184 to delete message information 182 from memory of an AMPA device of user. AMPA devices of user touches “Save” key 185 to store message information 182 correspond to file in memory.

FIG. 4I: continuing reference present invention message N information 180 in FIG. 4H to display responding message with respond type such as confirmed to third service system diagram 186 in FIG. 4I. In this present invention FIG. 4I diagram illustration. An AMPA device of user touches “Send” key 189 to transmit message information N 188 with respond type confirmed 187 to third service systems. An AMPA device of user touches “Save” key 190 to store responds message information N 188 with respond type confirmed 187 into corresponding file in memory. An AMPA device of user touches “Back” key 191 in FIG. 4I to back “Message File” diagram 177 in FIG. 4G.

FIG. 4J: continuing reference present invention “Personal Account File 120” in FIG. 4A. An AMPA device of user touches “Credit Card Identity File” key 127 in FIG. 4A to enter Credit Card Identity file 192 in FIG. 4J. In this present invention FIG. 4J diagram illustration. Credit Card Identity File 192 in FIG. 4J comprising: “Credit Card Identity number from 1 to N” key 193 and “Back” key 194. An AMPA device of user touches “Back” key 194 in FIG. 4J to back “Personal Account File 120” in FIG. 4A. “Credit Card Identity Number N” key 193 is provided to an AMPA device of user searching credit card information with identity number N. For example: An AMPA device of user touches “Credit Card Identity Number N” key in 193 to display credit card information with identity number N diagram 195 in FIG. 4K.

FIG. 4K: continuing reference present invention Credit Card Identity File 192 in FIG. 4J. An AMPA device of user touches “Credit Card Identity Number N” key in 193 to display credit card information with identity number N diagram 195 in FIG. 4K. In this present invention FIG. 4K diagram illustration. Credit card identity number N information 195 comprising: payee's bank provided credit card identity number N information 196, and “Send” key 197, “Back” key 198, “Delete” key 199, “Next” key 200 and “Enter” key 201. Payee's Bank Information 196 comprising: Payee's Bank name is that bank provided a credit card identity number N to an AMPA device of user. Payee's Bank telephone is that the bank can communicate with an AMPA device by telephone. Payee's Bank Website is that an AMPA device of user can search more information about personal credit card account from the bank online. Expire date of Credit card identity number N is provided by Payee's bank. An AMPA device of user touches “Send” key 197 to transmit credit card identity information to third service system. An AMPA device of user touches “Back” key 198 in FIG. 4K to back “credit card identity file 192 in FIG. 4J. An AMPA device of user touches “Delete” key 199 to delete credit card identity number N information 196 from memory of an AMPA device of user. An AMPA device of user touches “Next” key 200 to search next credit card identity number information. An AMPA device of user touches “Enter” key 201 to embed credit card identity number N information in Electrical Text such as EPC or EWD.

FIG. 4L: continuing reference present invention “Personal Account File 120” in FIG. 4A. An AMPA device of user touches “Receipt File” key 129 in FIG. 4A to enter Receipt File 202 diagram in FIG. 4L. In this present invention FIG. 4L diagram illustration. Receipt File 202 comprising: credit card identity number from 1 to N and corresponding to “receipt number from 1 to N” key in 203. And “Back” key 204. An AMPA device of user touches “Back” key 204 in FIG. 4L to back “Personal Account File 120” in FIG. 4A. Credit card identity is used to purchase goods/service by an AMPA device of user. “Receipt number from 1 to N” key 203 is provided to an AMPA device of user who searches receipt history information under the credit card identity. For example, an AMPA device of user wants to search receipt N information with credit card identity such as number N, then she/he touches “Receipt Number N” key in 203 under Credit Card Identity Number N to display receipt number N information diagram 205 in FIG. 4M.

FIG. 4M: continuing reference present invention “Receipt File” 202 in FIG. 4L to display receipt number N information diagram 205 in FIG. 4M. In this present invention FIG. 4M diagram illustration. For example: an AMPA device of user responds receipt message N with confirmed to third service system and saved responded message in “Receipt File” 202 in FIG. 4L. Receipt number N information 205 comprising: confirmed receipt number N information 206, purchased information 207 and “Enter” key 208, “Back” key 209, “Delete” key 210 and “Next” key 211.

Confirmed receipt number N information 206 including: Respond type such as confirmed; Credit card identity such as number N; Purchasing transaction time such as 12:00 pm and date such as Dec. 1, 2006; And business service Telephone:

Receipt data such as

| | |
|---|---|
| Orange juice | 20.00 |
| LCTD 5 RF | 10.00 |
| Balance | 30.00 |
| Tax | 2.00 |
| Balance Due | 32.00 |

Purchased information 207 including: Sale date such as Dec. 1, 2006; a business license is business service license such as MX4BBK6K; Purchase Address that is business service address such as CVS PHARMACY SMITHFIELD NC. Amount is balance due such as 32.00. An AMPA device of user touches “Enter” key 208 to transfer digital data of purchasing information 207 into Total Charges File 131 in FIG. 4A. An AMPA device of user touches “Back” key 209 to back “Receipt File” 202 in FIG. 4L An AMPA device of user touches “Delete” key 210 to delete receipt information 206 and purchasing information 207 from memory of an AMPA of user. An AMPA device of user touches “Next” key 211 to search next receipt number information.

FIG. 4N: continuing reference present invention “Personal Account File 120” in FIG. 4A. An AMPA device of user touches “Total Charges File” key 131 in FIG. 4A to enter “Total Charges File 212” diagram in FIG. 4N. In this present invention FIG. 4N diagram illustration. “Total Charges File 212” diagram in FIG. 4N comprising: “credit card identity number from 1 to N” key 213 and “Back” key 214. An AMPA device of user touches “Back” key 214 in FIG. 4N to back “Personal Account File 120” in FIG. 4A. An AMPA device of user touches “Credit Card Identity Number N” key 213 to display Total Charges information under credit card identity number N. For example: If An AMPA device of user wants to search total charge information with credit card identity, then touches credit card identity: such as number N to display total charges information under credit card number N diagram 215 in FIG. 4O.

FIG. 4O: continuing reference present invention “Total Charges File 212” diagram in FIG. 4N to display total charges information under credit card number N diagram 215 in FIG. 4O. In this present invention FIG. 4O diagram illustration. Total Charges Information 215 comprising: Credit Card Identity Number N 216, Total Purchased information 217, Total Current Charge information 220, “Creating Electrical Payment Check (EPC)” key 228 and “Back” key 229, “Delete” key 230 and “Next” key 231. Total Purchased Information 217 collecting: Sale Date, Business Licensee, and Purchase Address amount. Total Purchase Information 217 lists each purchased information 207 in FIG. 4M And an a acquirement device of an AMPA device adds amount of each purchasing information 207 in FIG. 4M to obtain Purchases Total amount 218 such as 32.00 in place 219.

Total current charges information 220 comprising: Previous Balance 221, Purchases Total Amount 222, Payment 223 and New Balance 224 under the purchase 225. PreviousBalance 221 is total amount before payment. For example, an AMPA device of user previous payment is $120.00.

(+) Purchase Total Amount 218 is purchased total amount 222. For example, An AMPA device or user needs to payment purchase total amount 222 is $32.00. (−) Payment 223 is that an AMPA device had amount of payment to payee's bank. For example, an AMPA device of user made payment $120.00. And a acquirement of an AMPA device acquires new balance: [(=) New balance] 224=[Previous Balance] 221+[(+) Purchase Total Amount] 218−[(−) Payment] 223.

Total Current Charges 226=[new balance] 227.

For example in special case: Previous Balance 221=120.00; (+) Purchases Total Amount 218=32.00; (−) Payment 223=120.00.

[(=) New Balance 224]=[Previous Balance 221]+[(+) Purchases Total Amount 218]−[(−) Payment 223]=120.00+32.00−120.00=32.00.

Total Current Charges 226=$32.00 in place 227.

An AMPA device of user touches “Creating Electrical Payment Check (EPC)” key 228 to enter creating an Electrical Payment Check (EPC) step 234 in FIG. 4P to create EPC for making payment to payee's bank. An AMPA device of user touches “Back” key 229 to back “Total Charges File 212” in FIG. 4N. An AMPA device of user touches “Delete” key 230 to delete one of Total Purchased Information 217, then, the purchases Total Amount 218, Total Current Charges Information 220 and Total Current Charges 226 will be recalculated by software in AMPA device. An AMPA device of user touches “Next” key 231 to enter next total charges information under credit card identity number.

FIG. 4P: continuing reference present invention “Personal Account File 120” in FIG. 4A. An AMPA device of user touches “Electrical Payment Check File” key 133 in FIG. 4A to enter “Electrical Payment Check File 232” in FIG. 4P. In this present invention FIG. 4P diagram illustration. Electrical Payment Check File 232 in FIG. 4P comprising: “EPC Credit Card Identity Number from 1 to N” key 233, “Creating EPC” key 234 and “Back” key 235. An AMPA device of user touches “Back” key 235 in FIG. 4P to back “Personal Account File 120” in FIG. 4A. An AMPA device of user touches “Creating EPC” key 233 to enter creating EPC step processing diagram 263 in FIG. 4T.

EPC Credit Card Identity Number is provided to an AMPA device of user searching EPC history which includes received confirmed EPC and sent EPC under credit card identity number. For example, An AMPA device of user touches “EPC Credit Card Identity Number N” key 233 to display Electrical Payment Check (EPC) information under credit card identity number N diagram 236 in FIG. 4Q.

FIG. 4Q: continuing reference present invention “Electrical Payment Check File 232” in FIG. 4P to display Electrical Payment Check (EPC) information under credit card identity number N diagram 236 in FIG. 4Q. In this present invention FIG. 4Q diagram illustration. Electrical Payment Check (EPC) information 236 comprising: under “EPC Credit Card Identity Number N 237”, “Confirmed EPC” key 238, “Sent EPC” key 239 and “Back” key 240. EPC Credit Card Identity Number N 237 is mean that an AMPA device of user payment with EPC to payee's bank according to credit card identity number N. “Confirmed EPC” key 238 is provided to an AMPA device to search received confirmed EPC information from payer's bank service system to prove successfully transferring funds from account of payer who is an AMPA device of user to payee's bank process. For example, An AMPA device of user touches “Confirmed EPC” key 238 to display Confirmed EPC diagram 241 in FIG. 4R. “Sent EPC” key 239 is provided to an AMPA device of user for searching “Sent EPC” information which she/he transmitted EPC to third service systems before she/he receives confirmed EPC information from third service systems in order to payment date. For example, An AMPA device of user touches “Sent EPC” key 239 in FIG. 4Q to display Sent EPC diagram 253 in FIG. 4S. An AMPA device of user touches “Back” key 240 in FIG. 4Q to back display diagrams 232 in FIG. 4P.

FIG. 4R: continuing reference present invention “Confirmed EPC” key 238 in FIG. 4Q to display Confirmed EPC diagram 241 in FIG. 4R. In this present invention FIG. 4R diagram illustration.

Confirmed EPC information 241 comprising: payee's bank 242 information 243, payer's bank 247 information 248, confirmed information 244, 245 and 246, payer's signature 249; and “Back” key 250, “Delete” key 251 and “Next” key 252. Payee's bank 242 is that provide credit card identity number N to an AMPA device of user who is payer 249 to purchase transaction with merchant.

Payee's bank 242 also obtained payments from personal account of payer 249 in payer's bank 247 according to payment amount information 246 such as letter number “one hundred dollars” and digital number “$100.00”. Payee's bank information 243 includes Payee's Bank Name, Payee's Bank Telephone, and Credit Card Identity Number such as N. Expire Date of credit card identity number N. Payer's Bank 247 provides personal account number N to an AMPA device of user and transfer money from personal account number N of payer 249 to payee's bank 242 in order to payment amount 246 in EPC. Payer's bank information 248 includes Payer's Bank Name, Payer's Bank Telephone, and Personal Account Number such as N. Confirmed information is which mean that having transferred money from personal account N of payer 249 to payee's bank 242. And payer's bank 247 confirmed words “thank you for payment” 244 and payment date such as Feb. 2, 2006 and time such as 02:00 pm 245 and amount of money such as $100.00 246. An AMPA device of user who is payer 249 received confirmed EPC information 241 from payer's bank 247 and stores message in “Confirmed EPC” 238 in FIG. 4Q under “Electrical Payment Check File 232” in FIG. 4P to prove that payer made payment to payee's bank according to EPC. Payer's signature 249 such as Jim provides identifying that payment information 246 is provided by payer who is an authority to use a registered an AMPA device with personal account number N in payer's bank.

An AMPA device of user touches “Back” key 250 in FIG. 4R to back display “EPC information” diagram 236 in FIG. 4Q. An AMPA device of user touches “Delete” key 251 to delete confirmed EPC information 241 from memory of an AMPA device of user. An AMPA device of user touches “Next” key 252 to search next confirmed EPC information.

FIG. 4S: continuing reference present invention “Sent EPC” key 239 in FIG. 4Q to display Sent EPC diagram 253 in FIG. 4S. In this present invention FIG. 4S diagram illustration. An AMPA device of user touches “Sent EPC” key 239 in FIG. 4Q to display sent EPC information diagram 253 in FIG. 4S. Sent EPC information 253 comprising: payee's bank information 254, payment date 255, payer's bank information 257, payment information 256, payer's signature 258 and sent EPC date and time information 259; And “Back” key 260, “Delete” key 261 and “Next” key 262. Payee's bank information 254 is that payee's bank provides credit card identity number N to an AMPA device of user who is payer 258. Payee's bank information 254 includes Payee's Bank name, Payee's Bank Telephone, Payee's Bank Website, Credit Card Identity Number such as N. Expire Date of credit card identity number N. Payer's bank information 257 is that payer 258 provides personal account number N 257 information and the payer 258 will use this personal account number N for payment to payee's bank 254. So that payer's bank 257 can transfer money from account number N of payer 258 to payee's bank 254 in order to payment information 256.

Payer's bank information 257 includes Payer's Bank Name, Payer's Bank Telephone, Payer's Bank Website, and Personal Account Number such as N. Payment information 256 is that payer 258 will make payment to payee's bank 254 amount money such as $100.00 dollars. Payment information 256 includes payment amount of money in digital represent image data of letter number such as “one hundred” and digital represent image data of digital number $100.00. Payer's signature 258 such as Jim is that identifying this EPC information 253 is created by payer 258 such as Jime. Sent EPC date 259 such as Dec. 21, 2006 and time such as 02:00 pm is remaining that an AMPA device of user who had sent EPC information to third service systems at time. Payment date 255 such as Jan. 2, 2007 is mean payer's bank can transfer funds to payee's bank according to payment date. An AMPA device of user touches “Back” key 260 to back display “EPC information” diagram 236 in FIG. 4Q. An AMPA device of user touches “Delete” key 261 to delete sent EPC information 253 from memory of an AMPA device of user. An AMPA device of user touches “Next” key 262 to search next sent EPC information.

FIG. 4T: Continuing reference present invention Electrical Payment Check (EPC) 234 in FIG. 4P to enter creating Electrical Payment Check (EPC) step with an AMPA device. An AMPA device of user touches “Creating EPC” key 234 in FIG. 4P to enter creating EPC step processing diagram 263 in FIG. 4T. In this present invention FIG. 4T diagram illustration. An AMPA device of user touches “Creating EPC” key 234 in FIG. 4P or key 228 in FIG. 4O to enter creating EPC step1: Electrical Payment Check (EPC) 263 in FIG. 4T. In FIG. 4T diagram 263 illustrations that payee's Bank information 264 and “credit card identity information” key 265. Payee's Bank 264 remains payer to choose one of credit card identity from credit card identity information 265 which is provided by payee's bank 264 to an AMPA device of user. For example: an AMPA device of user wants to choose credit card identity which is stored in “Credit Card Identity File 192” in FIG. 4J and number is N. An AMPA device of user touches “credit card identity information” key 265 in FIG. 4T to enter “Credit Card Identity File 192” in FIG. 4J and then continues to touch “Credit Card Identity number N” 193 key in FIG. 4J to enter credit card identity number N information 195 in FIG. 4K and then continuing to touch “Enter” key 201 in FIG. 4K to embed “credit card identity information” 196 in EPC diagram 267 in FIG. 4U to display payee's bank information 268 in FIG. 4U. An AMPA device of user touches “Back” key 266 in FIG. 4T to Back “Electrical Payment Check File 232” in FIG. 4P. And an AMPA device of user continues creating EPC to step 2 in FIG. 4U:

FIG. 4U: Continuing reference present invention creating EPC step1 in 263 FIG. 4T to step 2 in FIG. 4U. In this present invention creating EPC step 2 in 267 FIG. 4U diagram illustrations. In FIG. 4U diagram 267 illustration that payee's bank information 268 and “Enter Payment Date” key 269 and “Back” key 270. An AMPA device of user touches “Enter Payment Date” key 269 to create digital represent image data of digital number of payment date 272 such as Feb. 1, 2007 in FIG. 4V in order to illustration Digital Number diagram 155 in FIG. 4D and display EPC diagram 271 in FIG. 4V. An AMPA device of user touches “Back” key 270 in FIG. 4U to back display diagrams 263 in FIG. 4T. And an AMPA device of user continues creating EPC to step 3 in FIG. 4V:

FIG. 4V: Continuing reference present invention creating EPC step 2 in 267 FIG. 4U to step 3 in FIG. 4V. In this present invention creating EPC step 3 in 271 FIG. 4V diagram illustrations. In FIG. 4V diagram 271 illustration that payee's bank information, payment date 272 and pay to the order of 273 with “Enter Letter Number” key 274 and “Back” key 275. Pay to the Order of 273 remains that payer input payment amount of digital represent image data of letter number in EPC.

An AMPA device of user touches “Enter Letter Number” key 274 to create digital represent image data of letter number (such as One Hundred Dollars) 277 in FIG. 4W in order to illustration letter number diagram 160 in FIG. 4E and display EPC diagram 276 in FIG. 4W. AMPA devices of user touches “Back” key 275 in FIG. 4V to back display diagram 267 in FIG. 4U. And an AMPA device of user continues creating EPC to step 4 in FIG. 4W:

FIG. 4W: Continuing reference present invention creating EPC step 3 in 271 FIG. 4V to step 4 in 276 FIG. 4W. In this present invention creating EPC step 4 in 276 FIG. 4W diagram illustrations. In FIG. 4W diagram 276 illustration that payee's bank information, payment date, pay to the order of One Hundred Dollars 277 and money sign “$” 278 with “Enter Digital Number” key 279 and “Back” key 280. Money sign “$” 278 remains payer that input payment amount money of digital represent image data of digital number correspond to payment amount of digital represent image data of letter number 277 such as One Hundred. An AMPA device of user touches “Enter Digital Number” key 279 to create digital represent image data of digital number (such as 100.00) 282 in FIG. 4X in order to illustration digital number diagram 155 in FIG. 4D and display EPC diagram 281 in FIG. 4X. An AMPA device of user touches “Back” key 280 in FIG. 4W to back display EPC diagrams 271 in FIG. 4V. And an AMPA device of user continues creating EPC to step 5 in FIG. 4X:

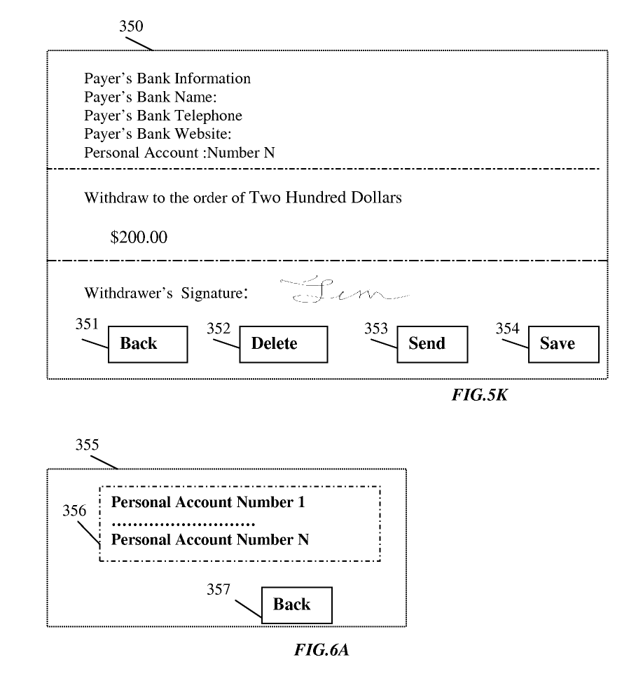

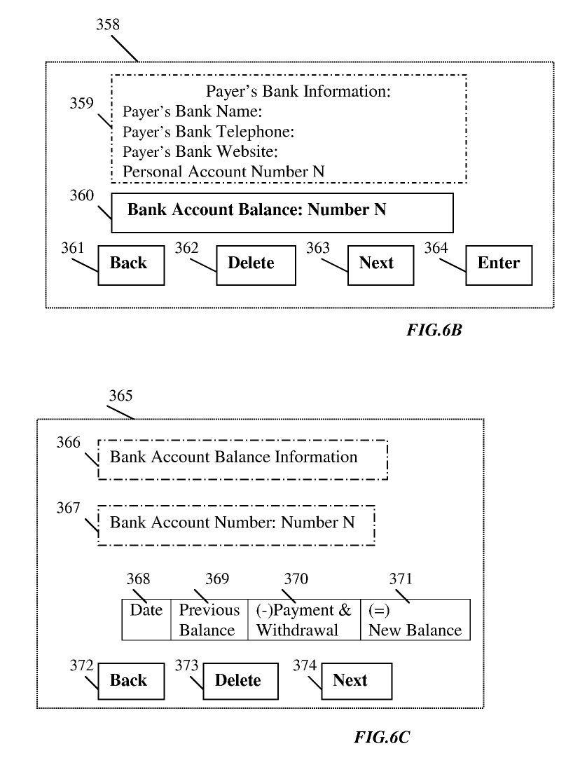

FIG. 4X: Continuing reference present invention creating EPC step 4 in 276 FIG. 4W to step 5 in 281 FIG. 4X. In this present invention creating EPC step 5 in 281 FIG. 4X diagram illustrations. In FIG. 4X diagram 281 illustration that payee's bank information, payment date, pay to the order of letter number such as One Hundred Dollars and digital number 282 such as $100.00 are embedded in EPC. And Payer's bank information 283 with “Bank Account Information” key 284 and “Back” key 285. Payer's bank information 283 remains that payer choose a bank account number N from payer's bank. An AMPA device of user touches “Bank Account Information “key 284 to enter” Personal Bank Account File 355 in FIG. 6A. And then continuing to touch “Personal Account Number N” key 356 in FIG. 6A to enter “Bank Account Information” 358 in FIG. 6B. And then continuing to touch “Enter” key 364 in FIG. 6B to embed “Payer's Bank Information 359” FIG. 6B in diagram EPC 286 FIG. 4Y and display payer's bank information 287 in FIG. 4Y. An AMPA device of user touches “Back” key 285 in FIG. 4X to back display EPC diagrams 276 in FIG. 4W. And an AMPA device of user continues creating EPC to step 6 in FIG. 4Y:

FIG. 4Y: Continuing reference present invention creating EPC step 5 in 281 FIG. 4X to step 6 in FIG. 4Y. In this present invention creating EPC step 6 in 286 FIG. 4Y diagram illustrations.

In FIG. 4Y diagram 286 illustration that payee's bank information, payment date, pay to the order of letter number such as One Hundred Dollars and digital number such as $100.00, payer's bank information 287 are all embedded in EPC, and “payer's signature” key 288 and “Back” key 289.

Payer's signature 288 remains payer sign signature identity to identify that an authorized user creating EPC. An AMPA device of user touches “payer's signature” key 288 in FIG. 4Y and display sign diagram 290 in FIG. 4Z. An AMPA device of user touches “Back” key 289 in FIG. 4Y to back display diagrams 281 in FIG. 4X. And an AMPA device of user continues creating EPC to step 7 in FIG. 4Z:

FIG. 4Z: Continuing reference present invention creating EPC step 6 in 286 FIG. 4Y to step 7 in FIG. 4Z. In this present invention creating EPC step 7 in 290 FIG. 4Z diagram illustrations. In FIG. 4Z diagram 290 illustration that signature 292 and “Yes” key 293, “No” key 294 and “Back” key 295.

Signature 292 remains payer to sign authority signature (such as Jim) in place 291. If authorized user did not satisfy her/his signature, then touching “No” key 294 to delete signature 291 and authorized user can resign again. If authorized user satisfied her/his signature, then touching: “Yes” key 293 to display EPC diagram 296 in FIG. 5A If authorized user wants to cancel sign process and come back step 6, then touching: “Back” key 295 in FIG. 4Z to back diagram 286 FIG. 4Y.

FIG. 5A: Continuing reference present invention creating EPC step 7 in 290 FIG. 4Z that If authorized user satisfied her/his signature, then touching: “Yes” key 293 to step 8 display EPC diagram 296 in FIG. 5A. In this present invention creating EPC step 8 in 296 FIG. 5A diagram illustrations. In FIG. 5A diagram 296 illustration that payee's bank information, payment date, pay to the order of letter number such as one hundred dollars and digital number such as $100.00. Payer's bank information, payer's signature such as Jim are all embedded in EPC. And “Back” key 297, “Delete” key 298, “Send” key 299 and “Save” key 300. An AMPA device of user touches “Back” key 297 in FIG. 5A to back display EPC diagrams 286 in FIG. 4Y. An AMPA device of user touches “Delete” key 298 to delete EPC diagram 296 in FIG. 5A from memory of an AMPA device of user.

An AMPA device of user touches “Send” key 299 to transmit digital of image data of EPC 296 in FIG. 5A to third service systems such as payee's bank service system, payer's bank service system and security service system. An AMPA device of user touches “Save” key to store EPC 296 in “Sent EPC File 239” in FIG. 4Q.

FIG. 5B: continuing reference present invention “Personal Account File 120” in FIG. 4A.” An AMPA device of user touches “ATM Electrical WithDrawal (EWD) File” key 136 in FIG. 4A to enter “ATM Electrical WithDrawal (EWD) File” 301 in FIG. 5B. In this present invention FIG. 5B diagram illustration. ATM Electrical WithDrawal File 301 in FIG. 5B comprising: “ATM withdrawal Account Number from 1 to N” key 302, “Creating EWD” key 303 and “Back” key 304. An AMPA device of user touches “Back” key 304 in FIG. 5B to back “Personal Account File 120” in FIG. 4A. An AMPA device of user touches “Creating EWD” key 303 to enter creating EWD step 327 in FIG. 5F. ATM withdrawal Account Number from 1 to N” key 302 is provided to an AMPA device of user to search withdrawal information under bank account number. For example: an AMPA device of user wants to search withdrawal information under bank account number N. An AMPA device of user touches “ATM EWD Account number N” key 302 in FIG. 5B to display Electrical WithDrawal (EWD) information 305 in FIG. 5C

FIG. 5C: continuing reference present invention “ATM Electrical WithDrawal (EWD) File” 301 in FIG. 5B to display Electrical WithDrawal (EWD) information under account number N 305 in FIG. 5C. In this present invention FIG. 5C diagram illustration. EWD information 305 in FIG. 5C comprising: ATM Account Number N 306, “Confirmed EWD” key 307 and “Sent EWD” key 308. ATM Account Number 306 is meaning that an AMPA device of user withdraws money with personal bank account number N 306 from Changing ATM machine. “Confirmed EWD” key 307 is provided to an AMPA device searching received confirmed EWD information from payer's bank service system to prove successfully sent out funds from account of payer to Changing ATM. An AMPA device of user touches “Confirmed EWD” key 307 to enter Confirmed EWD information diagram 310 in FIG. 5D. An AMPA device of user can search for storing Sent EWD information to service system for waiting withdrawal money from Changing ATM machine. “Sent EPC” key 308 is provided to an AMPA device of user who searches “sent EWD” information which she/he transmitted EWD to third service systems for withdrawal money from changing ATM machine. An AMPA device of user touches “Sent EWD” key 308 to enter Sent EWD information diagram 319 in FIG. 5E. An AMPA device of user touches “Back” key 309 in FIG. 5C to back display ATM EWD File diagram 301 in FIG. 5B.

FIG. 5D: continuing reference present invention “Confirmed EWD” key 307 in FIG. 5C to display Confirmed EWD diagram 310 in FIG. 5D. In this present invention FIG. 5D diagram illustration.

Confirmed EWD information 310 in FIG. 5D comprising: payer's bank information 311, confirmed information 312, 313 and 314; payer's signature 315. And “Back” key 316, “Delete” key 317 and “Next” key 318. Payer's bank information 311 is that the payer's bank provides personal account number to withdrawer. Confirmed information is that payer's bank 311 had transferred money from personal account number N of withdrawer who is an AMPA device of user to Changing ATM machine in order to EWD of withdrawer. And payer's bank 311 given confirmed words “Thank you use ATM machine” 312 and withdrawn date 313 such as Mar. 11, 2006 and time such as 02:30 pm and withdrawn amount money 314 such as Two Hundred Dollars and $200.00 from personal account number N in payer's bank 311. Withdrawer's signature 315 such as Jim provides to identify that EWD information 310 is provided by withdrawer who has personal account number N in payer's bank and an authority to use a registered an AMPA device. An AMPA device of user touches “Back” key 316 in FIG. 5D to back display “EWD information” 305 diagram in FIG. 5C. An AMPA device of user touches “Delete” key 317 to delete confirmed EWD information 310 from memory of an AMPA device. An AMPA device of user touches “Next” key 318 to search next confirmed EWD information.

FIG. 5E: continuing reference present invention touching “Sent EWD” key 308 in FIG. 5C to display Sent EWD Information diagram 319 in FIG. 5E. In this present invention FIG. 5E diagram illustration. Sent EWD information 319 in FIG. 5E comprising: payer's bank information 320, WithDrawal information 321, withdrawer's Signature 322 and sent EWD date and time 323; “Back” key 324, “Delete” key 325 and “Next” key 326. Payer's Bank 320 provides personal account number N to an AMPA device of user and also provides Changing ATM machine for withdrawal. Withdrawal information 321 indicates that withdrawal money amount in digital represent image data of letter number such as Two Hundred Dollars and in digital represent image data of digital number such as $200.00. Payer's Bank 320 in order to withdraw information 321 to sent money from personal account number N of withdrawer to output of changing ATM machine which withdrawer who is an AMPA device of user have to take money place. Withdrawer's signature 322 identifies that EWD information 319 is created by Withdrawer such as Jime. Sent EWD date 323 such as Mar. 11, 2006 and time such as 02:10 remain that an AMPA device of user had sent EWD information to third service system. An AMPA device of user touches “Back” key 324 to back display “EWD information” diagram 305 in FIG. 5C. An AMPA device of user touches “Delete” key 325 to delete Sent EWD information 319 from memory of an AMPA device of user. An AMPA device of user touches “Next” key 326 to search next Sent EWD information.

FIG. 5F: Continuing reference present invention “ATM Electrical WithDrawal (EWD) File” 301 in FIG. 5B to create Electrical WithDrawal (EWD) with an AMPA device. An AMPA device of user touches “Creating EWD” key 303 in FIG. 5B to enter creating EPC step processing diagram 327 in FIG. 5F. In this present invention FIG. 5F diagram illustration. In FIG. 5F diagram 327 illustration that payer's bank information 328, “Bank Account Information” key 329 and “Back” key 330. Payer's bank information 328 remains that withdrawer chooses one of bank account number from personal account information which is provided by payer's bank to an AMPA device of user. For example: an AMPA device of user wants to choose one of bank account number which is stored in “Personal Bank Account File” 355 in FIG. 6A and number is N. An AMPA device of user touches “Bank Account Information” key 329 in FIG. 5F to enter “Personal Bank Account File 355” in FIG. 6A. And then continuing to touch “Personal Account Number N” key 356 in FIG. 6A to enter “Bank Account Information N” 358 in FIG. 6B. And then continuing to touch “Enter” key 364 in FIG. 6B to embed “Payer's Bank Information N 359” in FIG. 6B into EWD 331 in FIG. 5G to display payer's bank information 332 diagram in FIG. 5G. An AMPA device of user touches “Back” key 330 in FIG. 5F to back “Electrical WithDrawal File” 301 in FIG. 5B. And an AMPA device of user continues creating EWD to step 2 in FIG. 5G.

FIG. 5G: Continuing reference present invention creating EWD step 1 in FIG. 5F to step 2 in FIG. 5G. In this present invention creating EPC step 2 in 331 FIG. 5G diagram illustrations.

In FIG. 5G diagram 331 illustration that payer's bank information 332 and withdrawal to the Order of 333 and “Enter Letter Number” key 334, “Back” key 335. WithDrawal to the Order of 333 remains that withdrawer input withdrawal amount money of digital represent image data of letter number in EWD. An AMPA device of user touches “Enter letter Number” 334 to create digital represent image data of letter number such as Two Hundred Dollars 337 in FIG. 5H in order to illustration letter number diagram 160 in FIG. 4E and display EWD diagram 336 in FIG. 5H. An AMPA device of user touches “Back” key 335 in FIG. 5G to back display EWD diagram 327 in FIG. 5F. And an AMPA device of user continues creating EWD to step 3 in FIG. 5H.

FIG. 5H: Continuing reference present invention creating EWD step 2 in FIG. 5G to step 3 in FIG. 5H. In this present invention creating EPC step 3 in 336 FIG. 5H diagram illustrations.

In FIG. 5H diagram 336 illustration that payer's bank information and withdrawal in the order to such as Two Hundred Dollars 337, sign “$” 338 with “Enter Digital Number” key 339, and “Back” key 340. Money sign “$” 338 remains that withdrawer input withdrawal amount money of digital represent image data of digital number correspond to withdraw amount of digital represent image data of letter number 337 such as Two Hundred. An AMPA device of user touches “Enter Digital Number” key 339 to create digital represent image data of digital number (such as 200.00) 342 in FIG. 5I in order to illustration digital number diagram 155 in FIG. 4D and display EWD diagram 341 in FIG. 5I. An AMPA device of user touches “Back” key 340 in FIG. 5H to back display EPC diagrams 331 in FIG. 5G. And an AMPA device of user continues creating EWD to step 4 in FIG. 5I.

FIG. 5I: Continuing reference present invention creating EWD step3 in FIG. 5H to step 4 in FIG. 5I. In this present invention creating EPC step 4 in 341 FIG. 5I diagram illustrations. In FIG. 5I diagram 341 illustration that payer's bank information, withdrawal in the order to money such as Two Hundred Dollars and ($200.00) 342. And “Withdrawer's Signature” key 343 and “Back” key 344. Withdrawer's Signature 343 remains withdrawer signs signature identity to identify that an authorized user creating EWD. An AMPA device of user touches “Withdrawer's Signature” key 343 in FIG. 5I and display signing diagram 345 in FIG. 5J. AMPA devices of user touches “Back” key 344 in FIG. 5I to back display diagram 336 in FIG. 5H. And an AMPA device of user continues creating EWD to step 5 in FIG. 5J:

FIG. 5J: Continuing reference present invention creating EWD step 4 in FIG. 5I to step 5 in FIG. 5J.

In this present invention creating EPC step 5 in 345 FIG. 5J diagram illustrations. In FIG. 5J diagram 345 illustrations that signature 346, “Yes” key 348, “No” key 349 and “Back” key 920. Signature 346 remains withdrawer to sign authority signature (such as Jim) in place 347.

An AMPA device of user signs signature identity such as Jim 347 with stylus on the screen of an AMPA device. If an authorized user did not satisfy her/his signature, then touching “No” 349 key to delete signature in 347 and an AMPA device of user can resign again with stylus on the screen of an AMPA device. If an AMPA device of user satisfied her/his signature, then touching: “Yes” key 348 to display diagram 350 in FIG. 5K. If authorized user wants to cancel sign process and come back step 4, then touching: “Back” key 920 in FIG. 5J to back diagram 341 FIG. 5I. And an AMPA device of user continues creating EWD to step 6 in FIG. 5K.

FIG. 5K: Continuing reference present invention creating EWD step 5 in FIG. 5J to step 6 in FIG. 5K.

In this present invention creating EPC step 6 in 350 FIG. 5K diagram illustrations. In FIG. 5K diagram 350 illustration that payer's bank information, withdrawal in the order to such as Two Hundred Dollars and $200.00, withdrawer's signature such as Jim, and “Back” key 351, “Delete” key 352, “Send” key 353 and “Save” key 354. AMPA device of user touches “Back” key 351 in FIG. 5K to back display diagram 341 in FIG. 5I. An AMPA device of user touches “Delete” key 352 to delete EWD diagram 350 in FIG. 5K from memory of an AMPA device of user. An AMPA device of user touches “Send” key 353 to transmit digital represent of image data of EWD 350 in FIG. 5K to third service system such as payer's bank service system, and security service system. An AMPA device of user touches “Save” key 354 to store EWD 350 FIG. 5K in Sent EWD File 308 in FIG. 5C.

FIG. 6A: continuing reference present invention “Personal Account File 120” in FIG. 4A. An AMPA device of user touches “Personal Bank Account File” key 139 in FIG. 4A to enter “Personal Bank Account File” 355 in FIG. 6A. In this present invention FIG. 6A diagram illustration.

Personal Bank Account File 355 in FIG. 6A comprising: “Personal Account Number from 1 to N” key 356 and “Back” key 357. An AMPA device of user touches “Back” key 357 in FIG. 6A to back “Personal Account File” 120 in FIG. 4A. “Personal Account Number from 1 to N” key 356 is provided to an AMPA device of user to choose one of personal account number. For example: an AMPA device of user wants to choose personal account number N. An AMPA device of user touches “Personal Account Number N” key in 356″ to display payer's bank information diagram 358 in FIG. 6B

FIG. 6B: Continuing reference present invention “Personal Bank Account File” in FIG. 6A to display payer's bank information diagram 358 in FIG. 6B. In this present invention FIG. 6B diagram illustration. Bank Account Information N 358 comprising: payer's bank information 359 and “Bank Account Balance Number N” key 360 and “Back” key 361, “Delete” key 362, “Next” key 363 and “Enter” key 364. Payer's bank information 359 includes Payer's bank name, Payer's bank telephone, Payer's bank website and personal account number N. An AMPA device of user touches “Bank Account Balance: Number N” key 360 to display Bank Account Balance information 365 in FIG. 6C. An AMPA device of user touches “Back” key 361 in FIG. 6B to back “Personal Bank Account File” 355 in FIG. 6A. An AMPA device of user touches “Delete” key 362 to delete payer's bank account information 359 in FIG. 6B from memory of an AMPA device of user. An AMPA device of user touches “Next” key 363 to search next bank account information. An AMPA device of user touches “Enter” key 364 to embed payer's bank account information in Electrical Text such as Electrical Payment Check or Electrical WithDrawal.

FIG. 6C: Continuing reference present invention toughing “Bank Account Information” in FIG. 6B to display Bank Account Balance information 365 in FIG. 6C. In this present invention FIG. 6C diagram illustration. Account Balance information 365 in FIG. 6C comprising: Bank Account Balance Information 366, bank account number such as number N 367, date 368, PreviousBalance 369, (−) Payment&Withdrawal 370, and (=) NewBalance 371. Bank Account Balance Information 366 remains that an AMPA device of user this diagram is about account balance under the account number N 367. Date 368 is that an AMPA device of user payment date or withdrawal date.

PreviousBalance 369 is that amount money of balance in personal account number N 367 before an AMPA device of user payment or withdrawal money from personal account number N 367.

Payment&withdrawal 370 is that amount money that an AMPA device of user payment or withdrawal money from account number N 367. New balance 371 is that amount money of balance in personal account number N 367 after an AMPA device of user payment or withdrawal money 370 from personal account number N 367. An acquisition device in an AMPA device acquire New balance 371=previous balance 369—payment&withdrawal 370 and store New balance data.

An AMPA device of user touches “Back” key 372 in FIG. 6C to back “Personal Bank Account File” 355 in FIG. 6A. An AMPA device of user touches “Delete” key 373 to delete one of Bank Account Balance Information 365 from memory of an AMPA device of user. An AMPA device of user touches “Next” key 374 to search next bank account number balance information.

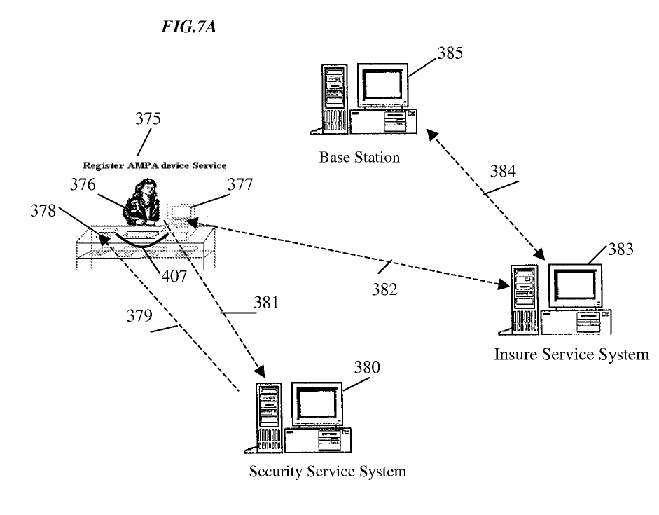

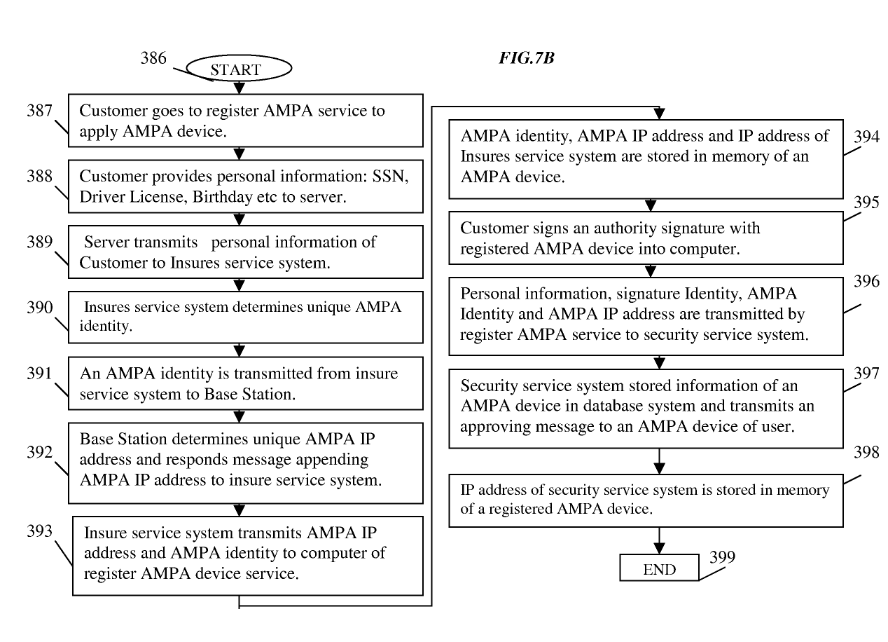

FIG. 7A: Pervious present invention mention that an authorized user must use a registered AMPA device to purchase goods/service in Defense ID-theft attack security service system, in this present invention diagram in FIG. 7A illustration that a user obtains a registered AMPA device and to be authorized user at register AMPA device service. A register AMPA device service 375 provides AMPA device 378 to customer (no illustration) who wants to use an AMPA device 378 for purchasing goods/service and a computer 377 communicate with insures service system 383 over wired network 382. A server 376 who is employee of insures company is utilizing computer 377 to help a customer (no illustration) register AMPA device 378 at register AMPA device service 375. Customer provides personal information including Social Security Number (SSN), Driver License, and Birthday etc (no illustration) to server 376. Server 376 utilizes computer 377 at register AMPA device service 375 to transmit personal information of customer to insures service system 383 over wired network 382. Insures service system 383 receives personal information of customer from computer 377 of register AMPA device service 375 to determine unique AMPA identity from its AMPA identity domain in system database (no illustration). Insures service system 383 transmits unique AMPA identity to base station 385 over wired network 384. Base station 385 determines an IP address of an AMPA device from its IP address domain (no illustration) correspond to AMPA identity and responds message appending AMPA IP address with AMPA identity to insures service system 383 over wired network 384. AMPA IP address is stored in correspond to database of system of base station 385. Insures service system 383 receives IP address of an AMPA device from base station 385, a message appending unique AMPA identity and AMPA IP address is transmitted to computer 377 of register AMPA device service 375 over wired network 382. Personal information of customer, AMPA identity and AMPA IP address are stored in correspond to system database of insures service system 383 separately. Then, the customer signs an authority signature with stylus on touch screen (no illustration) of a registered AMPA device 378 and utilizes a cable 407 to connect host interface (no illustration) of registered AMPA device 378 and host interface (no illustration) of computer 377 of register AMPA device service 375 to transmit digital represent image data of an authority signature identity (no illustration) into computer 377. A server 376 at register AMPA service 375 operates computer 377 to transmit an authority signature identity with personal information appending AMPA identity, AMPA IP address and IP address of insures service system 383 to security service system 380 over wired network 381. Personal information, signature identity, AMPA identity, AMPA IP address and IP address of insures service system 383 are stored in correspond to system database of security service system 380 separately. Security service system 380 transmits an approve message to an AMPA device 378 of user for confirming user having authority to use a registered AMPA device 378 over wireless network 379. AMPA identity, AMPA IP address and IP address of security service system 380 and IP address of insures service system 383 are stored in correspond electrical file in memory of a registered AMPA device.

FIG. 7B: Present invention there is provided register AMPA device service to provide special service that a customer, who wants to use AMPA device for purchasing transaction and maintains personal account information in memory of AMPA device, obtains authority to use a registered AMPA device. Register AMPA device of service is provided by insures service system.

In this present invention illustration a register AMPA device service process for a customer to obtain unique AMPA device with AMPA identity, AMPA IP address, IP address of insures service system and IP address of security service system and signature identity of customer to be stored in system database of security service system 386. Initially, a customer goes to register AMPA device service to apply a registered AMPA device 387. Customer provides personal information such as Social Security Number (SSN), Derive licenses, and Birthday etc to server who is an employee of insures company works at register AMPA device service 388. Server identifies personal information of customer is valid and transmits application message with personal information of customer to insures service system 389. After insures service system receives application message from a computer of a register AMPA device service, then, Insures service system determines unique AMPA identity from its AMPA identity domain database of insures service system 390. And an application IP address message with AMPA identity is transmitted from insures service system to base station which manages IP address in wireless and wired network 391. The Base Station receives application IP address message from insures service system and scans its IP address domain database to determine unique IP address corresponding to unique AMPA identity. A system of base station stores AMPA IP address in database. Then, Base Station responds feedback application message appending AMPA IP address and AMPA identity to insures service system 392. Insures service system receives AMPA IP address appending AMPA identity from base station. An AMPA identity database of insures service system stores AMPA identity with corresponding to AMPA IP address. Then, a responding application message with AMPA Identity and AMPA IP address are transmitted to register AMPA device service over wired network 393. A computer of register AMPA device service receives responding application message from the insures service system and transmits digital data about AMPA IP address, AMPA Identity and IP address of insures service system into registered AMPA device of user via cable between host interfaces of an registered AMPA device and host interface of computer of register AMPA device service. The digital data are stored in nonvolatile memory of a registered AMPA device. AMPA identity, AMPA IP address and IP address of insures service systems are nonvolatile and also the user could not change them 394. Then, customer uses a registered AMPA device to sign an authority signature with a stylus on touch screen and directly transmits signature of customer to computer of register AMPA device service via cable between host interface of an AMPA device and host interface of computer of register AMPA device service 395. An authority signature message with personal information appending AMPA IP address, AMPA Identity and IP address of insures service system is transmitted by register AMPA device service to security service system 396. After security service system receives authority signature message from register AMPA device service, AMPA Identity AMPA IP address and IP address of insures service system are stored in AMPA identity database; personal information is stored in Personal Information database; authority signature Identity is stored in Signature Identity database of security service system. The security service system replies an approving message with confirming that user has authority the use a registered AMPA device to an AMPA device of user over wireless network 397. Registered AMPA device of user receives approving message from security service system and IP address of security service system is stored in memory of an AMPA device. IP address of security service system is stored in nonvolatile memory and an AMPA device of user could not change them 398 ends 399.

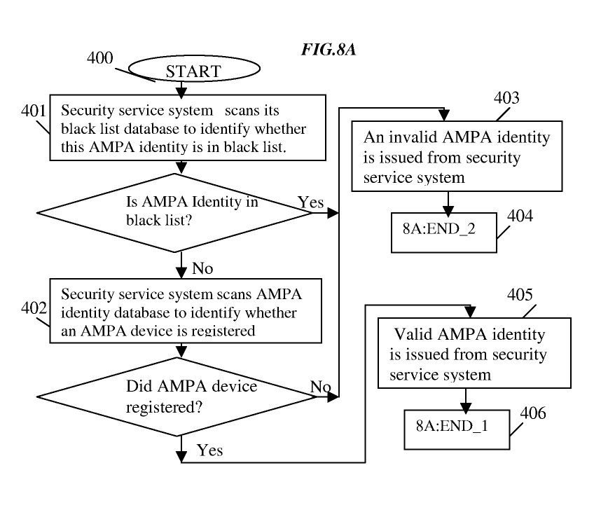

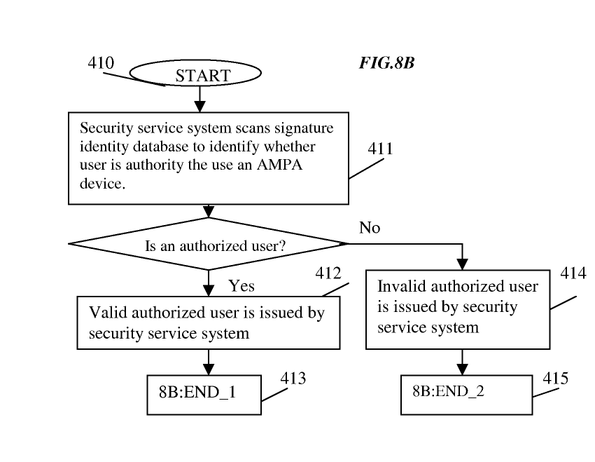

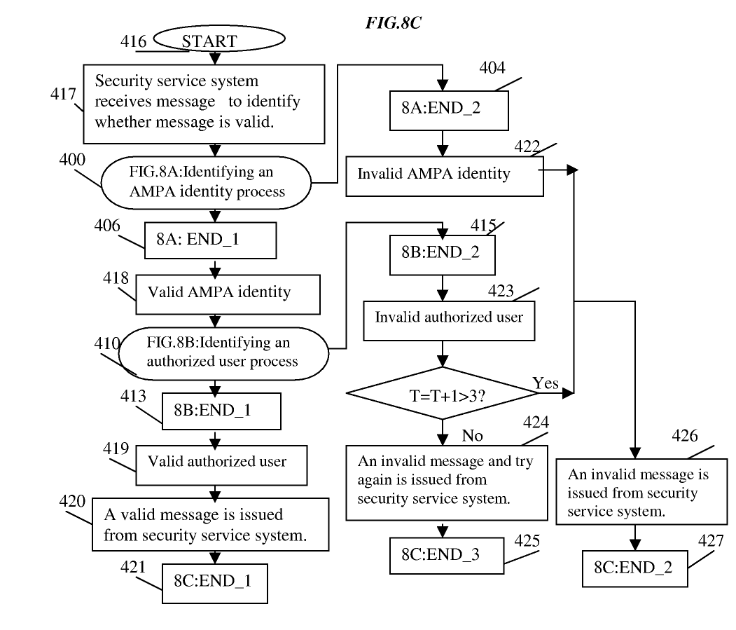

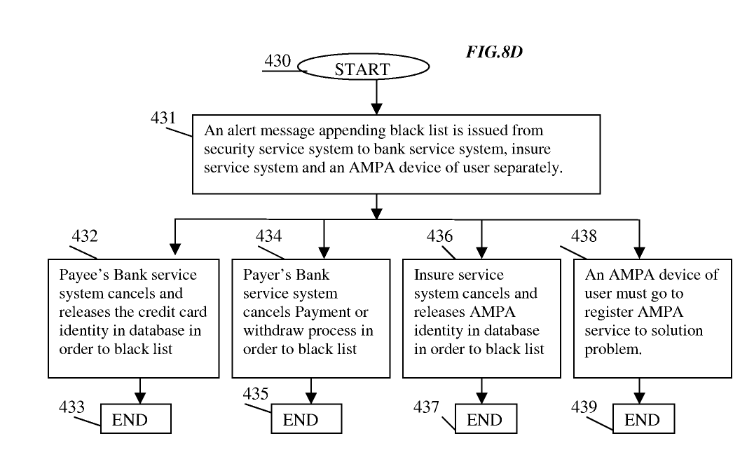

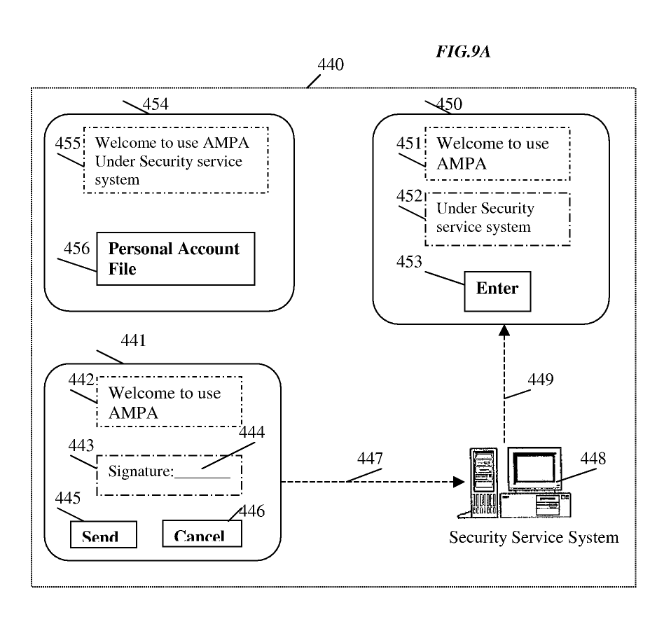

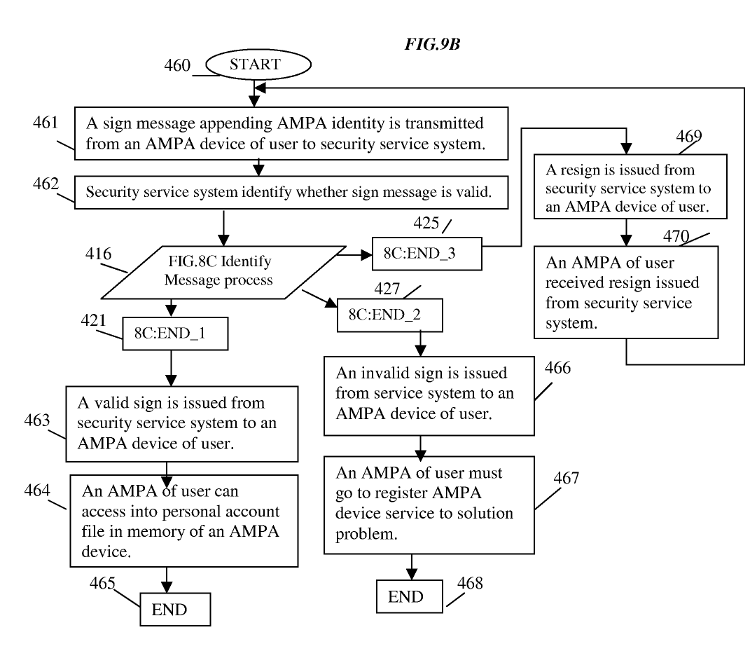

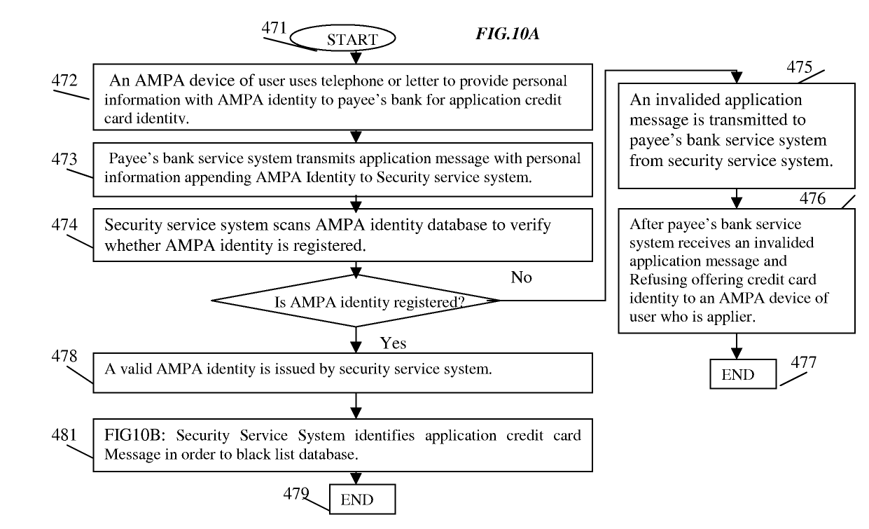

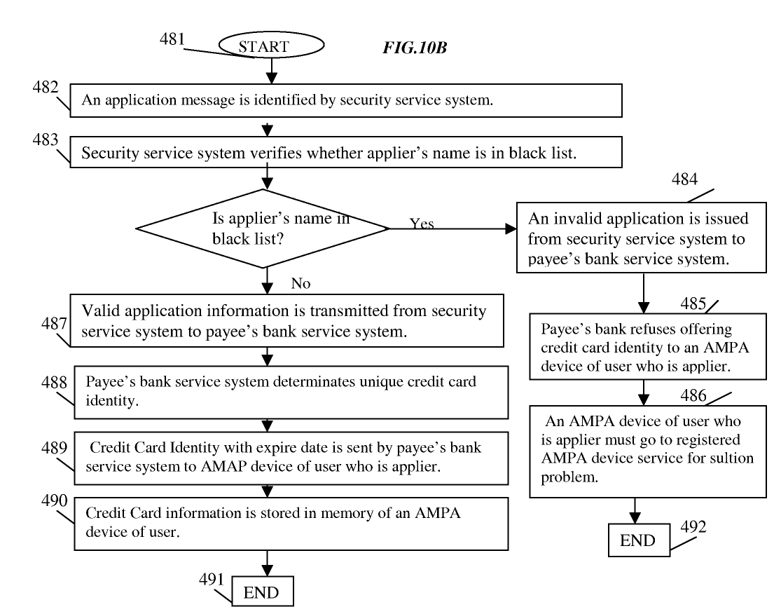

FIG. 8A: present invention there is provided a black list database in security service system to ensure an AMPA device identity in black list could not be used in defense ID-theft attack security service system; and also present invention there is provided an AMPA identity database in security service system to identify whether an AMPA device has registered. Only a registered AMPA device can be utilized to purchase goods/service for user.

It is defense potential ID-theft attack risks that ID-theft utilizes an alert AMPA identity such as a registered AMPA Identity in black list is suspended by security service system to purchase transaction with merchant. It is defense potential ID-theft attack risks that ID-theft utilizes unqualified AMPA device such as no registered AMPA device to purchase goods/service 400.

In this present invention, Security service system process sub-procedure identifies whether AMPA identity is valid in FIG. 8A. Security service system receives packets appending AMPA identity information from service system or an AMPA device of user. A determination device as a part of security service system scans black list database to check whether this AMPA identity is in black list database 401. If A determination device as a part of security service system discoveries AMPA identity in black list database, then, invalid AMPA identity is issued by security service system 403 and going to step 404 in 8A:END_2. If A determination device as a part of security service system undiscovered AMPA identity in black list database, then continuing second step: A determination device as a part of security service system scans AMPA identity database to discovery whether AMPA identity is in AMPA identity database of system 402. If a determination device as a part of security service system discoveries AMPA identity in AMPA identity database, a valid AMPA device is issued by security service system 405 and going to step 406 in 8A: END_1. If a determination device as a part security service system undiscovered AMPA identity in AMPA identity database, an invalid AMPA identity is issued by security service system and going to step 403 and going to step 404 in 8A:END_2.

FIG. 8B: Present invention there is provided an AMPA user's signature identity database in security service system to identify whether an AMPA device of user has authority to use a registered AMPA device for purchasing transaction with merchant. Only an authorized user utilizes registered AMPA device to purchase goods/service.

It is defense potential ID-theft attack risks that ID-theft utilizes forge signature identity with stolen a registered AMPA device to purchase transaction with merchant under victim blinding.

In this present invention, Security service system process sub-procedure identifies whether the user is an authorized user 410 in FIG. 8B. Security service system receives packets appending signature identity information of an AMPA device of user from service systems or an AMPA device of user. A determination device as part of security service system determines that received signature identity of an AMPA device of user is matched with recorded signature identity of an AMPA device of user in signature identity database of system, an valid authorized user is issued from the security service system 412 and going to step 413 in 8B:END_1. A determination device as a part of security service system determines that received signature identity of an AMPA device of user is not matched with recorded signature identity of an AMPA device of user in signature identity database of system, invalid authorized user is issued from the security service system 414 and going to step 415 in 8B:END_2.

FIG. 8C: continuing reference present invention FIG. 8A and FIG. 8B sub-procedures process to obtain sub-procedure in FIG. 8C. There is provided a security service system to provide a special service in responds to massage issued from third service systems or an AMPA device to identify whether massage is valid. Only valid message is allowed to obtain service in Defense ID-theft attack security service system.

It is defense potential ID-theft attack risks that ID-theft transmits forge message to third service systems under victim blinding during purchasing transaction session.

In this present invention, Security service system process sub-procedure identifies whether message is valid 416 in FIG. 8C. A determination device as a part of security service system receives message from third service systems or an AMPA device of user to identify whether this message is valid 417. First: a determination device as part of security service system process procedure step 400 in present invention FIG. 8A to determine whether valid AMPA identity is used in message. If the processing procedure 400 of FIG. 8A goes to step 404 in FIG. 8A: END_2, a determination device as a part of security service system determines an invalid AMPA identity in message 422 and an invalid message is issued from security service system 426 and goes to step 427 in 8C: END_2. If the processing procedure 400 of FIG. 8A goes to step 406 in 8A: END_1, a determination device as a part of security service system determines a valid AMPA identity in message 418. And a determination device as a part of security service system continues to go to step 410 in FIG. 8B identify whether a user is an authorized user in message. If the processing procedure 410 of FIG. 8B goes to step 413 in 8B: END_1, a determination device as a part of security service system determines a valid authorized user in message 419. Then, a valid message is issued from security service system 420 and going to step 421 in 8C: END_1. If the processing procedure 410 of FIG. 8B goes to step 415 in 8B: END_2, a determination device as a part of security service system determines an invalid authorized user in message 423. Then, a determination device as a part of security service system checks how many time (T) an AMPA device of user sign signatures.

Initial T=0, if T=T+1<3, an invalid message and try again is issued from security service system 424 and going to step 425 in 8C: END_3. Otherwise, if T=T+1>3, then an invalid message is issued from security service system 426 and going to step 427 in 8C: END_2.

FIG. 8D: in this present invention there is provided a security service system to deal with an AMPA device of user's name in black list database. Due to some reason an AMPA device of user transmits message with error such as an AMPA device problem or ID-theft attack, or an AMPA device of user dishonest behavior. A determination device as a part of security service system will detect error message and put user's name with his/her AMPA identity into black list database, and transmits black list data to third service system and suspends service for this person whom name in black list in Defense ID-theft attack security service system 430.

It is that prevents and defends against potential ID-theft attack risk that ID-theft hides in marketing environment to continue attacks under victim blinding. It is that restrict dishonest behavior risk that person denies purchasing goods/service under merchant blinding.

Security service system broadcasts black list message including an AMPA device of user's name, AMPA identity and credit card identity in Defense ID-theft attack security service system 431. Payee's bank service system receives black list from security service system to release credit card identity in order to black list so that an AMPA of user in black list could not use the credit card identity to purchase goods/service in Defense ID-theft attack security service system 432 and ends 433. Payer's bank service system receives black list from security service system to cancels payment or withdrawal processing and close account in order to black list so that an AMPA of user in black list could not use the account identity to payment or withdrawal in Defense ID-theft attack security service system 434 and ends 435. Insures service system receives black list from security service system to release AMPA identity in order to black list so that an AMPA of user in black list could not have authority to use a suspending AMPA identity 436 and ends 437. An AMPA device of user receives black list with her/his name and she/he could not access into personal account file in memory of an AMPA device and must go to register AMPA service for explaining reason or re-register AMPA device and reopen credit card identity, reopen personal account 438 and ends 439.

FIG. 9A: In present invention, an AMPA device of user has to pass identifying from security service system, then she/he can access into memory to search or use personal account file and in this present invention processing 440 diagrams in FIG. 9A illustration.

Initially, an AMPA device of user turns on power of an AMPA device and on the touch screen 441 display comprising: Electrical Text such as welcome to use AMPA 442 and signature 443; and “Send” key 445 and “Cancel” key 446. Second, An AMPA device of user sign signature identity with stylus in place 444 and touches “Send” key 445 to transmit sign message with signature identity appending to AMPA identity to security service system 448 over wireless network 447, if an AMPA device of user satisfy sign signature. If an AMPA device of user did not satisfy sign signature, then she/he touches “Cancel” key 446 to delete signed signature in place 444.

A determination device as a part of security service system 448 identifies whether sign message from an AMPA device of user is valid. If identifying this signature is valid, security service system 448 responds approving message to AMPA device of user over wireless network 449. Third, An AMPA device of user receives approving message from security service system and touches screen 450 of an AMPA device of user display Electrical Text such as “welcome to use AMPA 451” and “Under Security Service System” text 452 and “Enter” key 453. Fourth, An AMPA device of user touches “Enter” key 453 on touch screen 450 to display Electrical Text such as “welcome to use AMPA and Under Security service system” 455 and “Personal Account File” key 456 diagram on touch screen 454. Now an AMPA device of user can access into personal account file in AMPA device with stylus touching “personal account file” key 456 on touch screen 454 of an AMPA device of user. If an AMPA device of user receives try-again message (no illustration) from security service system, then she/he must resign signature for identifying from security service system. If an AMPA device of user receives deny message (no illustration) from security service system, then, she/he must go to register AMPA device service to solution problem.

FIG. 9B: Pervious present inventions mention that there is provided a security service system to provide special service that identify whether message is valid in FIG. 8C. In this present invention, security service system utilizes sub-procedure FIG. 8C “Identify Message Process” to identify whether a sign message from an AMPA device of user is valid. Only valid sign is allowed that an AMPA device of user can access into Personal Account File 120 in FIG. 4A in memory of an AMPA device of user 460.

It is defense potential ID-theft attack risks that ID-theft stolen or pick up an AMPA device to purchases goods/service under victim blinding. It is defense potential ID-theft attack risks that ID-theft stolen personal account information from an AMPA device under victim blinding. It is defense potential ID-theft attack risks that ID-theft transmits forge message to service system with an AMPA device under victim blinding.

An AMPA device of user signs a signature with stylus on touch screen and transmits sign message including AMPA identity and signature identity to security service system 461. A determination device as a part of security service system receives sign message from an AMPA device of user and identifies whether this sign message is valid 462. A determination device as a part of security service system uses sign message instead of message in FIG. 8C to process step 416 processing sub-procedure “Identify Message process” to identify whether sign Message is valid. If a determination device as a part of security service system processes sub-procedure of FIG. 8C going to step 421 in 8C:END_1, then, a valid sign is issued from a determination device as a part of security service system to an AMPA device of user 463. Now, an AMPA device of user can access into Personal Account File 120 in FIG. 4A to search history of account information or use AMPA device for purchasing transaction with merchant 464 and end 465. If a determination device as a part of security service system processes sub-procedure of FIG. 8C going to step 427 in 8C:END_2, then, an invalid sign is issued from a determination device as a part of security service system to an AMPA device of user 466. An AMPA device of user must go to register AMPA device service to solution problem about AMPA device 467 and ends 468. If a determination device as a part of security service system processes procedure of FIG. 8C going to step 425 in 8C:END_3, then, a resign signature is issued from security service system to an AMPA device of user 469. An AMPA device of user receives resign issued from security service system and going back to step 460 to reprocess procedure FIG. 9B again.

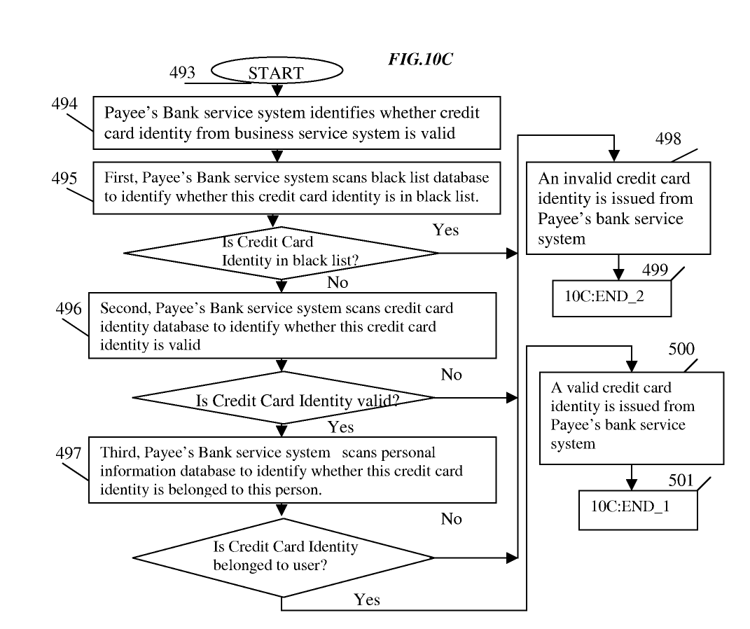

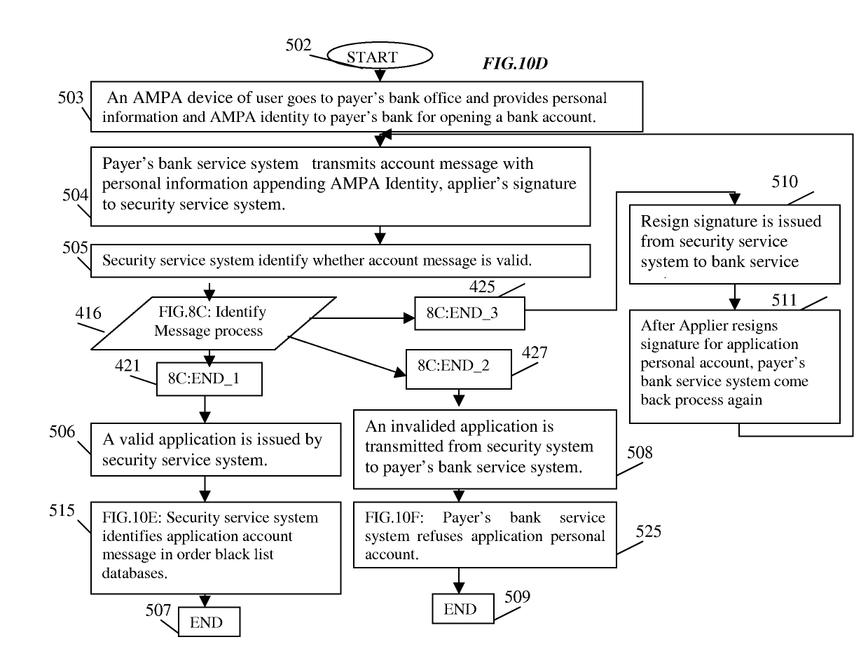

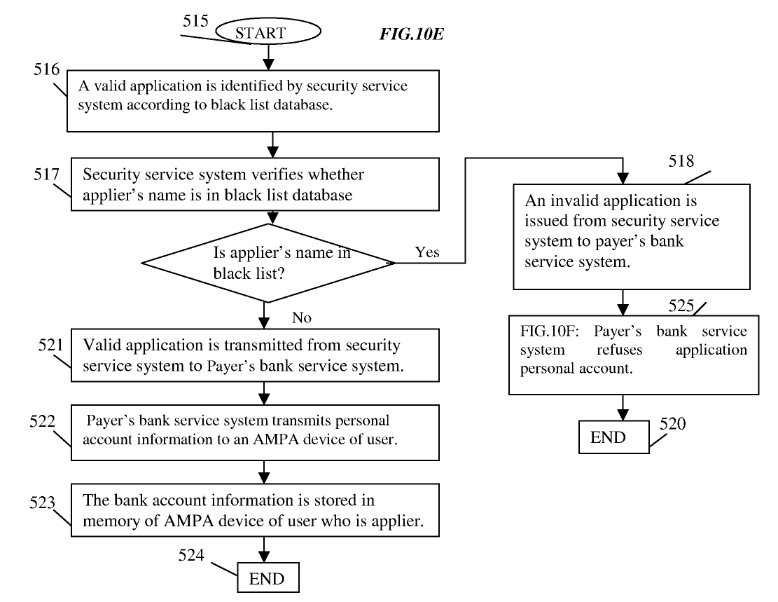

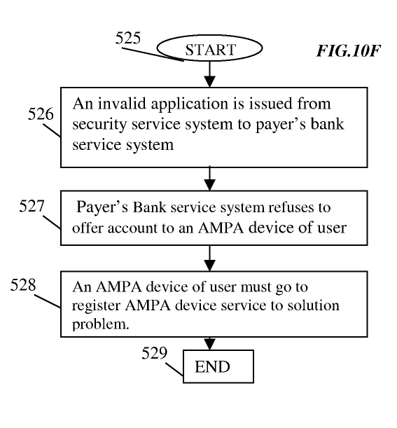

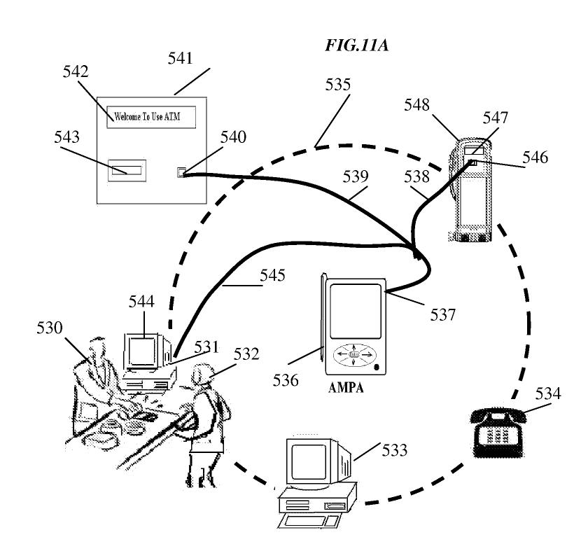

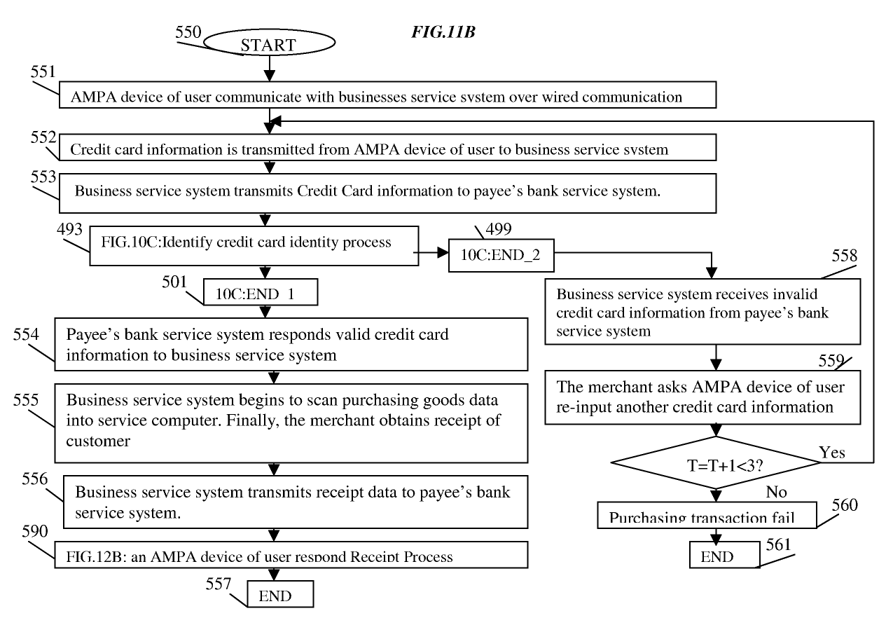

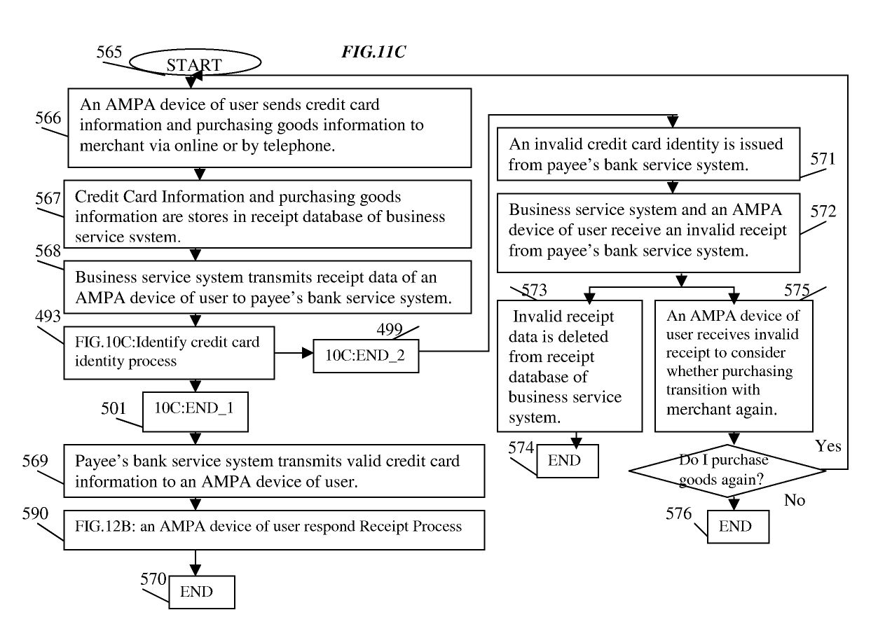

FIG. 10A: in FIG. 7A and FIG. 7B, present invention illustration that customer obtains registered AMPA device from register AMPA device service and becomes an AMPA device of user. In this prevent invention there is provided payee's bank service system to provide a special service in providing credit card identity to an AMPA device of user for purchase goods/service with an AMPA device and security service system assure that a applier who uses registered AMPA device and also her/his name's is not in black list database 471.

It is defense potential ID-theft attack risks that ID-theft stolen or pick up an AMPA device to apply credit card identity under victim blinding. It is defense potential ID-theft attack risks that ID-theft stolen personal information to apply credit card identity under victim blinding.

After User becomes authority the use registered AMPA device and utilizes telephone or letter to provide personal information, AMPA identity and AMPA IP address to payee's bank service system for application credit card identity 472. Payee's Banker utilizes payee's bank service system transmits application message with personal information appending AMPA identity to security service system over wired network 473. A determination device as a part of security service system scans AMPA identity database of system correspond to personal information database of system to identify whether AMPA identity is registered 474. If a determination device as a part of Security service system identifies that the AMPA device is registered, then a determination device as a part of Security service system 478 issues a valid AMPA identity. And a determination device as a part of security service system continues processes procedure FIG. 10B goes to step 481 to identify whether applier name is in black list database of security service system and ends 479. If a determination device as a part of Security service system identifies that the AMPA device is not registered then, an invalided application message is transmitted from security service system to payee's bank service system over wired network 475. After payee's bank service system receives an invalided application message from the security service system, a refusing application message is transmitted by payee's bank service system to an AMPA device of user who is applier over wireless network 476 and 477.

FIG. 10B: continue reference present invention in FIG. 10A, a determination device as a part of security service system scans black list database to check whether applier's name is valid, only valid name approve for application credit card identity 481.

A determination device as part of security service system identifies application message in order to black list database 482. A determination device as part of security service system verifies whether applier's name is in black list database 483. If a determination device as part of security service system verifies that applier's name is not in black list, then, security service system stores IP address of payee's bank service system in personal information database and transmits valid application message to payee's bank service system over wired network 487. After payee's bank service system receives valid application information from security service system, payee's bank service system determines unique credit card identity from its credit card identity database of system 488. Unique credit card identity appending expire date is transmitted from payee's bank service system to an AMPA device of user who is applier over wireless network 489. Credit card identity information includes payee's bank information such as credit card identity expire date, payee's bank telephone, and payee's bank name, payee's bank website etc are stored in Credit Card Identity File 127 in FIG. 4A in memory of AMPA device 490 and ends 491. If a determination device as part of security service system verifies that applier's name is in black list database, then, an invalided application message is transmitted from security service system to payee's bank service system over wired network 484. After payee's bank service system receives an invalided application message from the security service system, a refusing application message is transmitted by payee's bank service system to an AMPA device of user who is applier over wireless network 485. After an AMPA device received refuse message from payee's bank service system, she/he must go to register AMPA device service for solution problem 486 and 492.

FIG. 10C: Present invention there is provided a credit card identity database including black list database in payee's bank service system to identify whether credit card identity is valid. A user who has authority the use registered AMPA device uses only valid credit card identity to purchase goods/service 493.

It is defense potential ID-theft attack risks that ID-theft utilizes alert credit card identity such as credit card identity in black list is temporally suspended by security service system to purchase goods/service under merchant blinding. It is defense potential ID-theft attack risks that ID-theft utilizes unqualified credit card identity such as no application or expire credit card identity to purchase goods/service under merchant blinding. It is defense potential ID-theft attack risks that ID-theft stolen credit card identity to purchase transaction with merchant under victim blinding.

Initial, an AMPA device of user provides credit card identity information to business service system. And Business service system receives credit card identity information from an AMPA device of user and retransmits credit card identity information of an AMPA device of user to payee's bank service system to identify whether credit card identity is valid 494. A determination device as a part of payee's bank service system scans black list database to check whether this credit card identity is in black list database 495. If a determination device as a part of payee's bank service system discovers credit card identity in black list, then, invalid credit card identity is issued from payee's bank service system 498 and goes to step 499 in 10C:END_2. If a determination device as a part of payee's bank service system undiscovered credit card identity in black list, then continuing to second step to scans its credit card identity database to check whether this credit card identity is in credit card identity database 496. If a determination device as a part of payee's bank service system verifies that credit card identity is not in credit card identity database, then, invalid credit card identity is issued from payee's bank service system 498 and goes to step 499 in 10C:END_2. If a determination device as a part of payee's bank service system verifies that credit card identity is in credit card identity database, then continuing third step to scan its personal information database according to corresponding credit card identity to identify whether the personal information is matched 497.

If a determination device as a part of payee's bank service system identifies that received personal information from business service system is not matched with recorded personal information in system database corresponding to credit card identity information database, then invalid credit card identity is issued from payee's bank service system 498 and goes to step 499 in 10C:END_2. If a determination device as a part of payee's bank service system identifies that received personal information from business service system is matched with recorded personal information in system database corresponding to credit card identity information database, then a valid credit card identity is issued from payee's bank service system 500 and goes step 501 in 10C:END_1.

FIG. 10D: in FIG. 7A and FIG. 7B, present invention illustration that a user obtains registered AMPA device from register AMPA device service and becomes an AMPA device of user. In this prevent invention there is provided a payer's bank service system to provide a special service in providing personal bank account to an AMPA device of user for payment or withdrawal from Changing ATM machine and security service system assure that a applier is an authority user having the use registered AMPA device and applier's name is not in black list 502.

It is defense potential ID-theft attack risks that ID-theft stolen or pick up an AMPA device to apply bank account under victim blinding. It is defense potential ID-theft attack risks that ID-theft stolen personal information to apply bank account under victim blinding.

After customer has authority the use a registered an AMPA device, she/he goes to office of Bank Company that utilizes payer's bank service system. And applier utilizes her/his AMPA device to connect with compute of payer's bank service system via cable between host interface of AMPA device and host interface of computer of payer's bank service system. And applier transmits personal information appending AMPA identity, signature and IP address of security service system to computer of payer's bank service system for opening a personal bank account 503. Payer's bank service system transmits account message with personal information appending AMPA identity, applier's signature to security service system over wired network 504. A determination device as part of security service system receives account message from Payer's bank service system and verifies whether account message is valid 505. A determination device as part of security service system uses account message instead of message in FIG. 8C process to step 416 processing sub-procedure “Identify Message process” to identify whether account Message is valid. If A determination device as part of security service system processes sub-procedure of FIG. 8C going to step 421 in 8C: END_1, then, a valid application is issued from a determination device as part of security service system. A determination device as part of security service system continues to go to step 515 process procedure FIG. 10E to verify whether applier's name is in black list and ends 507.

If A determination device as part of security service system processes sub-procedure of FIG. 8C going to step 427 in 8C:END_2, then, an invalid application is issued from a determination device as part of security service system to payer's bank service system over wired network 508. Payer's bank service system receives invalid application from a determination device as part of security service system and goes to step 525 process procedures FIG. 10F to refuse application account for an AMPA device of user and end 509. If a determination device as part of security service system processes sub-procedure of FIG. 8C going step 425 in 8C:END_3, then, a resign signature is issued from a determination device as part of security service system to payer's bank service system over wired network 510. After Applier resigns signature identity on application account information 511, then payers' bank service system process procedure in FIG. 10D at step 504 again.

FIG. 10E: continuing reference present invention in FIG. 10D, a determination device as part of security service system verifies a valid application for an authorized user who uses a registered AMPA device. However, a determination device as part of security service system needs to verify whether this applier is in black list. Only applier who is not in black list can obtain account service in Defense ID-theft attack security service system 515.

A determination device as part of security service system identifies whether application is valid according to black list database 516. A determination device as part of security service system continues to verify whether applier's name is in black list database 517. If a determination device as part of security service system undiscovered applier's name in black list, then, security service system stores IP address of payer's bank service system in personal information database and valid application message is transmitted from security service system to payer's bank service system over wired network 521. Payer's bank service system stores personal account information including personal information, an AMPA device Identity and an AMPA device of IP address and IP address of security service system in personal account database and transmits personal account information to an AMPA device of user who is applier 522. Payer's bank account information includes Payer's bank account number, payer's bank name, payer's bank telephone number, payer's bank IP address and payer's bank website, etc through host interface of computer via cable into host interface of an AMPA device of user who is applier and Payer's bank account information is stored in Personal Bank Account File 139 in FIG. 4A in memory of an AMPA device 523 and end 524. If a determination device as part of security service system discoveries applier' name in black list database, then, an invalid application is issued from a determination device as part of security service system to payer's bank service system over wired network 518. Payer's bank service system receives invalid application from security service system and goes to step 525 process procedures FIG. 10F to refuse application account for an AMPA device of user and end 520.

FIG. 10F: continuing reference present invention in FIG. 10D and FIG. 10E. In this present invention process procedure FIG. 10F: payer's bank refuses application account for an AMPA device of user who is applier 525. An invalid application is issued from a determination device as part of security service system to payer's bank service system over wired network 526. Payer's bank service system receives invalid application information from security service system and refuses offering bank account to an AMPA device of user 527. An AMPA device of user must go to register AMPA device service to solution problem 528 and end 529.

FIG. 11A: Present invention there is provided an AMPA device to person who can use an AMPA device to purchasing transaction with merchant unlimited location 535.

An AMPA device of user communicates with businesses service system with either wired communication or wireless communication. Wired communication is mean that an embodiment of host interface of an AMPA device connects with host interface of computer or machine in businesses service system with a cable. And an AMPA device of user provides credit card information to businesses service system over wired communication. Or provides personal account information to payer's bank service system for withdrawal money from ATM machine over wired communication.

It is defense potential ID-theft attack risks that ID-theft utilizes publican machine such as credit card machine, tradition Gas Machine and tradition ATM machine with stolen credit card identity or personal bank account etc to purchase goods/service under victim blinding. In other words, even if ID-theft stolen credit card identity, personal information, passwords or personal bank account etc., however, ID-theft cannot purchase goods/service without an AMPA device.

Wireless communication is meaning that an AMPA device provides credit card information to business service system online or by telephone. Purchasing goods/service is made by an AMPA device 536 of user 532 using business service system such as Changing Gas Machine 548, computer at shop 544, online with computer 533, by telephone 534 and Changing ATM machine 541 etc., and merchant uses businesses service system offer goods/service. An AMPA device 536 of user 532 provides credit card information to the business service system for purchasing goods/service over wired communication illustration as following: At shop, businesses service system provides computer 544 to merchant 530 for offering goods/service to customer who is an AMPA device 536 of user 532. An AMPA device 536 of user 532 transmits credit card identity information from host interface 537 via cable 545 to host interface 531 of computer 544 of business service system 535.

At Gas Station, businesses service system 535 provides Changing Gas Machine 548. The Changing Gas Machine 548 compares with tradition Gas Machine comprising: adding host interface 546 and display 547 and also eliminating credit card input and output of receipt (no illustration) in tradition Gas Machine. An AMPA device 536 of user 532 transmits credit card identity information from host interface 537 via cable 538 to host interface 546 of Changing Gas Machine 548. Display 547 show amount of gas and price. An AMPA device 536 of user 532 provides credit card information to business service system 535 for purchasing gas over wireless communication at Gas Station with Gas Machine 548. At Changing ATM, payer's bank service system provides Changing ATM Machine 541. The Changing ATM machine 541 compares with tradition ATM Machine (no illustration) comprising: adding host interface 540, output 543 and display 542 and also eliminating credit card input and keyboard (no illustration) in tradition ATM Machine. An AMPA device 536 of user 532 transmits Electrical WithDrawal from host interface 537 via cable 539 to host interface 540 of Changing ATM Machine 541 of payer's bank service system 535. An AMPA device 536 of user 532 provides personal bank account information to payer's bank service system for withdrawal money from Changing ATM machine 541 over wired communication at ATM machine service.

And also an AMPA device 536 of user 532 utilizes computer 533 online or by telephone 534 to provide credit card identity information to business service system 535 for purchasing goods/service with merchant over wireless communication.

FIG. 11B: continue reference present invention in FIG. 11A illustration that an AMPA device of user can use an AMPA device for purchasing goods/service anywhere. And an AMPA device of user transmits credit card information to business service system over wired communication. And also there is provided payee's bank service system to verify whether credit card information of an AMPA device of user from businesses service system is valid. Only valid credit card information is allowed to purchase transaction with merchant. In this present invention process procedure in FIG. 11B that an AMPA device of user transmits credit card information to business service system over wired communication 550.

It is defense potential ID-theft attack risks that ID-theft utilizes forge credit card information such as time expire or unqualified credit card identity to purchase transaction with merchant in shop or Gas station etc. It is defense potential ID-theft attack risks that ID-theft utilizes stolen credit card information to purchase transaction with merchant in shop or Gas station etc under victim blinding.

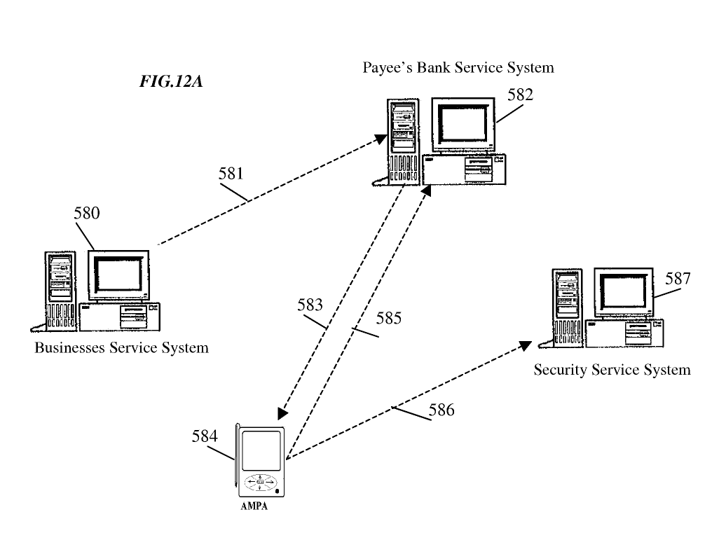

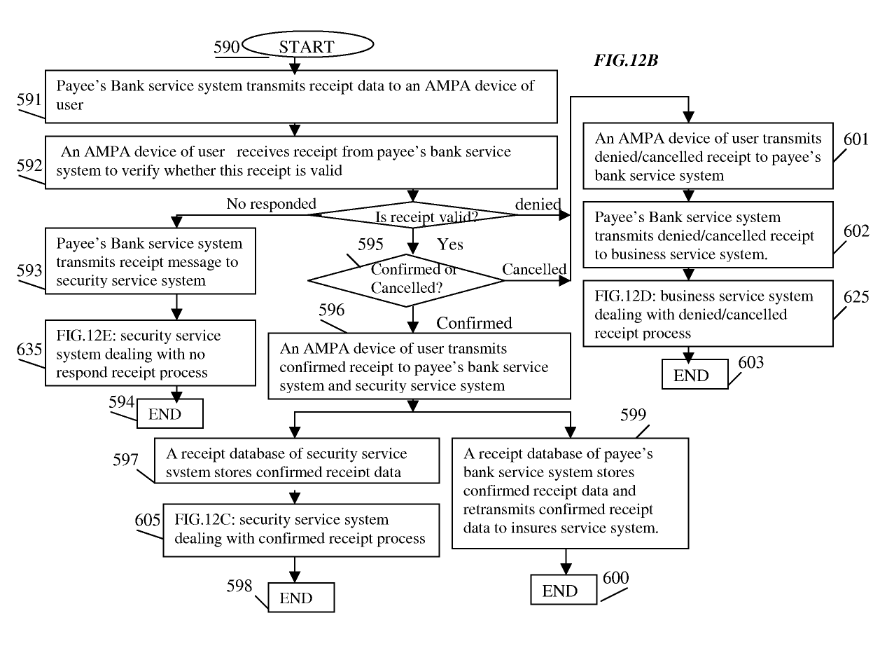

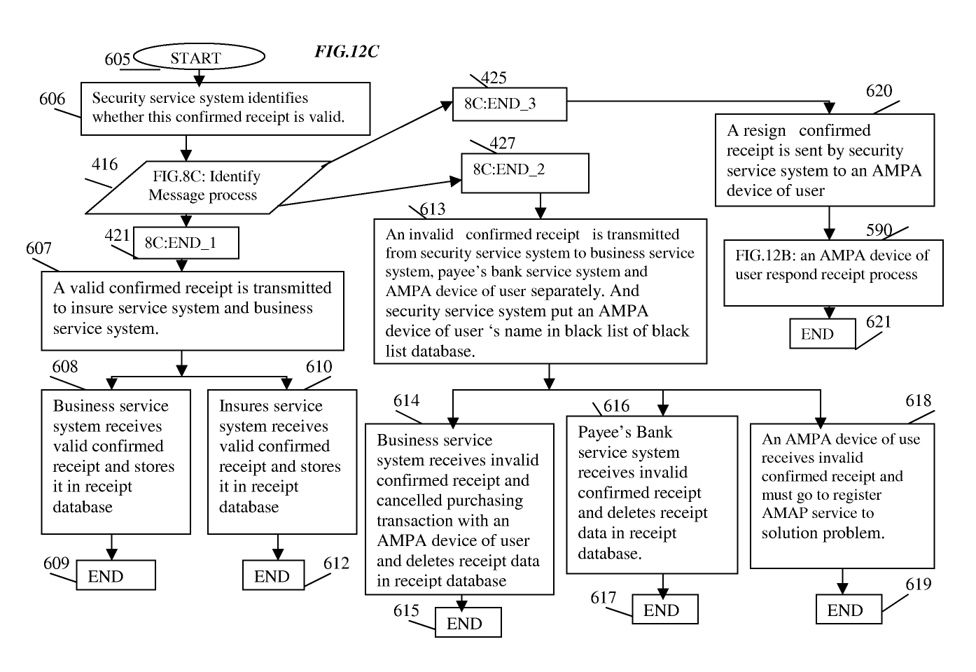

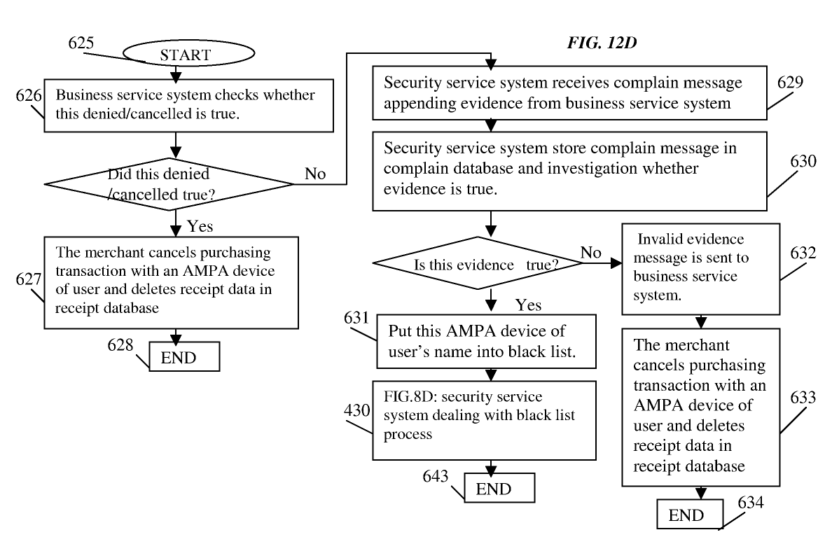

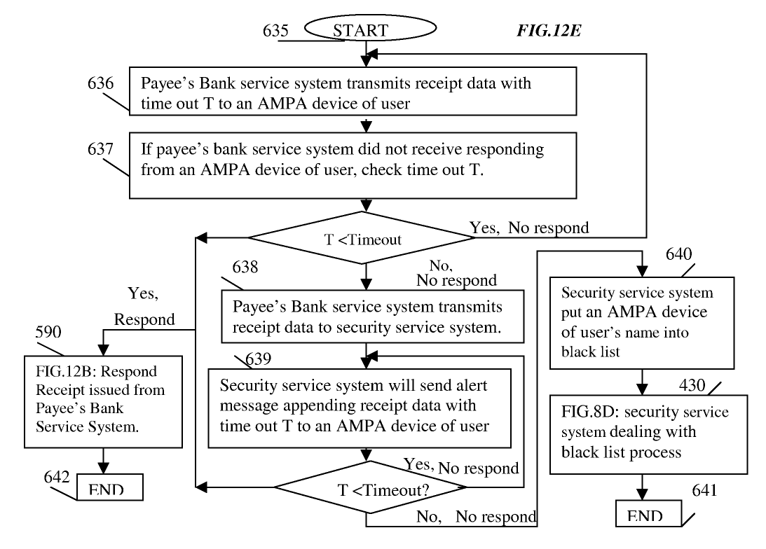

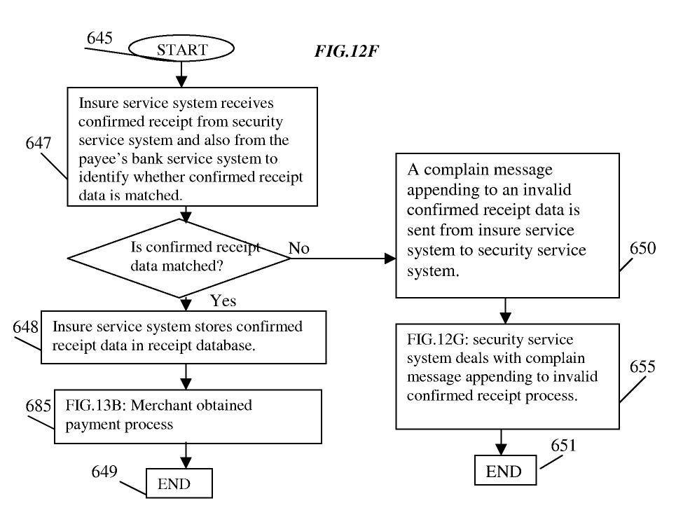

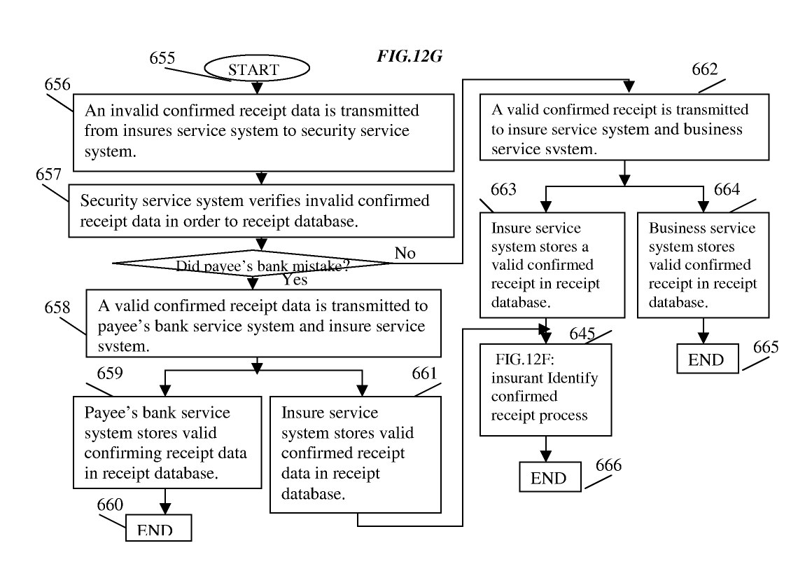

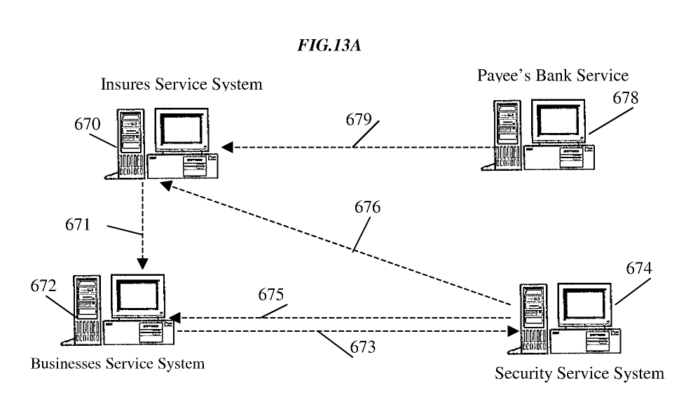

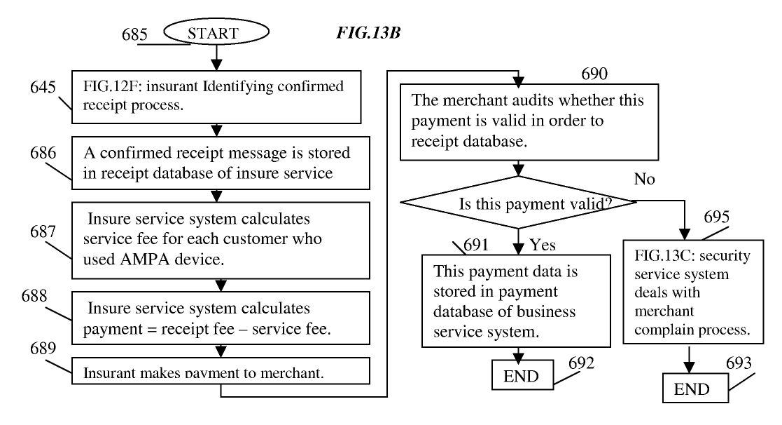

An AMPA device of user uses a host interface of AMPA device to connect a host interface of computer of business service system via cable 551. An AMPA device of user transmits credit card information to computer of business service system over wired communication 552. Business service system retransmits credit card information of an AMPA device of user to payee's bank service system in order to credit card information over wired network 553. A determination device as part of Payee's bank service system receives credit card information of an AMPA device of user from businesses service system and process sub-procedures 493 in FIG. 10C to identify whether Credit Card Information is valid. If a determination device as part of Payee's bank service system processing sub-procedure of FIG. 10C goes to step 501 in 10C: END_1, then, A determination device as part of payee's bank service system issues valid credit card information to business service system 554. After business service system receives valid credit card information from payee's bank service system, Business service system begins to scan purchasing goods data into computer of business service system. Finally, the merchant obtains receipt charges for a customer who purchases goods/service with an AMPA device 555. Business service system stores receipt data in its receipt database and transmits this receipt data to payee's bank service system 556. After a determination device as part of Payee's bank service system receives receipt data from business service system and retransmits receipt information to an AMPA device of user. An AMPA device of user receives receipt information from payee's bank service system to process step 590 in FIG. 12B to respond receipt information and ends 557. If a determination device as part of Payee's bank service system processing sub-procedure of FIG. 10C goes to step 499 in 10C:END_2, then, payee's bank service system responds invalid credit card information to business service system 558. After business service system receives invalid credit card information from payee's bank service system to check how many time (T) the customer fail for identifying credit card identity process 559. Initial T=0, if T=T+1<3. Then the business service system let an AMPA device of user try again and go back processing step 550. Otherwise, if T=T+1>3, the business service system pertinent purchasing transaction with an AMPA device of user is fail 560 and end 561.

FIG. 11C: continue reference present invention in FIG. 11A illustration that an AMPA device of user can use an AMPA device for purchasing goods/service anywhere. And an AMPA device of user transmits credit card information to business service system over wireless communication. In this present invention there is provided payee's bank service system to verify whether credit card information of an AMPA device of user from business service system is valid. Only valid credit card information is allowed to purchase purchasing transaction with merchant 565.

It is defense potential ID-theft attack risks that ID-theft utilizes stolen credit card identity information including personal information to purchase transaction with merchant online/by telephone etc under victim blinding. It is defense potential ID-theft attack risks that ID-theft utilizes forge credit card identity information such as time expire or unqualified credit card identity to purchase transaction with merchant online/by telephone etc.

An AMPA device of user can use telephone in office or at home to provide personal information including credit card identity information for purchasing goods/service from business service system 566. Credit card information and purchasing goods information of an AMPA device of user are stored in receipt database of system of business service system 567. Business service system retransmits Credit Card Information with receipt information of an AMPA device of user to payee's bank service system in order to the credit card identity information 568. After a determination device as part of Payee's bank service system receives Credit Card Information with receipt information of an AMPA device of user from business service system, A determination device as part of Payee's bank service system uses Credit Card Identity information to process procedure in FIG. 10C goes to step 493 process sub-procedures to identify whether Credit Card Information is valid. If a determination device as part of Payee's bank service system processing sub-procedure of FIG. 10C goes to step 501 in 10C:END_1, then, a determination device as part of Payee's bank service system transmits valid credit card information with receipt data to an AMPA device of user who purchased goods online or telephone 569. An AMPA device of user receives receipt information from payee's bank service system to process step 590 in FIG. 12B to respond receipt information and ends 570.

If a determination device as part of Payee's bank service system processing sub-procedure of FIG. 10C goes to step 499 in 10C:END_2, then, a determination device as part of Payee's bank service system issues invalid credit card information. Invalid credit card identity information is transmitted by payee's bank service system in order to receipt information to business service system and an AMPA device of user 572. Business service system receives invalid receipt information from payee's bank service system and deletes receipt data in database of system 573 and end 574.

An AMPA device of user receives invalid receipt information from payee's bank service system to consider whether she/he chooses another credit card information to purchase goods/service again 575. If she/he would like to purchase goods again to go to back step 565 trying again. Otherwise, an AMPA device of user pertinent purchasing transaction is fail end 576.

FIG. 12A: continuing reference present invention in FIG. 11B and FIG. 11C payee's bank service system receives receipt data from business service system and retransmits receipt data to an AMPA device of user who is purchasing goods/service with merchant. And in this present invention diagram in FIG. 12A, an AMPA device of user receives receipt from payee's bank service system and respond receipt issued to payee's bank service system over wireless network; and also transmit responds receipt information to security service system over wireless network. Payee's Bank service system 582 receives receipt data from business service system 580 over wired network 581 and then retransmits receipt data to an AMPA device 584 of user over wireless network 583. An AMPA device 584 of user verifies whether this receipt data is valid according to really purchasing goods/service events and responds receipt message to payee's bank service system 582 over wireless network 585 and also transmits responding receipt message to security service system 587 over wireless network 586.

FIG. 12B: continuing reference present invention in FIG. 11B and FIG. 11C payee's bank service system receives receipt from business service system and retransmits receipt data to an AMPA device of user who is purchasing goods/service with merchant. And in this present invention process procedure in FIG. 12B, there is provided an AMPA device to provide special service that an AMPA device of user identifies whether receipt from payee's bank service system is valid according to really purchasing goods/service events and respond receipt issued to payee's bank service system and also transmits receipt to security service system 590.

An AMPA of user responds receipt message from payee's bank service system having some probabilities in responds according to really purchasing goods/service events: A) An AMPA device of user confirmed receipt from payee's bank service system is valid because it is true that she/he purchased transaction with merchant. B) An AMPA device of user denied receipt from payee's bank service system because the receipt data is not correct such as ID-theft accesses into computer of payee's bank service system to change receipt data under victim blinding. C) An AMPA device of user denied receipt from payee's bank service system because the receipt data is invalid such as ID-theft stolen an AMPA device of user's personal information purchased transaction with merchant under victim blinding. D) An AMPA device of user cancels this receipt because she/he cancelled purchasing transaction with merchant and she/he did not take or had returned purchasing goods/service to merchant. E) An AMPA device of user no respond in receipt issued from payee's bank service system such as an AMPA device could not receive signal or out off batter of an AMPA device etc.

Payee's Bank service system obtains AMPA IP address according to AMPA Identity on the receipt data and payee's bank service system transmits receipt to an AMPA device of user in order to AMPA IP address over wireless network 591. An AMPA device of user receives receipt message from payee's bank service system to verify whether this receipt is valid 592. If an AMPA device of user verifies this receipt is valid and goes to step 595 consider whether this receipt is confirmed or cancelled. If this receipt is confirmed, then an AMPA device of user responds confirmed receipt message to payee's bank service system and transmits confirmed receipt message to security service system 596. A receipt database of payee's bank service system stores confirmed receipt data from an AMPA device of user to instead of receipt data from business service system and retransmit confirmed receipt data from an AMPA device of user to insures service system in order to AMPA identity 599 and end 600. A receipt database of security service system stores confirmed receipt data 597 and goes to step 605 to process procedure FIG. 12C to identify whether confirmed receipt message from an AMPA device of user is valid and ends 598. However, if this receipt is cancelled, then an AMPA device of user responds cancelled receipt message to payee's bank service system 601. If an AMPA device of user verifies this receipt is invalid and transmits denied receipt message to payee's bank service system 601. Payee's bank service system receives cancelled/denied receipt message from an AMPA device of user to delete receipt data in receipt database of system and retransmits cancelled/denied receipt message to business service system 602. Business service system receives cancelled/denied receipt message from payee's bank service system and goes to step 625 process procedures FIG. 12D to identify whether cancelled/denied receipt message is true and end 603. If an AMPA device of user did not respond receipt message issued from payee's bank service system during time out, then, payee's bank service system transmits receipt message to security service system 593. Security service system receives receipt message from payee's bank service system goes to step 635 process procedures FIG. 12E to deal with no responding process and ends 594.

FIG. 12C: Continuing reference present invention in FIG. 12B security service system receives confirmed receipt message from an AMPA device of user. In this present invention there is provided a security service system to provide a special service to utilize sub-procedure in FIG. 8C: “Identify Message process” identifying whether this confirmed receipt message is valid. Only valid confirmed receipt is transmitted to business service system and insures service system separately 605.

It is defense potential ID-theft attack risks that ID-theft stolen an AMPA device and transmits confirmed receipt under victim blinding. It is defense potential ID-theft attack risks that ID-theft transmits confirmed receipt with forge signature under victim blinding.

Previous present invention mention in FIG. 12B step 597, system database of security service system stores confirmed receipt message from an AMPA device of user and a determination device as part of security service system identifies whether this confirmed receipt message is valid 606.

A determination device as part of security service system uses confirmed receipt message instead of message in FIG. 8C process step 416 sub-procedure “Identify Message process” to identify whether Message is valid. If A determination device as part of security service system processing sub-procedure of FIG. 8C goes to step 421 in 8C: END_1, then, a valid confirmed receipt is stored in receipt database of security service system and security service system transmits a valid confirmed receipt to insures service system and business service system separately 607. A valid confirmed receipt data is stored in receipt database of business service system to prove that this purchasing transaction with an AMPA of user is successfully and the payment will be obtained from insures service system in order to this valid confirmed receipt data 608 and end 609. A valid confirmed receipt data is stored in receipt database of insures service system 610 and ends 612. If A determination device as part of security service system processing sub-procedure of FIG. 8C goes to step 427 in 8C: END_2, then, an invalid confirmed receipt is issued from security service system to an AMPA device of user, payee's bank service system and business service system. And security service system put an AMPA device of user's name into black list in black list database of security service system 613. Business service system receives invalid confirmed receipt message and cancelled purchasing transaction with an AMPA device of user and deletes receipt data from receipt database of system 614 and ends 615. Payee's bank service system receives invalid confirmed receipt message and deletes receipt data from receipt database 616 and ends 617. An AMPA device of user receives invalid confirmed receipt message and must go to register AMPA service for solution problem 618 and ends 619. If A determination device as part of security service system processing procedure of FIG. 8C goes to step 425 in 8C:END_3, then, a resign confirmed receipt is issued from security service system to an AMPA device of user 620. An AMPA device of user goes to step 590 re-process procedure FIG. 12B to respond receipt to service system again and ends 621.

FIG. 12D: Continuing reference present invention in FIG. 12B step 602 business service system receives denied/cancelled receipt message from payee's bank service system 625.

In this present invention there is provided a business service system to provide special service to check whether denied/cancelled receipt data from an AMPA device of user is true. Only truly denied/cancelled information is accepted by business service system 626.

It is defense potential dishonest person attack risks that person uses an AMPA device with credit card identity to purchase transaction with merchant, however, responded forge receipt message to third service system.

If merchant receives returned purchasing goods/service from an AMPA of user, then, this cancelled is true. The merchant cancels purchasing transaction with an AMPA device of user and deletes receipt data in its receipt database 627 and ends 628. If an AMPA of user did not purchased transaction with merchant, then, this denied is true. The merchant cancels purchasing transaction with an AMPA device of user and deletes receipt data in its receipt database 627 and ends 628. If merchant provides evidence that an AMPA of user purchased goods/then, this cancels is not true. Then, A complaining message appending evidence is issued from business service system to security service system 629. Security service system stores complain message in business complain database to investigate whether this evidence is true 630. If this evidence show that an AMPA device of user purchased goods/service from merchant, then, this evidence is true. The security service system put this AMPA device of user's name into black list in black list database of system 631. And security service system will deal with black list in order to step 430 process procedure FIG. 8D and ends 643.

If this evidence could not show that an AMPA device of user purchased goods/service, then, this evidence is invalid. An invalid evidence message is issued from security service system to business service system 632. Business service system cancels purchasing transaction with an AMPA device of user and deletes receipt data from its receipt database 633 and ends 634.

FIG. 12E: continuing reference present invention step 593 in FIG. 12B an AMPA device of user did not respond to receipt message issued from payee's bank service system. In this present invention, there is provided a security service system to deal with no respond receipt from an AMPA device of user problem 635.

It is defense potential ID-theft attack risks that ID-theft stolen an AMPA device to purchase goods/service under victim blinding. It is defense potential dishonest person attack risks that dishonest person purchased goods/service, however, she/he did not want to make payment to payee's bank.

First, payee's bank service system transmits receipt message with a Timeout (T) to an AMPA device of user 636. If payee's bank service system does not receive any responding information from an AMPA device of user, and then it checks the Timeout T 637. If T<Timeout and no respond information, then payee's bank service system back to step 635 in FIG. 12E process procedure again.

If T>Timeout and no responding, then payee's bank service system transmits receipt message to security service system 638. If T<Timeout, an AMPA device of user receives receipt information and decides to respond receipt message, then, an AMPA device of user goes to step 590 process procedure in FIG. 12B and ends 642. Security service system sends alert message appending receipt data with time out T to an AMPA device of user. If security service system does not receive any responding information from an AMPA device of user, and then it checks the Timeout T 639.

If T<Timeout and no respond, then, security service system back to step 639 in FIG. 12E process procedure again. If T>Timeout and no respond, then security service system put an AMPA device of user's name into black list in black list database 640. And security service system will deal with black list in order to step 430—process procedure FIG. 8D and ends 641. If T<Timeout, an AMPA device of user receives receipt information and decides to respond receipt message, then, an AMPA device of user goes to step 590 process procedure in FIG. 12B and ends 642.

FIG. 12F: Continuing reference present inventions 599 in FIGS. 12B and 610 in FIG. 12C, insures service system receives confirmed receipt data from security service system and payee's bank service system. In this present invention there is provided a determination device as part of insures service system to verify whether confirmed receipt data from security service system is matched with confirmed receipt data from payee's bank service system. Only matched confirmed receipt data is allowed to use for payment process 645.

It is defense potential ID-theft attack risks that ID-theft utilizes technology to access payee's bank service system or security service system to change confirmed receipt data under victim blinding.

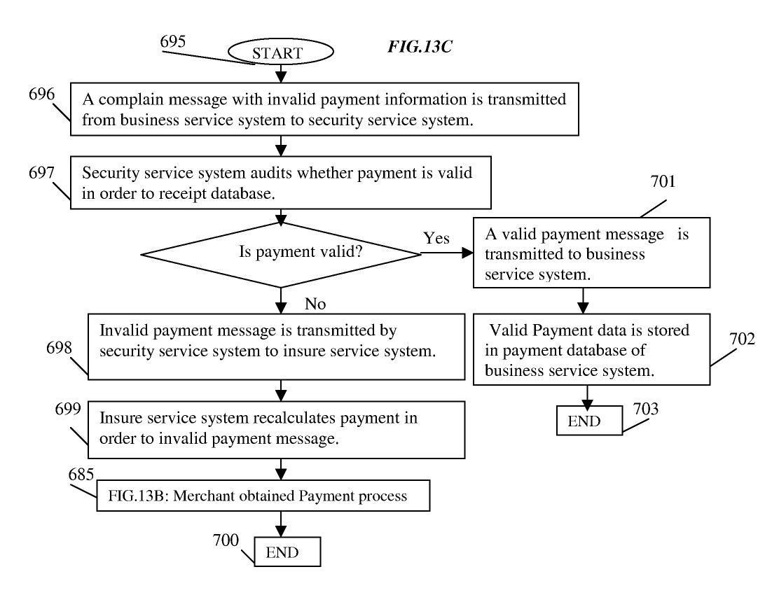

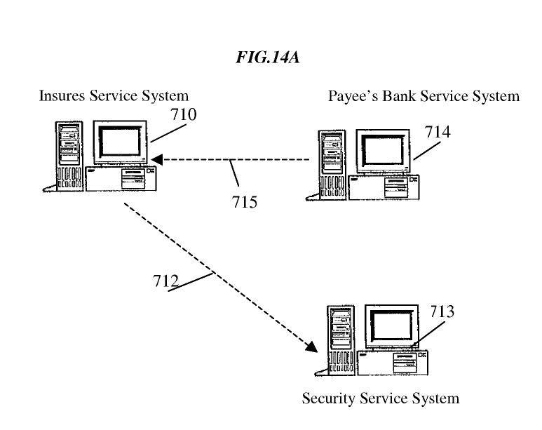

A determination of device as a part of insures service system verifies whether confirmed receipt data from security service system is matched with confirmed receipt data from payee's bank service system 647. If a determination of device as a part of insures service system verifies that confirmed receipt data is matched, then a system database stores confirmed receipt data in receipt database of insures service system 648. Insures service system is going to step 685 to process procedure FIG. 13B to make payment to merchant in order to confirmed receipt data in receipt database and end 649. If a determination of device as a part of insures service system verifies that confirmed receipt data is not matched, then a complain message appending invalid confirmed receipt data is transmitted by insures service system to security service system 650. Security service system goes to step 655 process procedure in FIG. 12G to deal with complain message appending to invalid confirmed receipt from insures service system and end 651.

FIG. 12G: continuing reference present invention procedure in FIG. 12F security service system receives complain message appending to invalid confirmed receipt data from insures service system. In this present invention there is provided a security service system to verify error in confirmed receipt data is made by payee's bank service system or security service system in order to receipt database of security service system 655.

Security service system receives complain message appending to an invalid confirmed receipt data from insures service system 656. A determination device of security service system verified whether invalid confirmed receipt data is matched with confirmed receipt data in receipt database 657. If a determination device of security service system verifies that confirmed receipt data is matched, mean that error in confirmed receipt data is made by payee's bank service system. In other words, payee's bank service system made mistaken. So that security service system utilizes confirmed receipt data from receipt database to be valid confirmed receipt data and retransmits them to payee's bank service system and insures service system 658. Payee's bank service system stores valid confirmed receipt data from security service system to instead of receipt data in receipt database and retransmits receipt data to insures service system 659 and end 660. Insures service system stores valid confirmed receipt data to instead of receipt data in receipt database from security service system and goes to step 645 process procedures FIG. 12F to identify confirmed receipt again and end 666. If a determination device of security service system verifies confirmed receipt data is not matched, mean that error in confirmed receipt data is made by security service system. In other words, security service system made mistaken. So that security service system utilizes confirmed receipt data from payee's bank service system to be valid confirmed receipt data. And transmits them to insures service system and business service system 662. Insures service system stores valid confirmed receipt data to instead of receipt data in receipt database and goes to step 645 process procedures FIG. 12F to identify confirmed receipt again and end 666. Business service system stores valid confirmed receipt data to instead of receipt data in receipt database 664 and end 665

FIG. 13A: Continuing reference present invention in FIG. 12F, valid confirmed receipt is stored in receipt database of insures service system. In this present invention diagram illustration FIG. 13A merchant obtain payment process.

After payee's bank service system 678 and security service system 674 receives respond message with confirmed receipt data from an AMPA of user (no illustration) separately.

Security service system 674 transmits valid confirmed receipt data to businesses service system 672 over wired network 675 and a system stores valid confirmed receipt data from the security service system 674 in receipt database of business service system 672. Valid confirmed receipt data is transmitted from the security service system 674 to insures service system 670 over wired network 676 and also Payee's bank service system 678 transmits confirmed receipt data to insures service system 670 over wired network 679. After insures service system 670 receives confirmed receipt data from payee's bank service system 678 and from security service system 674 separately, a determination device as part of insures service system 670 identifies whether confirmed receipt data is matched. Only matched confirmed receipt data is allowed to be valid confirmed receipt data that is stored in receipt database for payment processing. Insurant who uses insures service system 670 calculates payment in order to receipt database and merchant who uses business service system 672 will obtain payment from insurant who uses insures service system 670 over wired network 671.

A determination device as a part of business service system verifies whether payment is valid. Only valid payment is allowed to be stored in payment database of businesses service system. If invalid payment, then a complain message appending invalid payment information is transmitted by business service system 672 to the security service system 674 over wired network 673.

FIG. 13B: continuing reference present invention in FIG. 12F the business service system stores valid confirmed receipt data in receipt database and also insures service system stores valid confirmed receipt data in receipt database. In this present invention that insures service system offers AMPA device to user who use it to purchase goods/service with merchant. And merchant offers goods/service. Therefore, the insurant will obtain service fee from merchant and calculates service fee subtract from receipt fee of customer who uses AMPA device to purchase goods/service and also guarantee merchant who do business/service with customer obtaining payment from insurant 685.

Insures service system goes to step 645 process procedures FIG. 12F to obtain valid confirmed receipt data of an AMPA device of user. And valid confirmed receipt data is stored in receipt database of insures service system 686. Since insurant provides an AMPA device to user who uses AMPA device purchasing transaction with merchant, then the merchant will pay service fee for each AMPA device of user who purchased transaction with this merchant 687. An acquisition device as part of insures service system acquires payment to subtract service fee from receipt data in order to receipt database for a customer and then insurant deposits money to account of merchant.

And the payment function illustration 688:

Payment (per customer)=receipt fee (per customer)−service fee (per customer)

Insurant who utilizes insures service system makes payment to merchant who utilizes business service system offers goods/service every day 689. A determination device as a part of businesses service system audits whether this payment is valid in order to receipt database of business service system 690. If A determination device as a part of businesses service system audits invalid payment, then a complain message with invalid payment data is sent by business service system to security service system. And security service system goes to step 695 process procedure FIG. 13C to deal with merchant complain message and end 693. If a determination device as a part of businesses service system audits valid payment, valid payment is stored in payment database of business service system 691 and ends 692.

FIG. 13C: Continuing reference present invention in FIG. 13B business service system transmits a complain message to security service system.

In this present invention there is provided a security service system to provide a special service to deal with complain message issued from business service system and a determination device as a part of security service system identifies whether payment information from insures service system is valid 695.

It is defense potential ID-theft attack risk that ID-theft utilizes technology to access into insures service system and changes payment information under victim blinding.

A determination device as a part of security service system receives complain message with payment information from business service system 696. A determination device as part of security service system audits whether payment information from business service system is valid in order to receipt database of security service system 697. First, an acquisition device as a part of security service system acquires payment data to subtract service fee from receipt data according to receipt database of security service system. Second, an acquisition device as a part of security service system compares acquiring payment data with payment data from businesses service system. If the acquiring payment data is matched with payment data from businesses service system, a valid payment message is transmitted to business service system 701. Valid payment data is stored in payment database of business service system 702 and ends 703. If the acquiring payment data is not matched with payment data from businesses service system, Security service system transmits invalid payment message with mistaking information to insures service system 698. Insures service system must recalculate the payment in order to mistaking information in invalid payment message from security service system 699 and goes to back step 685 to process procedure in FIG. 13B to recalculate payment to merchant and ends 700.

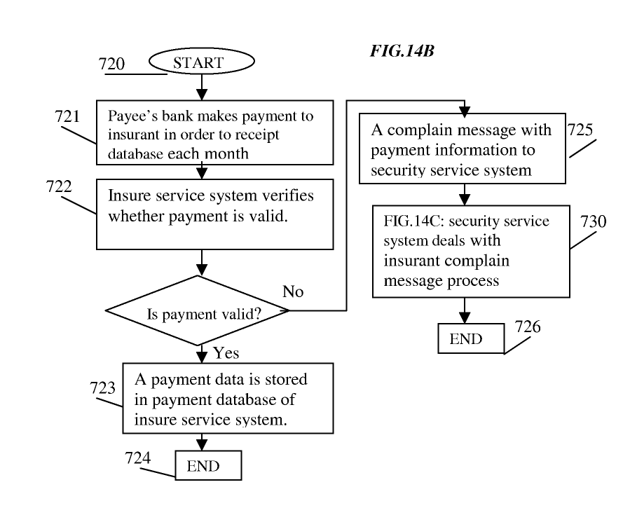

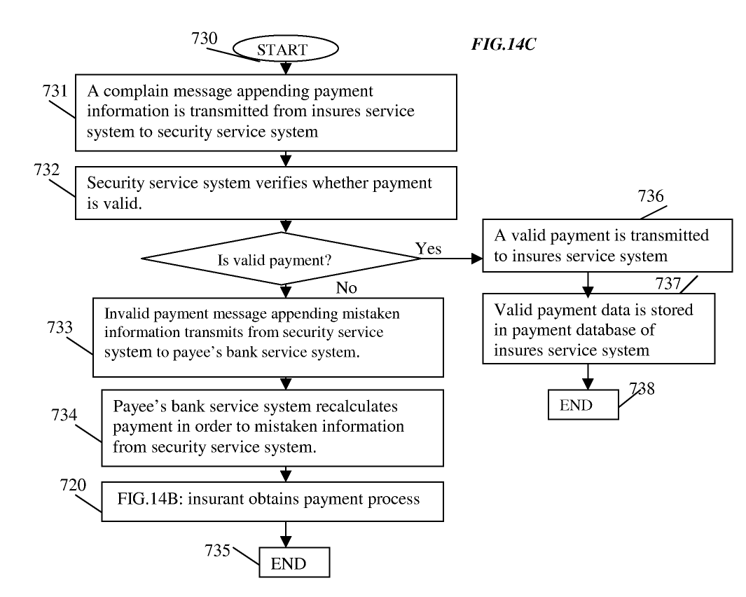

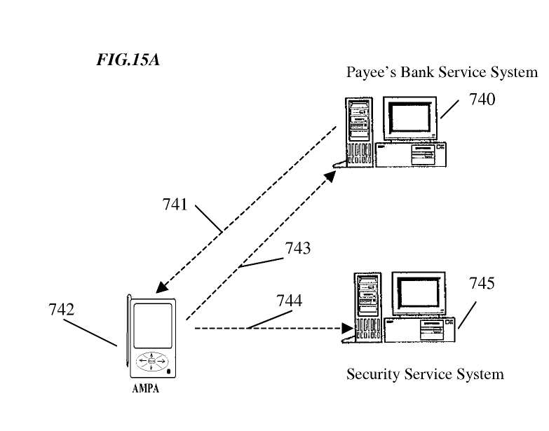

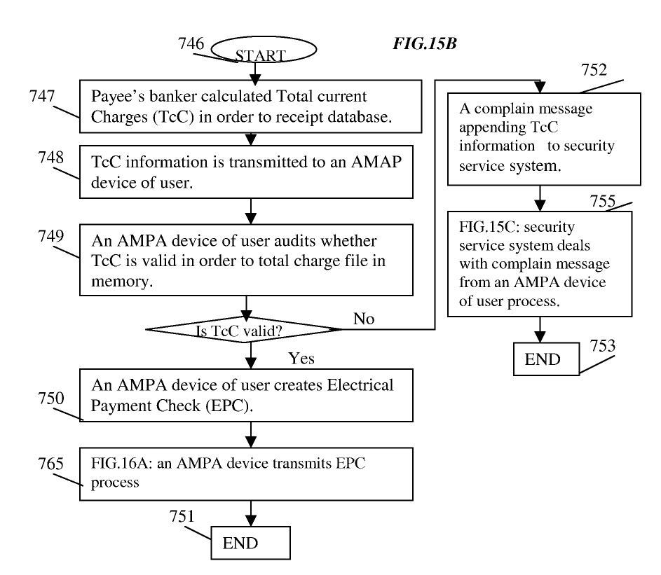

FIG. 14A: pervious present invention mentions FIG. 13A diagram illustration that insurant makes payment to merchant every day. Moreover, due to purchase goods/service with credit card identity is made by an AMPA device of user, the payee's bank guarantees to assure that insurant obtains payment according to receipt database each month. In FIG. 14A present invention diagram illustration payee's bank makes payment to insurant each month.

Payee's bank that utilizes payee's bank service system 714 calculates payments for an AMPA device of user who purchases goods/service with credit card identity in order to receipt database of payee's bank service system each month. And payee's bank that utilizes payee's bank service system 714 deposits payment to insurant who utilizes insures service system 710 over wired network 715. If insurant who utilizes insures service system 710 did not satisfy payment from payee's bank who utilizes banks service system 714, insures service system 710 transmits a complain message appending payment information to security service system 713 over wired network 712.

FIG. 14B: In previous present invention mention, Purchasing goods/service with credit card identity is made by customer using AMPA device; offering goods/service is made by merchant; offering AMPA device is made by insurant; And providing credit card identity is made by payee's banker. Insurant guarantees to make payment to merchant every day. In this present invention there is provided a payee's banker in a special service to calculate payment data and guarantee to make payment to insurant each month process in defense ID theft attack security service system 720.

An acquisition device as part of Payee's bank service system acquires payment to sum total receipt data of an AMPA device of user who purchases goods/service with credit card identity according to receipt database of system each month, then sum total receipt data in one month is stored in payment database of payee's bank service system. So that payee's banker makes payments to insurant according to payment database of payee's bank service system 721. A determination device as a part of insures service system verifies whether payment is valid in order to receipt database of insures service system 722. First, an acquisition device as a part of insures service system acquires payment to sum total receipt data of an AMPA device of user according to receipt database of system and total receipt data is stored in payment database each month. Second, a determination device as a part of insures service system compares received payment from payee's bank service system against with stored payment data in payment database of insures service system.

If a determination device as a part of insures service system identifies that this is a valid payment from payee's bank service system, then payment data is stored in payment database of insures service system 723 and ends 724. If a determination device as a part of insures service system identifies that this is a invalid payment from payee's bank service system, then, insures service system transmits a complain message appending to invalid payment information to security service system 725. After security service system receives complain message from insures service system, it goes to step 730 to process procedure in FIG. 14C to deal with complain message from insures service system and ends 726.

FIG. 14C: continuing reference present invention in FIG. 14B insures service system transmits a complain message to security service system. In this present invention there is provided a security service system to provide a special service to deal with complain message issued from insures service system and a determination device as part of security service system identifies whether payment information from bank service system is valid 730.

It is defense potential ID-theft attack risks that ID-theft utilizes technology to access into payee's bank service system to change payment information under victim blinding.

Security service system receives complain message appending to payment information from insures service system 731. A determination device as a part of security service system verifies whether payment data from payee's bank service system is valid 732. First, an acquisition device as a part of security service system acquires payment to sum total receipt data of an AMPA device of user according to receipt database of system and total receipt data is stored in payment database. Second, a determination device as a part of security service system compares received payment from insures service system against with stored payment data in payment database of security service system.

If a determination device as a part of security service system identifies that this is an invalid payment, Security service system transmits an invalid payment appending to mistaken information to payee's bank service system 733. Payee's bank service system must recalculate payment in order to message appending to mistaken information from security service system 734 and goes to step 720 process procedures FIG. 14B to recalculate payment data and makes payment to insurant and end 735. If a determination device as a part of security service system identifies this is a valid payment, a valid payment message is transmitted to insures service system 736. This valid payment is stored in payment database of insures service system 737 and ends 738.

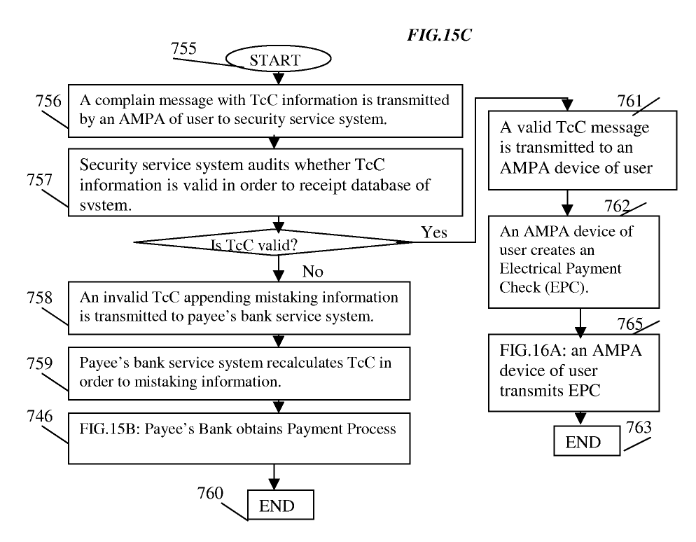

FIG. 15A: continuing reference present invention in FIG. 14A diagram illustration insurant obtained payment from payee's banker. In this present invention FIG. 15A diagram illustration payee's banker obtains payment from customer who used an AMPA device with credit card identity to purchase transaction with merchant each month.

Initial, payee's banker who uses payee's bank service system 740 calculates total current charges for a customer who uses AMPA device with credit card identity to purchase goods/service each month and then payee's bank service system 740 transmits statement including total current charges to an AMPA device 742 of user over wireless network 741. After an AMPA device 742 of user receives statement including total current charges from payee's bank service system 740, an Electrical Payment Check (EPC) is created and transmitted by an AMPA device 742 of user to payee's bank service system 740 over wireless network 743 if an AMPA device 742 of user satisfies statement from payee's bank service system. If an AMPA device 742 of user did not satisfy statement from payee's bank service system, a complain message appending to statement of payee's banker to security service system 745 over wireless network 744.

FIG. 15B: previous present invention mention that payee's banker made payment to insurant in FIG. 14B, then, purchasing goods/service is made by an AMPA device of user using credit card identity, and payee's bank offers credit card to an AMPA device of user. In this present invention there is provided payee's bank service system to calculate total current charges of an AMPA device of user according to receipt database and transmits statement including total current charges to an AMPA of user and an AMPA device of user verifies whether total current charges from payee's bank service system is valid. And only valid total current charges are allowed to be payment data 746.

It is defense potential ID-theft attack risks that ID-theft utilizes technology to access into payee's bank service system to change statement under victim blinding.

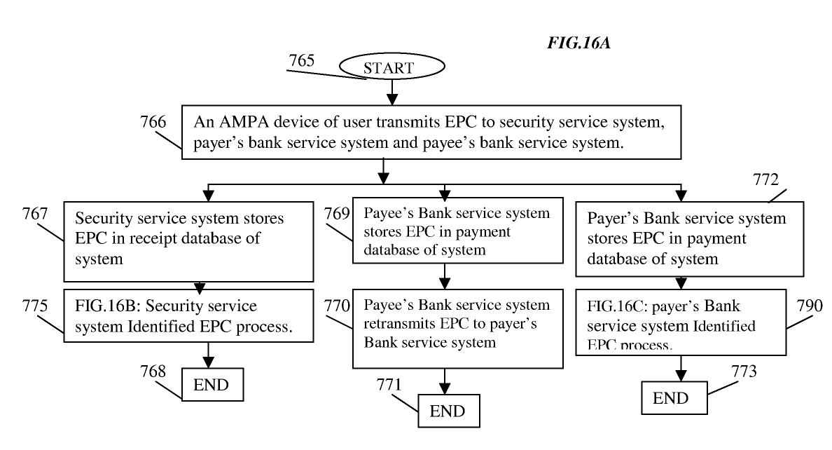

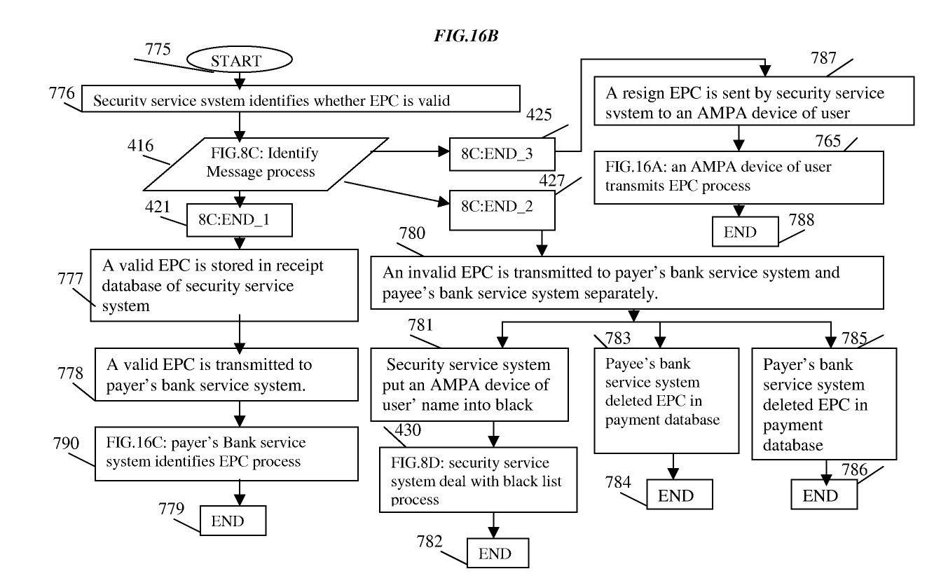

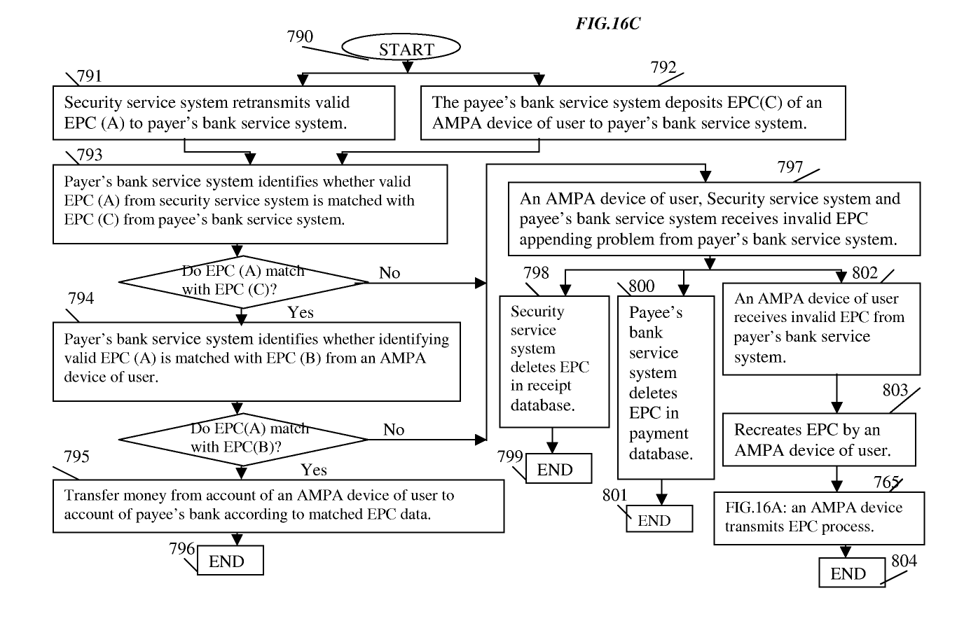

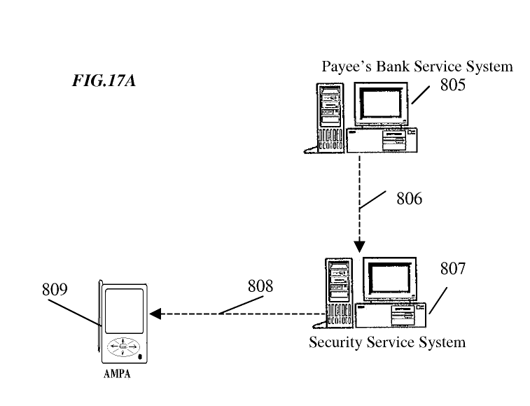

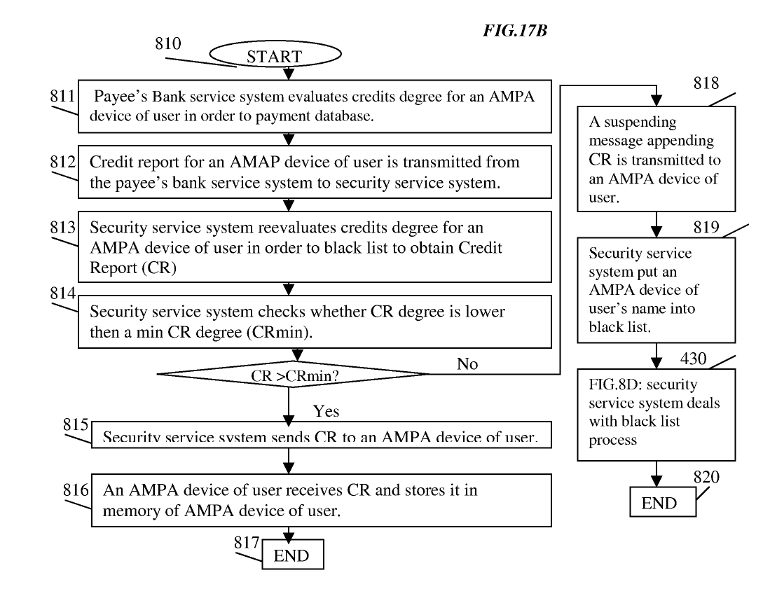

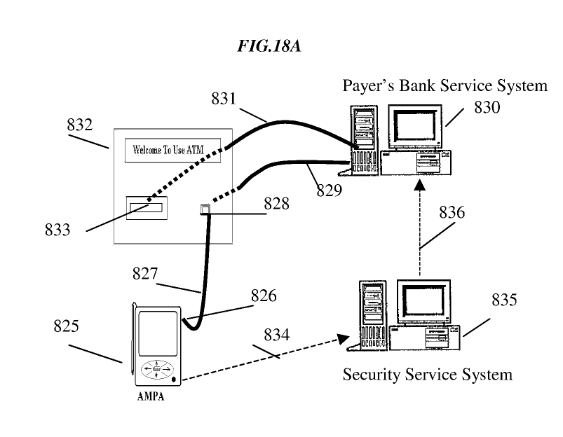

An acquisition device as part of payee's bank service system acquires total current charge to calculate Total current Charges (TcC) for an AMPA device of user in order to receipt database of payee's bank service system and transmits statement including TcC with credit card identity to an AMPA device of user 747 each month. An AMPA device of user receives statement including TcC information 748. First, acquisition device as a part of an AMPA device acquires Total current Charges in order to 215 in FIG. 4O and stores total current charges data in Total Charges File 131 in FIG. 4A in memory of an AMPA device of user. Second, a determination device as a part of an AMPA device of user compares Total current Charge data from payee's bank service system against with Total current Charges in Total Charges File in memory to verify whether Total current Charge from payee's bank service system is valid 749. If a determination device as a part of an AMPA device identifies that total current charges from payee's bank service system is valid, then, an AMPA device of user creates a digital represent image data of Electrical Payment Check (EPC) according to create EPC step 234 in FIG. 4P. An AMPA device of user goes to step 765 process procedures in FIG. 16A and transmit EPC to third service systems and end 751. If a determination device as a part of an AMPA device identifies that Total current Charges from payee's bank service system is invalid, then, an AMPA device of user transmits a complain message appending to TcC information to security service system 752. And security service system goes to step 755 process procedure FIG. 15C to deal with complain message from an AMPA device of user and end 753.

FIG. 15C: continuing reference present invention in FIG. 15B that an AMPA device of user transmits a complain message to security service system. In this present invention there is provided a security service system to provide a special service to deal with complains message issued from an AMPA of user and a determination device as a part of security service system identifies whether TcC information from payee's bank service system is valid 755.

Security service system receives complain message appending to TcC information from an AMPA device of user 756. An acquisition device as a part of security service system acquires Total current Charges (TcC) to sum amount of charges in order to receipt database of system. A determination device as part of security service system compares TcC information from an AMPA device of user against stored TcC data in system to identify whether TcC from an AMPA device of user is valid.

If a determination device as a part of security service system identifies that this TcC from an AMPA device of user is invalid, then, an invalid TcC appending to mistaking information is transmitted to payee's bank service system 758. Payee's Bank service system recalculates TcC in order to mistaking information from security service system 759. Payee's Bank service system goes back to step 746 process procedure FIG. 15B to retransmit statement including TcC to an AMPA device of user and end 760. If a determination device as a part of security service system identifies that this TcC from an AMPA device of user is valid, then, a valid TcC message is responded to an AMPA device of user 761. An AMPA device of user creates an Electrical Payment Check (EPC) 762 according to create EPC step 234 in FIG. 4P and goes to step 765 process procedures FIG. 16A to transmit EPC to third service system for payment and end 763.

FIG. 16A: continuing reference present invention in FIG. 15B an AMPA device of user receives valid Total current Charges (TcC) and an AMPA device of user creates Electrical Payment Check (EPC) according to create EPC step 234 in FIG. 4P for payment. In this present invention there is provided an AMPA device of user transmits Electrical Payment Check to payee's bank service system, security service system and payer's bank service system 765.

It is defense potential ID-theft attack risks that ID-theft utilizes stolen an AMPA device to transmit forge EPC to payee's bank service system under victim blinding.

An AMPA device of user utilizes software program to create EPC in order to step 234 in FIG. 4P. A digital represent image data of EPC is transmitted from an AMPA device of user to security service system, payer's bank service system and payee's bank service system 766 separately. Security service system stores EPC in receipt database of system 767 and goes to step 775 process procedures FIG. 16B to identify whether EPC is valid and end 768. Payee's bank service system stores EPC in payment database of system 769. Payee's bank service system retransmits EPC of an AMPA device to payer's bank service system for deposit money 770 and end 771. Payer's bank service system stores EPC from an AMPA device of user in payment database of system 772. Payer's bank service system goes to step 790 process procedures in FIG. 16C to identity whether EPC is valid and end 773.

FIG. 16B: Continuing reference present invention in FIG. 16A: Security service system receives EPC from an AMPA device of user. In this present invention there is provided a security service system to provide a special service to utilize sub-procedure in FIG. 8C Identify Message process and identify whether this EPC is valid. Only valid EPC is transmitted to payer's bank service system 775.

It is defense potential ID-theft attack risks that ID-theft stolen an AMPA device to create EPC under victim blinding.

Previous present invention mention in FIG. 16A step 767 Security service system receives a digital image data of EPC from an AMPA device of user and a determination device as a part of security service system identifies whether this EPC is valid 776. A determination device as a part of security service system uses EPC message instead of message in FIG. 8C and goes to step 416 processing sub-procedure “Identify Message process” to identify whether EPC Message is valid. If a determination device as a part of security service system processes sub-procedure of FIG. 8C goes to step 421 in 8C:END_1, then, a valid EPC is stored in receipt database of security service system 777. And security service system transmits valid EPC to payer's bank service system 778.

Payer's bank service system receives valid EPC from security service system and goes to step 790—process procedure in FIG. 16C to identify whether EPC is valid and end 779. If a determination device as a part of security service system processes sub-procedure of FIG. 8C goes to step 427 in 8C:END_2, then, an invalid EPC is issued from security service system to payer's bank service system and payee's bank service system 780. And an AMPA device of user's name is put into black list in black list database of security service system 781.

And security service system deals with black list in order to step 430—process procedure FIG. 8D to suspend service for an AMPA device of user in defense ID-theft attack security service system and ends 782. Payee's bank service system receives invalid EPC to delete EPC in payment database of system 783 and end 784. Payer's bank service system receives invalid EPC to delete EPC in payment database of system and cancelled payment process with payee's bank service system 785 and end 786. If a determination device as a part of security service system processes procedure of FIG. 8C goes to step 425 in 8C:END_3, then, a resign EPC is issued from security service system to an AMPA device of user 787. An AMPA device of user goes to step 765 to re-process procedure FIG. 16A to recreate and retransmit an EPC to third service systems and ends 788.

FIG. 16C: continuing reference present invention in FIG. 16A and FIG. 16B, payer's banker received EPC from an AMPA device of user is called EPC (B), received EPC from security service system is called EPC (A) and received EPC from payee's bank service system is called EPC (C). In this present invention there is provided a payer's bank service system to provide a special service in a determination device as a part of payer's bank service system identifies whether EPC (A), EPC (B) and EPC(C) are matched, and all matched EPC is allowed to be valid EPC for making payment process 790.

It is defense potential ID-theft attack risks that ID-theft utilizes technology to access into payee's bank service system or payer's bank service system to change EPC data under victim blinding. It is defense potential ID-theft attack risks that ID-theft utilizes technology access into security service system to change EPC data under victim blinding. It is defense potential ID-theft attack risks that ID-theft stolen an AMPA device and creates forge EPC data under victim blinding.

Payer's bank service system receives EPC (A) from security service system 791 and also receives deposit EPC (C) from payee's bank service system 792. First, a determination device as a part of payer's bank service system identify whether EPC (A) data from security service system is matched with EPC (C) data from payee's bank service system 793. If a determination device as a part of payer's bank service system identifies ECP is matched, Then, a determination device as a part of payer's bank service system identify whether identifying EPC (A) data is matched with EPC (B) data from an AMPA device of user who is payer 794.

If a determination device as a part of payer's bank service system identifies that ECP is matched, then, a payment database of payer's bank service system is stored EPC data and payer's bank transfers money from account of an AMPA device of user who is payer to payee's bank according to match EPC information and transmitting receipt information with confirmed EPC to an AMPA device of user who is payer 795 and end 796. If a determination device as a part of payer's bank service system identifies ECP (A) is not matched with EPC (B) or EPC (C), then, payer's bank service system issued invalid EPC appending to problem to an AMPA device of user who is payer, payee's bank service system and security service system 797. Security service system receives invalid EPC from payer's bank service system to delete EPC in receipt database of system 798 and end 799. Payee's bank receives invalid EPC from payer's bank service system to delete EPC in payment database of system 800 and end 801. An AMPA device of user who is payer receives invalid EPC from payer's bank service system 802 and recreates EPC 803, then going to step 765 process procedures in FIG. 16A retransmit EPC to third service system and end 804.

FIG. 17A: in this present invention diagram illustrate payee's bank service system and security service system will evaluate credit report to an AMPA device of user. And an AMPA device of user receives credit report from security service system each month.

Payee's bank service system 805 evaluates credits degree for an AMPA device 809 of user in order to payment database. A credit report of an AMPA device 809 of user is transmitted from payee's bank service system 805 to security service system 807 over wired network 806. Security service system receives credit report and re-evaluated credit report of an AMPA device 809 of user in order to black list database to obtain new credit report. The credit report message is transmitted by security service system 807 to an AMPA device 809 of user over wireless network 808.

FIG. 17B: in present invention procedure in FIG. 15B illustration payee's banker obtains payment from an AMPA of user. Payee's bank service system evaluates credits degree to customer who used credit card identity with an AMPA device to purchase goods/service in order to payment database. In this present invention there is provided security service system to provide special service to reevaluate credits degree for an AMPA of user in order to black list in black list database 810.

It is defense potential dishonest person attack risk that dishonest person purchased goods/service, however, she/he does not wants to payment to payee's bank. It is punish unresponsive person that person loses her/his AMPA device and did not report to security service system, so that ID-theft picks up an AMPA device to attack under victim blinding.

Payee's Bank service system evaluates credits degree in order to payment database 811. Credit degree information of an AMPA device of user is transmitted from payee's bank service system to security service system 812. A determination device as a part of security service system reevaluates credit degree from payee's bank service system to obtain credit report in order to black list database 813. A determination device as a part of security service system verifies whether Credit Report degree (CR) is lower then a minimum Credit Report degree (CRmin) 814. If A determination device as a part of security service system identifies CR>CRmin, then, security service system transmits CR information to an AMPA device of user 815. An AMPA of user receives CR from security service system and stores CR in Credit Report File 125 in FIG. 14A in memory of AMPA device 816 and ends 817. If A determination device as a part of security service system identifies CR<CRmin, then, a suspending message appending to credit report is transmitted from security service system to an AMPA device of user 818. Security service system put an AMPA device of user who had lower credit degree into black list 819. Security service system goes to step 430 process procedures in FIG. 8D to deal with black list and end 820.

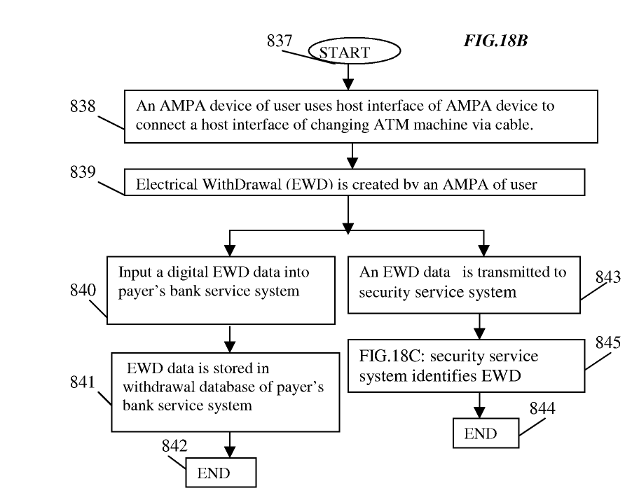

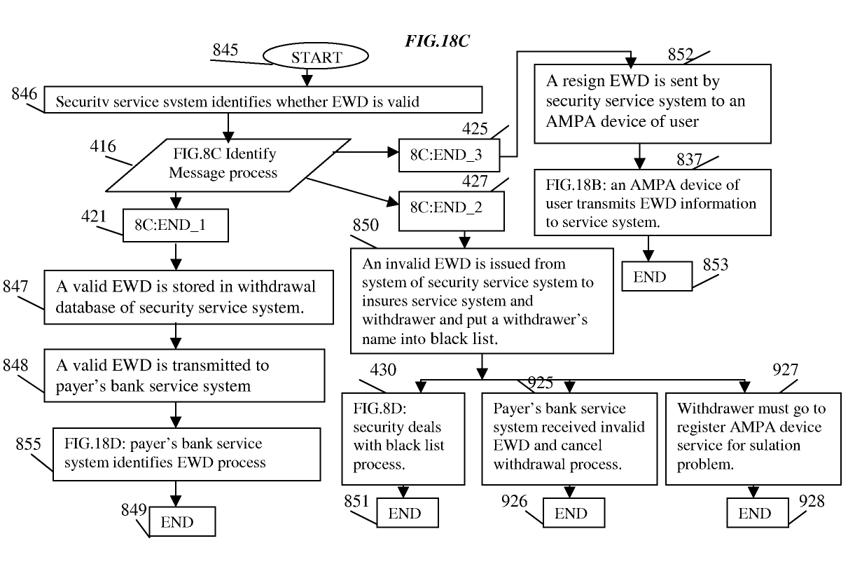

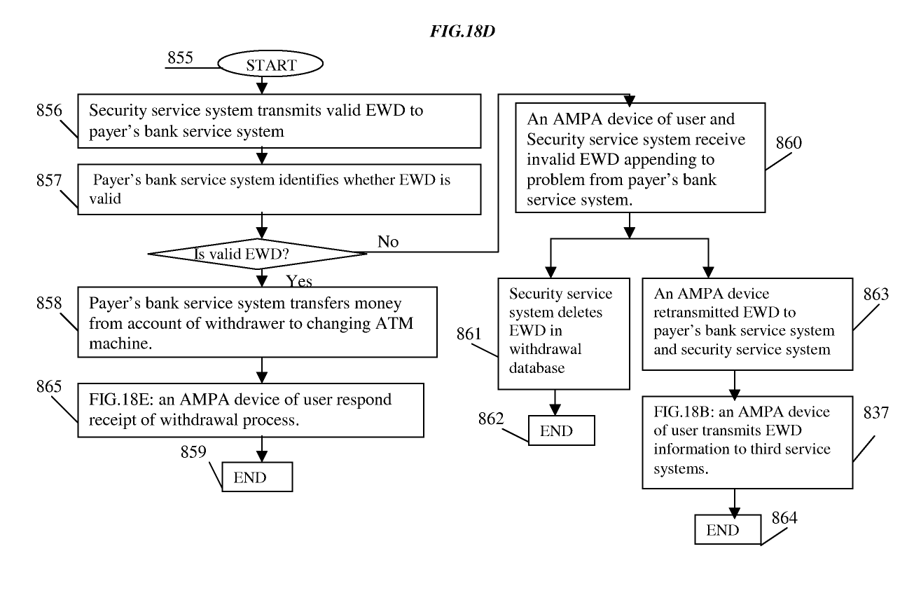

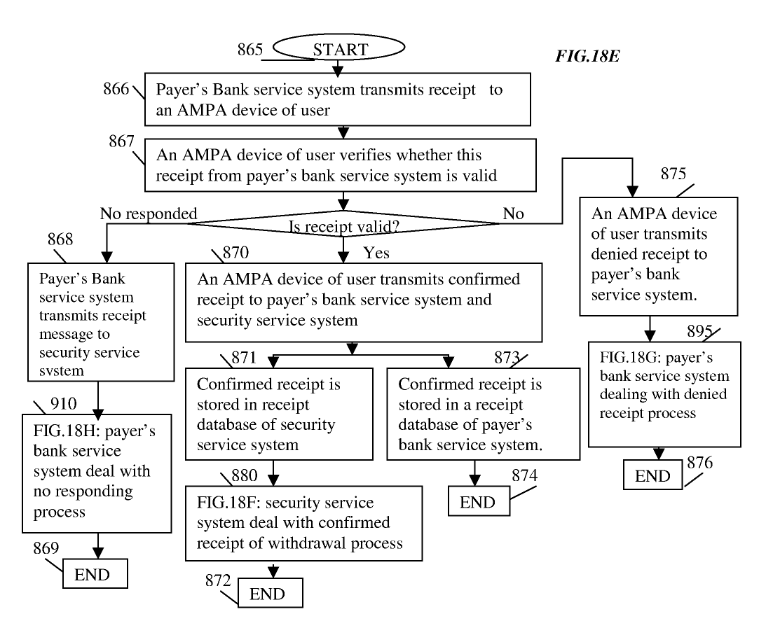

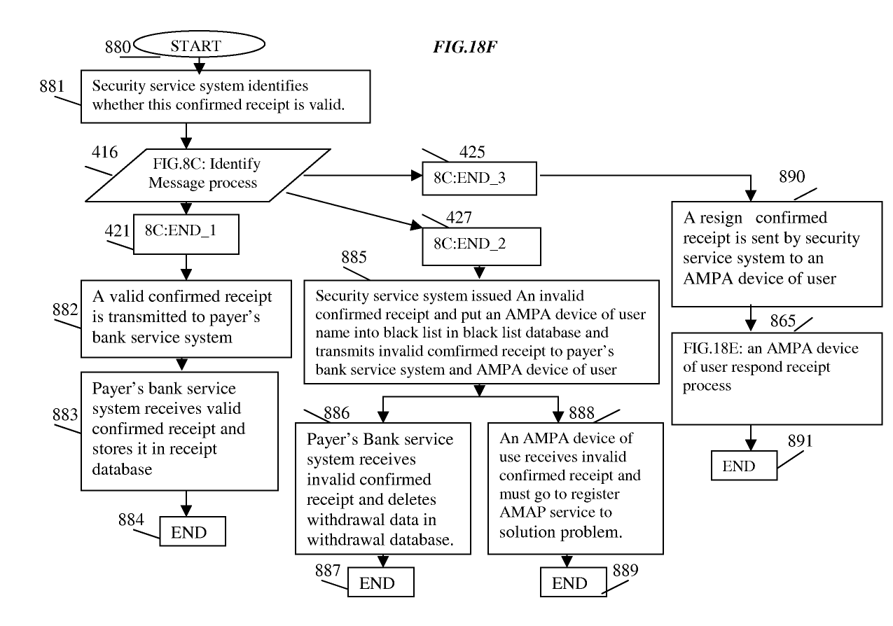

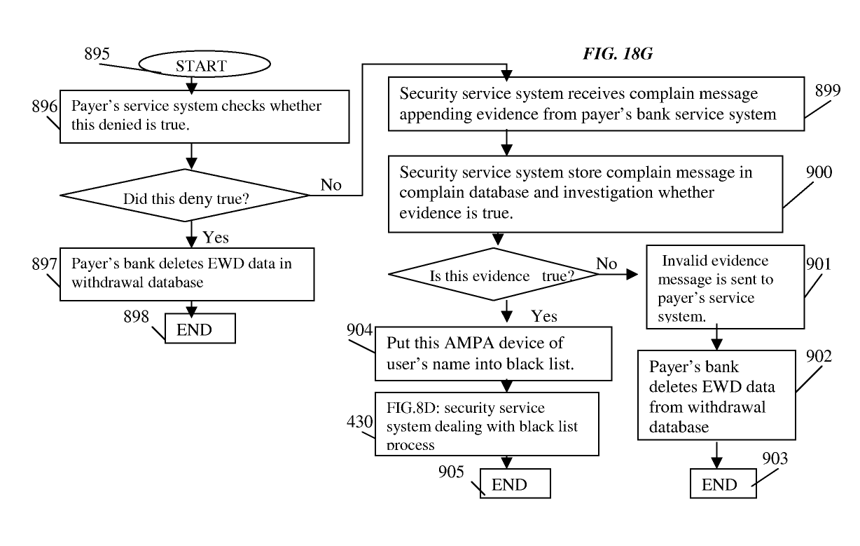

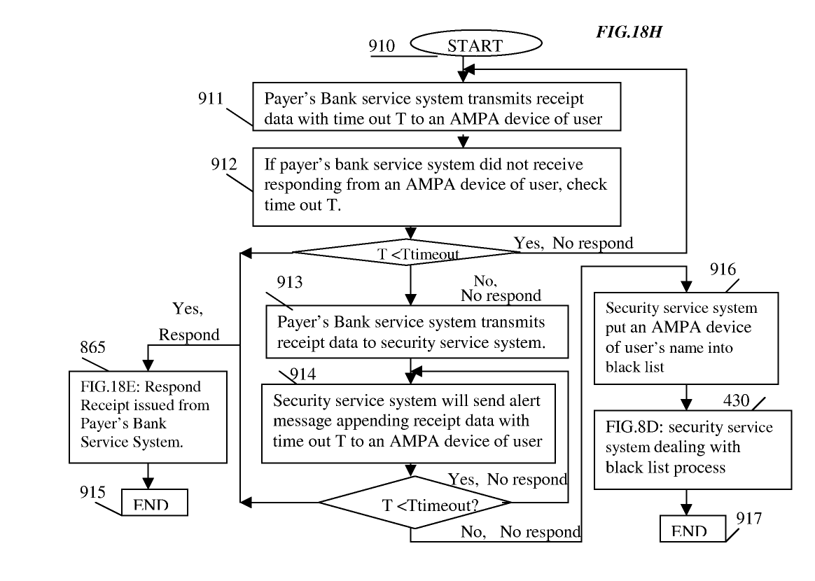

FIG. 18A: pervious present invention in FIG. 11A diagram illustration that withdrawal is made an AMPA device of user using Changing ATM machine, and payer's banker provides Changing ATM machine. And an AMPA device of user provides personal account information via wired communication. In this present invention in FIG. 8A diagram illustration that an AMPA device of user withdraws money with Electrical WithDrawal (EDW) from Changing ATM machine.

Withdrawer (no illustration) uses an AMPA device 825 to connect Changing ATM machine 832 via cable 827 between host interface 826 of an AMPA device 825 and host interface 828 of Changing ATM machine 832.

And host interface 828 of ATM machine 832 connects with a computer of payer's bank service system 830 via a cable 829. An AMPA device 825 of user creates digital represent image data of Electrical WithDrawal (EWD) and transmits EWD from an AMPA device 825 to payer's bank service system 830 through host interface 826 via cable 827 to a host interface 828 via a cable 829 to computer of payer's bank service system 830. And also EWD is transmitted from an AMPA device 825 to security service system 835 via wireless network 834. Security service system provides a special service to identify whether EWD is valid and transmits valid EPC to payer's bank service system 830 via wired network 836. Payer's Bank service system 830 decides whether an AMPA device 825 of user can withdraw money from her/his personal account number using Changing ATM machine 832. And payer's bank service system 830 controls Changing ATM machine 832 via a cable 831 to send money out from output 833 according to valid EWD.

FIG. 18B: continuing reference present invention in FIG. 18A diagram, in this present invention illustration process procedure that there is provided payer's bank service system to provide special service to allow an AMPA device of user withdrawal money from Changing ATM machine 837.

It is that defense potential ID-theft attack risks that ID-theft utilizes stolen credit card identity and password to withdraw money under victim blinding.

An AMPA device of user utilizes a host interface of an AMPA device to connect with a host interface of changing ATM machine via a cable 838. And an AMPA device of user creates a digital represent image data of Electrical WithDrawal (EWD) with stylus on screen of an AMPA device 839 in order to creating EWD 303 in FIG. 5B. An AMPA device of user transmits a digital represent image data of EWD into Changing ATM machine to compute of payer's bank service system 840.

EWD data is stored in a withdrawal database of payer's bank service system 841 and ends 842.

And a digital image data of EWD is transmitted from an AMPA device of user to security service system over wireless network 843. And security service system goes to step 845—process procedure FIG. 18C to identify whether EWD is valid and end 844.

FIG. 18C: continuing reference present invention in FIG. 18B. In this present invention there is provided a security service system to provide a special service to identify whether the EWD from an AMPA of user is valid. Only valid EWD is allowed to withdraw money from Changing ATM machine 845.

It is that defense potential ID-theft attack risk that ID-theft stolen an AMPA device and creates forge EWD to withdraw money from Changing ATM machine under victim blinding.

Previous present invention mention step 843 in FIG. 18B Security service system receives digital represent image data of EWD from an AMPA device of user and a determination device as a part of security service system identifies whether this EWD is valid 846. A determination device as a part of security service system uses EWD message instead of message in FIG. 8C goes to step 416 processing sub-procedure “Identify Message process” to identify whether Message is valid.

If a determination device as a part of security service system processes sub-procedure of FIG. 8C going to step 421 in 8C:END_1, then, a valid EWD is stored in withdrawal database of security service system and transmits valid EWD message to payer's bank service system 847. And payer's bank service system receives a valid EWD issued from security service system 848.

And then, a determination device as part of payer's bank service system goes to step 855 process procedures in FIG. 18D to identify whether EWD is valid and end 849. If a determination device as a part of security service system processes sub-procedure of FIG. 8C going to step 427 in FIG. 8C: END_2, then, an invalid EWD is issued from security service system to payer's bank service system and an AMPA device of user who is withdrawer; and also putting AMPA device of user's name into black list in black list database of security service system 850. And security service system deals with black list in order to step 430—process procedure FIG. 8D to suspend service of AMPA device of user in Defense ID-theft attack security service system and ends 851. Payer's bank service system received invalid EWD from security service system to cancel withdrawal process and delete EWD from withdrawal database 925 and ends 926. An AMPA device of user who is withdrawer received invalid EWD message from security service system and must go to register AMPA device service for solution problem 927 and ends 928. If a determination device as a part of security service system processes procedure of FIG. 8C going to step 452 in 8C:END_3, then, a resign EWD is issued from security service system to an AMPA device of user 852. An AMPA device of user goes to step 837 to re-process procedure FIG. 18B to recreates and retransmits an EWD to third service system and ends 853.

FIG. 18D: continuing reference present invention in FIG. 18C. A valid EWD is transmitted from security service system to payer's bank service system. In this present invention there is provided a payer's bank service system to identify whether EWD from security service system is matched with EWD from an AMPA device of user. Only matched EWD is allowed to withdraw money from changing ATM machine 855.

It is defense potential ID-theft attack risk that ID-theft utilizes technology access security service system or payer's bank service system to change EWD data under victim blinding. It is defense potential ID-theft attack risk that ID-theft sends forges EWD to payer's bank service system under victim blinding.

Security service system transmits valid EWD to payer's bank service system 856. Payer's bank service system receives valid EWD from security service system and a determination device as a part of payer's bank service system identifies whether EWD from security service system is matched with EWD from an AMPA device of user 857. If a determination device as a part of payer's bank service system identifies EWD is valid, then payer's bank service system transfers money from account of an AMPA device of user who is withdrawer into changing ATM machine and transmits receipt information with confirmed EWD to an AMPA device of user who is withdrawer 858.

And an AMPA device of user who is withdrawer goes to step 865 process procedures FIG. 18E to respond receipt of withdrawal and end 859. If a determination device as a part of payer's bank service system identifies EWD is invalid, then, payer's bank service system issued an invalid EWD to an AMPA device of user and security service system 860. Security service system receives invalid EWD information from payer's bank service system to delete EWD in withdrawal database of system 861 and end 862. An AMPA device of user receives invalid EWD information from payer's bank service system 863 and goes to step 837 process procedures FIG. 18B to re-create and retransmit EWD to third service system and end 864.

FIG. 18E: continuing reference present invention in FIG. 18D an AMPA device of user withdraws money from Changing ATM machine and payer's bank offers Changing ATM machine. In this present invention process procedure in FIG. 18E there is provided an AMPA device to provide special service that an AMPA device of user identifies whether receipt from payer's bank service system is valid and respond receipt issued to payer's bank service system and also to security service system 865. An AMPA of user responds receipt message from payer's bank service system having some probabilities in responds: A) An AMPA device of user confirms receipt from payer's bank service system is valid because it is true that she/he withdraws money from Changing ATM machine. B) An AMPA device of user denies receipt from payer's bank service system because the receipt data is not correct such as ID-theft accesses into computer of payer's bank service system to change receipt data under victim blinding. C) An AMPA device of user denies receipt from payer's bank service system because the receipt data is invalid such as ID-theft stolen an AMPA device to withdraw money from Changing ATM machine under victim blinding. D) An AMPA device of user no respond in receipt issued from payer's bank service system such as an AMPA device could not receive signal or out off batter of an AMPA device, or unauthorized user used an AMPA device under victim blinding etc.

Payer's bank service system transmits receipt to an AMPA device of user in order to EWD of an AMPA device of user over wireless network 866. An AMPA device of user receives receipt message from payer's bank service system to verify whether this receipt is valid 867. If an AMPA device of user verifies this receipt is valid, then an AMPA device of user responds confirmed receipt message to payer's bank service system and transmits confirmed receipt message to security service system 870. A receipt database of payer's bank service system stores confirmed receipt data from an AMPA device of user 873 and end 874. A receipt database of security service system stores confirmed receipt data 871 and go to step 880 to process procedure FIG. 18F to identify whether confirmed receipt message from an AMPA device of user is valid and ends 872. If an AMPA device of user verifies this receipt is invalid and transmits denied receipt message to payer's bank service system 875. Payer's Bank service system receives denied receipt message from an AMPA device to go to step 895 process procedures FIG. 18G to identify whether denied receipt message is true and end 876. If an AMPA device of user did not respond receipt message issued from payer's bank service system during time out, then, payer's bank service system transmits receipt message to security service system 868. Security service system receives receipt message from payer's bank service system goes to step 910 process procedures FIG. 18H to deal with no responding process and ends 869.

FIG. 18F: Continuing reference present invention in FIG. 18E security service system receives confirmed receipt message from an AMPA device of user. In this present invention there is provided a security service system to provide a special service to utilize sub-procedure in FIG. 8C: “Identify Message process” identifying whether this confirmed receipt message is valid. Only valid confirmed receipt is transmitted to payer's bank service system separately 880.

It is defense potential ID-theft attack risks that ID-theft stolen an AMPA device and transmits confirmed receipt under victim blinding. It is defense potential ID-theft attack risks that ID-theft transmits confirmed receipt with forge signature under victim blinding.

Previous present invention mention in FIG. 18E step 871, system database of Security service system stores confirmed receipt message from an AMPA device of user and a determination device as part of security service system identifies whether this confirmed receipt message is valid 881. A determination device as part of security service system uses confirmed receipt message instead of message in FIG. 8C process step 416 sub-procedure “Identify Message process” to identify whether Message is valid. If A determination device as part of security service system processing sub-procedure of FIG. 8C goes to step 421 in 8C: END_1, then, a valid confirmed receipt is stored in receipt database of security service system and security service system transmits a valid confirmed receipt to payer's service system 882. A valid confirmed receipt data is stored in withdrawal database of payer's service system to prove that withdrawal process is successful 883 and end 884.

If A determination device as part of security service system processing sub-procedure of FIG. 8C goes to step 427 in 8C: END_2, then, an invalid confirmed receipt is issued from security service system to an AMPA device of user and payer's bank service system 885. Payer's service system receives invalid confirmed receipt message from security service system and deletes withdrawal data from withdrawal database of payer's banks service system 886 and ends 887. An AMPA device of user receives invalid confirmed receipt message from security service system and must go to register AMPA service to solution problem 888 and ends 889. If A determination device as part of security service system processing procedure of FIG. 8C goes to step 425 in 8C:END_3, then, a resign confirmed receipt is issued from security service system to an AMPA device of user 890. An AMPA device of user goes to step 865 re-process procedure FIG. 18E to respond receipt to service system again and ends 891.

FIG. 18G: Continuing reference present invention in FIG. 18E step 875, payer's service system receives denied receipt message from an AMPA device of user 895.

In this present invention there is provided a payer's bank service system to provide special service to check whether denied receipt data from an AMPA device of user is true. Only truly denied information is accepted by payer's service system 896.

It is defense potential dishonest person attack risks that person uses an AMPA device with personal account to withdraw money from Changing ATM machine, and responded forge receipt message to payer's bank service system.

If payer's bank did not transfer money to Changing ATM machine, then, this denied receipt is true. Payer's bank service system deletes EWD data in withdrawal database 897 and ends 898. If a determination device as part of payer's bank service system verifies money is transferred to Changing ATM machine, that this denied receipt is not true. Then, A complains message appending to evidence is issued from payer's service system to security service system 899. Security service system stores complain message from payer's bank service system in complain database to investigate whether this evidence is true 900. If this evidence show that an AMPA device of user taken money from Changing ATM machine, then, this evidence is true. The security service system put this AMPA device of user's name into black list in black list database of system 904. And the security service system will deal with black list in order to step 430—process procedure FIG. 8D and ends 905. If this evidence could not show that an AMPA device of user taken money from Changing ATM machine, then, this evidence is invalid. An invalid evidence message is issued from security service system to payer's service system 901.

Payer's bank service system deletes EWD data from withdrawal database 902 and ends 903.

FIG. 18H: continuing reference present invention step 868 in FIG. 18E an AMPA device of user did not respond to receipt message issued from payer's bank service system. In this present invention, there is provided a security service system to deal with no respond receipt from an AMPA device of user problem 910.

It is defense potential ID-theft attack risks that ID-theft stolen an AMPA device to withdraw money from Changing ATM machine under victim blinding. It is defense potential dishonest person attack risks that dishonest person withdraws money from Changing ATM machine; however, she/he did not want to admit it.

First, payer's bank service system transmits receipt message with a time out (T) to an AMPA device of user 911. If payer's bank service system does not receive any responding information from an AMPA device of user, and then it checks the Ttimeout T 912. If T<Timeout and no respond information, then payer's bank service system back to step 911 in FIG. 18H process procedure again.

If T>Timeout and no responding, then payer's bank service system transmits receipt message to security service system 913. If T<Timeout, an AMPA device of user receives receipt information and decides to respond receipt message, then, an AMPA device of user goes to step 865 process procedure in FIG. 18E and ends 915. Security service system sends alert message appending to receipt data with time out T to an AMPA device of user. If security service system does not receive any responding information from an AMPA device of user, and then it checks the Timeout T 914.

If T<Timeout and no respond, then, security service system back to step 914 in FIG. 18H process procedure again. If T>Timeout and no respond, then security service system put an AMPA device of user's name into black list in black list database 916. And security service system will deal with black list in order to step 430—process procedure FIG. 8D and ends 917. If T<Timeout, an AMPA device of user receives receipt information and decides to respond receipt message, then, an AMPA device of user goes to step 865 process procedure in FIG. 12E and ends 915.

What is claimed is:

1. A system and method for defense ID-theft attack security service system comprising: (a) at least four systems said service systems and at least one portable device processor comprising one or more processing elements; and wherein said service system processor is in communication with a plurality of database systems stored digital data and wherein said the service system and processor is programmed or adapted; and wherein a communication interface comprises a receiver that receives inbound communication from a communication channel associated with communication interface said wired network interface and said wireless network interface; and wherein said portable device processor is controlled by Central Process Unit (CPU) said CUP; and wherein said portable device processor is programmed or adapted; and wherein portable device is in communication with data in memory stored digital data; and wherein a communication interface comprises a antenna that receives inbound communication from a communication channel associated with communication interface said wireless network interface; (b) at least four service systems collect data from at least one of service systems and at least one of portable devices and wherein collect data further comprising: analyzing data from at least one of service system and at least one of portable devices to identify potentially ID theft attack events represented in the data; wherein in the data is identified by a determination device as part of a service system; transmitting identification information to third host said computer of third service systems; wherein third service systems based on the empirically derived information to reflect operation; (c) at least one portable device collect data from at least one of service systems and wherein collect data further comprising: auditing data from at least one of service system are stored in memory of portable device to identify potentially ID theft attack events represented in the data, wherein in the data is identified by a determination device as part of portable device according; transmitting identification information to third host said computer of third said service systems; wherein at least one of third service systems based on the empirically derived information to identify potential ID theft attacking and transmit identity events to other third service systems; wherein in other third service systems based on the empirically derived identity events to reflect operation; (d) wherein at least one service system further comprising: offering at least one portable device to customer for purchasing goods or service is made by at least one service system said Insures Service System; (e) wherein at least one service system further comprising: providing digital representations of credit card information to customer said who uses a portable device is made by a service system said bank service system said payee's bank service system of the authenticity of the credit card number; (f) wherein at least one service system further comprising: providing digital representations of account information to customer said who uses a portable device is made by a service system said bank service system said payer's bank service system of the authenticity of the account number; (g) wherein at least one service system further comprising: offering goods or service with at least one device said computer or machine to customer who uses a portable device is made by merchant; wherein computer or machine is as part of at least one service system; offering computer or machine to merchant for pertinent transaction with customer said who uses a portable device is made by at least one service system said business service system; (h) wherein at least one service system further comprising: defeating potential ID theft attack in marketing environment is made by at least one service system said security service system; (i) wherein at least one service system further comprising: ensuring maintaining purchasing transaction data to establish personal account information is made by a portable device said Automatic Management Personal Account device (AMPA device).

2. A system and method for defense ID-theft attack security service system in claim 1, wherein (d) at least one service system said insures service system further comprising: a plurality of database systems stored digital data; and providing register portable device service said registered AMPA device service to a customer; providing digital representation of portable device unique identity said AMPA device identity to a portable device said AMPA device for user said an AMPA device of user is made by at least one service system said insures service system of the authenticity unique portable device identity said AMPA device identity; at least one embodiment of device said determination device as a part of at least one service system said insures service system; wherein at least one determination device further comprising: verifying received digital data said received message from third service systems to prevent ID theft attacking; charging service fee said service fee for at least one portable device said AMPA device from at least one service system said business service system; assuring payment to at least one service system said business service system.

3. A system and method for defense ID-theft attack security service system in claim 1, wherein (e) at least one service system said payee's bank service system further comprising: a plurality of database systems stored digital data; and at least one embodiment of device said determination device as a part of payee's bank service system; wherein at least one determination device further comprising: identifying said credit card identity during customer said an AMPA device of user purchases transaction with said merchant processing; transmitting statement to a customer said an AMPA device of user who purchases goods or service with said credit card identity; ensuring payment to at least one service system said insures service according to portable device identity said AMPA device identity; obtaining payment from a customer said an AMPA device of user who purchase goods or service with said credit card identity; and evaluating said credit report according to payment of customer said an AMPA device of user who purchase goods or service with said credit card identity to at least one service system said security service system.

4. A system and method for defense ID-theft attack security service system in claim 1, wherein (f) at least one service system said payer's bank service system further comprising: A plurality of database systems stored digital data. And at least one embodiment of device said determination device as a part of payer's bank service system; wherein at least one determination device further comprising: identifying potential ID theft attacking in digital represent of Electrical Text; transmitting statement to at least one customer said an AMPA device of user who deposits funds, payment or withdrawal funds with said personal account information; transferring payment funds from said personal account of customer said an AMPA device of user to said payee's bank service system according to digital representation of Electrical Text said Electrical Payment Check of customer said an AMPA device of user; providing machine said ATM machine said Changing ATM machine to connect with at least one portable device said AMPA device for customer who wants withdrawing money from machine said ATM machine said Changing ATM machine according to digital representation of Electrical Text said Electrical Withdrawal of customer who uses an AMPA device withdrawal.

5. A system and method for defense ID-theft attack security service system in claim 4, wherein at least one machine said Changing ATM Machine further comprising: an embodiment device said display which shows how much money was taken by customer said an AMPA device; an embodiment device said money output where customer said an AMPA device of user takes cash; an embodiment device said host interface, which is controlled by CPU of computer in at least one service system said bank service system said payer's bank service system, connects with another one host interface of a portable device of user said AMPA device of user via cable communication said wired communication.

6. A system and method for defense ID-theft attack security service system in claim 1, wherein (g) at least one service system said business service system further comprising: a plurality of database systems stored digital data; and at least one embodiment device as part of said business service system said computer or machine with said an host interface connects with another one host interface of a portable device of user said AMPA device of user via cable said wired communication; at least one embodiment system as part of business service system said Internet or said by telephone communication said wireless communication with said an AMPA device of user; wherein computer or machine are provided to merchant for offering goods or service at an arbitrary place; wherein at an arbitrary place further comprising: at Shop Mall, Shop, at station said Gas Station, Online said using Internet, by telephone etc, and at station said ATM service station.

7. A system and method for defense ID-theft attack security service system in claim 6, wherein host interface of said computer or said machine further comprising: receiving digital represent information said credit card information from at least one portable device of user said AMPA device of user via cable said wired communication; and transmitting message said credit card information to third service system said bank service system said payee's bank service system.

8. A system and method for defense ID-theft attack security service system in claim 6, wherein machine further comprising: using machine said Gas Machine said Changing Gas Machine to provide gas to at least one customer said AMPA device of user; wherein Changing Gas Machine further comprising: an embodiment device said display shows how much gasoline are taken by at least one customer said AMPA device of user; an embodiment device said host interface as part of machine said Gas Machine said Changing Gas Machine in a service system said business service system is provided to connect with another host interface of at least one portable device said AMPA device via cable said wired communication.

9. A system and method for defense ID-theft attack security service system in claim 1, wherein (h) at least one service system said security service system further comprising: A plurality of database systems stored digital data; And at least one determination device as part of at least one service system said security service system; wherein determination device comprising: collection and analyzing data said in received message to identify potentially ID theft attack events and acquires identity events represented in data said in received message; transmitting information about said identity events to host said computer of third service systems in said defense ID-theft attack security service systems; and third service system based on empirically derived information said identity events to reflect operation; wherein to identify potentially ID theft attack events further comprising: identifying whether said an AMPA device is registered in defense ID-theft attack security service system; identifying whether customer said an authority user having the use a registered said AMPA device in defense ID-theft attack security service system; identifying whether received message is valid in defense ID-theft attack security service system; wherein received message further comprising: received receipt from at least one portable device of user said AMPA device of user, received digital representations of Electrical Text said Electrical Payment Check or said Electrical WithDrawal from at least one portable device of user said AMPA device of user; and received complains message from at least one third service systems, or at least one portable device of user said an AMPA device of user in defense ID-theft attack security service system.

10. A system and method for defense ID-theft attack security service system in claim 1, wherein (i) at least one portable device said AMPA device further comprising: (a) with a Central Process Unit (CPU) said CUP control digital data processing in a portable device said an AMPA device; (b) memory is controlled by said Central Process Unit (CPU) to manager electrical file; (c) an embodiment device said power switch is turned on/off by authorized user for opening or closing said electrical file in memory of portable device said an AMPA device; (d) an embodiment device said wireless networks interface that connects with Central Process Unit (CPU) is structured to transmit the communication to at least one service system via wireless network; (e) an embodiment device said host interface that connects with CPU is structured to transmit digital data to a host interface device embodiment in at least one service system said business service system via cable said wired communication; (f) an embodiment device said touch-screen interface connect with Central Process Unit (CPU) to display function both said as a memory display and said a data input device; (g) an embodiment device said a stylus pen is used to input or write digital data on screen said the touch sensitive screen; (h) an embodiment device said Array key interface connect with Central Process Unit (CPU) to choose and display electrical file in memory of said AMPA device.

11. A system and method for defense ID-theft attack security service system in claim 10, wherein said display further comprising after said step (f): accepting the Biometric Identity includes electrical recognizing or capturing the graphic nature of the signature; the Biometric Identity captures also displays the Biometric Identity captures as it is being written; and writing Biometric Identity with said stylus pen and CPU transmits digital represent image data said Biometric Identity said signature appending portable device unique identity said an AMPA identity digital data to at least one service system via said wireless network interface.

12. A system and method for defense ID-theft attack security service system in claim 10, wherein said electrical file further comprising after said step (b): maintaining said personal account file in memory of a portable device of user said AMPA device of user.

13. A system and method for defense ID-theft attack security service system in claim 12, wherein said personal account file comprising: (a) said Identify File; (b) said Number File; (c) said Credit Report File; (d) said Message File; (e) said Credit Card Identity File; (f) said Receipt File; (g) said Total Charges Files; (h) said Electrical Payment Check File; (i) said ATM Electrical WithDrawal (EWD) File; and (j) said Personal Bank Account File.

14. A system and method for defense ID-theft attack security service system in claim 13, wherein said Identify File further comprising after said step (a): storing identity said an AMPA identity, source address said an AMPA IP address and destination IP address said service systems addresses to provide addresses for transmitting packets which is appended said AMPA identity, source address said an AMPA IP address and destination IP address from source address said an AMPA address to destination addresses said service systems addresses.

15. A system and method for defense ID-theft attack security service system in claim 13, wherein said Number File further comprising after said step (b): storing Digital Number to support software program process Digital Number to create digital representation of image Digital Data into Electrical Text by said an AMPA device operation; and storing Letter Number to support software program process Letter Number to create digital representation of image Letter Data into Electrical Text by said an AMPA device operation.

16. A system and method for defense ID-theft attack security service system in claim 13, wherein said Credit Report File further comprising after said step (c): storing credit report information from at least one service system said security service system to report said an AMPA device of user action behavior during purchasing transaction with said merchant processing.

17. A system and method for defense ID-theft attack security service system in claim 13, wherein said Message File further comprising after said step (d): storing message information from at least one service systems to save message into corresponding electrical file and also to responds message with answering said respond type to third service systems.

18. A system and method for defense ID-theft attack security service system in claim 17, wherein said responds type further comprising: said confirmed to accept receipt which purchasing transaction with said merchant events; said denied to refuse receipt which purchasing transaction with said merchant events; said cancelled to invalid receipt which purchasing transaction with said merchant events; said complain to some unclearly digital data represent in message data.

19. A system and method for defense ID-theft attack security service system in claim 13, wherein said Credit Card Identity File further comprising after said step (e): (a) storing digital representation of credit card identity information from at least one service system said bank service system said payee's bank service system to be chose by a customer said an AMPA device of user for purchasing goods or service; and (b) storing digital representation of data of at least one service system said security service system to provide communication with security service system for customer said AMPA device of user.

20. A system and method for defense ID-theft attack security service system in claim 19, wherein said credit card identity information further comprising after said step (a): storing at least one digital representations of credit card number said identity and digital representations of data said credit card expire date are all authenticated by at least one service system said bank service system said payee's bank service system; and storing name and telephone number of at least one service system said bank service system said payee's bank service for communication by telephone; and storing said website address of at least one service system said bank service system said payee's bank service to search more information said payee's bank information online.

21. A system and method for defense ID-theft attack security service system in claim 19, wherein said security service system information further comprising after said step (b): storing name and telephone number of at least one service system said security service for communicate by telephone; and stored website address of at least one service system said security service to search more information said at least one service said security service information online.

22. A system and method for defense ID-theft attack security service system in claim 13, wherein said Receipt File further comprising after said step (f): storing receipt information from at least one service system said bank service system said payee's bank service system and saving responding message said receipt information in Receipt File to maintain purchasing transaction data evidence for defense ID theft attacking.

23. A system and method for defense ID-theft attack security service system in claim 13, wherein said Total Charges Files further comprising after said step (g): storing said total current charges information that is calculated by software program in said an AMPA device in order to said receipt information in file said Receipt File.

24. A system and method for defense ID-theft attack security service system in claim 13, wherein said Electrical Payment Check File further comprising after said step (h): storing (a) Electrical Payment Check (EPC) credit card identity number N information to help said an AMPA device of user search payment history and storing (b) Creating Electrical Payment Check to support a software program for creating Electrical Payment Check to make payment with said an AMPA device of user.

25. A system and method for defense ID-theft attack security service system in claim 24, wherein said EPC credit card identity number N information further comprising after said step (a): storing (a) digital represent of data said Confirmed EPC information to help said an AMPA device of user search received EPC information from service systems and storing (b) digital represent of data said Sent EPC information to remain that said an AMPA device of user had sent payment check to third service systems.

26. A system and method for defense ID-theft attack security service system in claim 25, wherein said Confirmed EPC information further comprising after said step (a): storing received statement with said Confirmed EPC data from at least one service system said bank service system said payer's bank service system.

27. A system and method for defense ID-theft attack security service system in claim 25, wherein said Sent EPC information further comprising after said step (b): storing sent digital represent image data said Electrical Text said Electrical Payment Check (EPC) which transmits digital represent image data said Electrical Text said Electrical Payment Check (EPC) from said an AMPA device of user to third service systems.

28. A system and method for defense ID-theft attack security service system in claim 24, wherein said Creating Electrical Payment Check further comprising after said step (b): supporting software program to create Electrical Text said Electrical Payment Check (EPC) steps to generate an Electrical Text said Electrical Payment Check (EPC) for payment to a payee's bank service system under CUP controlling in said an AMPA device of user; wherein creating Electrical Text said Electrical Payment Check (EPC) steps further comprising: creating digital representations of credit card information embeds in Electrical Text said EPC; creating digital representations of payment date in order to said Digit Data file embeds in Electrical Text said EPC; creating digital representations of said In Payment Order in digital image of said letter data in order to said Letter Number file embeds in Electrical Text said EPC; creating digital representations of said In Payment Order in digital data of image said digital data in order to said Digit Number File embeds in Electrical Text said EPC; creating digital representations of account number said account information in order to Bank Account File embeds in Electrical Text said EPC; and creating digital representations of payer's signature embeds in Electrical Text said EPC.

29. A system and method for defense ID-theft attack security service system in claim 13, wherein said ATM Electrical WithDrawal (said EWD) File further comprising after said step (i): storing digital data said (a) ATM EWD Account Number N information to help said an AMPA device of user search withdrawal information history and Creating (b) Electrical WithDrawal (EWD) to support software program for creating Electrical Text said EWD to said an AMPA device of user withdrawal from ATM machine said Changing ATM machine.

30. A system and method for defense ID-theft attack security service system in claim 29, wherein said ATM EWD Account Number N information further comprising after said step (a): storing digital data said (a) Confirmed EWD file to help said an AMPA device of user search received withdrawal information from service systems and storing (b) Sent EWD file to remain that an AMPA device of user had sent electrical withdrawal to third service systems.

31. A system and method for defense ID-theft attack security service system in claim 30, wherein said Confirmed EWD file further comprising after said step (a): Storing message said Confirmed EWD message from service system said payer's bank service system.

32. A system and method for defense ID-theft attack security service system in claim 30, wherein said Sent EPC file further comprising after said step (b): Storing said sent Electrical Text said Electrical WithDrawal (EWD) which transmits digital presentation of said an Electrical Text said Electrical WithDrawal (EWD) by said an AMPA device of user to third service systems.

33. A system and method for defense ID-theft attack security service system in claim 29, wherein said Creating Electrical WithDrawal (EWD) further comprising after said step (b): supporting software program to create Electrical Text said Electrical WithDrawal (EWD) steps to generate an Electrical Text said Electrical WithDrawal (EWD) for withdrawing money from account of a withdrawer said an AMPA device of user to a ATM machine said Changing ATM machine which connects with said an AMPA device; wherein creating Electrical Text said Electrical WithDrawal (EWD) steps further comprising: creating digital representations of bank account information embeds in Electrical Text said EWD; creating digital representations of withdrawal date in order to said Digit Number File embeds in Electrical Text said EWD; creating digital representations of said In Withdraw Order in digital image of letter data in order to said Letter Number File embeds in Electrical Text said EWD; creating digital representations of said In Withdraw Order in digital data of image digital data in order to said Digit Number File embeds in Electrical Text said EWD; and creating digital representations signature of withdrawer embeds in Electrical Text said EWD.

34. A system and method for defense ID-theft attack security service system in claim 13, wherein said Personal Bank Account File further comprising after said step ( ): storing (a) digital representation of Bank Account Information is provided by at least one service system said bank service system said payer's bank service system to an AMPA device of user for payment with account information or withdrawal money from machine said ATM machine said Changing ATM machine; and storing (b) calculating Bank Account Balance accords to said Electrical Payment Check and said Electrical WithDrawal by software process in said an AMPA device.

35. A system and method for defense ID-theft attack security service system in claim 34, wherein said Bank Account Information further comprising after step (a): storing digital representations of account information from at least one service system said bank service system said payer's bank service system; storing at least one digital representations of account number said identity is authenticated by at least one service system said bank service system said payer's bank service system; and storing telephone number of payer's bank service for communication by telephone; and storing said website address of payer's bank service to search more information said payer's bank information online; and choosing one of account information to payment or withdrawal is made by portable device of user said an AMPA device of user.

36. A system and method for defense ID-theft attack security service system in claim 34, wherein said Bank Account Balance further comprising after said step (b): storing bank account balance information which is calculated by software of an AMPA device in order to digital data in electrical files said EPC credit card identity number N information and ATM EWD Account Number N information.

37. A system and method for defense ID-theft attack security service system in claim 10, wherein said CUP control digital data processing further comprising after said step (a): allowing said received message via said wireless interface stores at least one electrical file in said memory; allowing to selectively accessing at least one electrical file in said memory with said a stylus on said touch screen; allowing said at least one electrical file in said memory can send out via said wireless interface to at least one service system; allowing said electrical file move up, down, left, and right by said array keyboard; allowing said at least one electrical file accesses to next electrical file in memory by next key; allowing said at least one electrical file accesses to back previously electrical file in memory by back key; allowing said digital data of at least one electrical file embedding in correspond electrical file in memory by enter key; allowing said at least one electrical file information is deleted from memory by delete key; allowing said at least one electrical file information is stored in memory by save key; allowing said at least one electrical file information is sent to a host said computer of service system by send key; and allowing said at least one electrical file information is delete in memory by cancel key.

38. A system and method for defense ID-theft attack security service system that application credit card identity said credit card information from at least one service said the bank service said payee's bank service which is authenticity of the credit card information is made by applier said a portable device of user said an AMPA device of user over wireless network and comprising: initial application credit card identity processing, an AMPA device of user offers plural verification information said personal information to at least one service said bank service said payee's bank service by telephone or sending letter; wherein payee's bank service utilizes at least one service system said payee's bank service system to transmit application information said personal information of applier said an AMPA device of user to at least one service system said security service system; wherein security service system further comprising: utilizing a determination device as part of service system of said security service system to identify whether application information is valid according to database said system database said AMPA identity database of service system said security service system; issuing identification information; and transmitting identification information to third service system said bank service system said payee's bank service system; wherein said payee's bank service system based on derived information said identification information to reflect operation; wherein said identification information further comprising: (a) said valid application information; and (b) said invalid application information.

39. A system and method for defense ID-theft attack security service system in claim 38, wherein at said payee's bank service system reflects operation comprising after step (a): providing bank information said payee's bank information in addition to unique credit card identity to applier said an AMPA device of user over wireless network.

40. A system and method for defense ID-theft attack security service system in claim 39, wherein said an AMPA device of user further comprising: receiving message said payee's bank information; and saving payee's bank information in electrical file said Credit Card Identity File in memory of said an AMPA device of user.

41. A system and method for defense ID-theft attack security service system in claim 38, wherein said payee's bank service system reflects operation comprising after step (b): transmitting refusing application information to applier said an AMPA device of user over wireless network.

42. A system and method for defense ID-theft attack security service system in claim 41, wherein said an AMPA device of user further comprising: receiving message with refusing application information; and going to service said register AMPA device service for solution problem.

43. A system and method for defense ID-theft attack security service system that application bank account identity said bank account information from at least one service said the bank service said payer's bank service which is authenticity of the bank account information is made by applier said a portable device of user said an AMPA device of user with over wired communication and comprising: initial application bank account identity processing, applier said an AMPA device of user utilizes an embodiment device said host interface of said AMPA device to connect with an embodiment device said host interface of computer of said a service system said bank service system said payer's bank service system with said an cable said wired communication; and offers plural verification information said personal information to at least one service system said bank service system said payer's bank service system via said wired communication; wherein said payer's bank service system further comprising: utilizing at least one service system said bank service system said payer's bank service system; transmitting application information said personal information of applier said an AMPA device of user to at least one service system said security service system.

44. A system and method for defense ID-theft attack security service system in claim 43, wherein said security service system further comprising: utilizing a determination device as part of service system to identify whether application information is valid; issuing identification information; and transmitting identification information to at least one service system said bank service system said payer's bank service system; wherein said payer's bank service system based on derived information said identification information to reflect operation; wherein said identification information comprising: (a) said valid application information; and (b) said invalid application information.

45. A system and method for defense ID-theft attack security service system in claim 44, wherein said security service system further comprising after step (a): transmitting message with valid application information to service system said bank service system said payer's bank service system over wired network.

46. A system and method for defense ID-theft attack security service system in claim 45, wherein said payer's bank service system comprising: providing bank information said payer's bank information in addition to unique account number to applier said an AMPA device of user over said wired communication.

47. A system and method for defense ID-theft attack security service system in claim 46, wherein said an AMPA device of user comprising: receiving message with payer's bank information; and saving payer's bank information in electrical file said Personal Bank Account File in memory of said an AMPA device of user.

48. A system and method for defense ID-theft attack security service system in claim 44, wherein said security service system further comprising after step (b): transmitting message with invalid application information to service system said bank service system said payer's bank service system over wired network.

49. A system and method for defense ID-theft attack security service system in claim 48, wherein said payer's bank service system comprising: transmitting refusing application information to applier said an AMPA device of user over said wired communication.

50. A system and method for defense ID-theft attack security service system in claim 49, wherein said an AMPA device of user further comprising: receiving refusing application information; and going to service said register AMPA device service for solution problem.

51. A system and method for defense ID-theft attack security service system for purchasing of goods or services at shop mall or at Gas Station; purchasing goods or service is made by at least one customer said AMPA device of user using at least one merchant; said merchant utilizes at least one computer or machine to offer goods or service over wired communication at shop mall, shop, or at Gas Station; said computer or machine at shop mall or Gas Station is controlled by at least one service system said business service system; said an embodiment device said host interface in computer or machine and comprising: initial purchasing goods or service process, customer said an AMPA device of user utilizes an embedment device said host interface connect with another embodiment of device said host interface of computer or machine of service system said business service system via cable said wired communication; transmitting message said credit card information to computer of service system said business service system over wired communication.

52. A system and method for defense ID-theft attack security service system in claim 51, wherein said business service system further comprising: receiving message said credit card information from said an AMPA device of user via cable said wired communication during transaction session; and transmitting message said credit card information of said an AMPA device of user to service system said bank service system said payee's bank service system.

53. A system and method for defense ID-theft attack security service system in claim 52, wherein said payee's bank service system further comprising: utilizing a determination device as part of service system said payee's bank service system to receive message said credit card information of customers said AMPA device of users from service system said business service system; utilizing a determination device as part of service system said payee's bank service system to identify whether credit card information is valid according to data in database said system database said credit card database of service system said bank service system said payee's bank service system; issuing identification information; and transmitting identification information to host said computer or machine of service system said business service system; wherein said business service system based one derived information said identification information to reflect operation; wherein identification information comprising: (a) said valid credit card information; and (b) invalid credit card information.

54. A system and method for defense ID-theft attack security service system in claim 53, wherein said payee's bank service system further comprising after step (a): transmitting message said identification information said valid credit card information to service system said business service system over said wired network.

55. A system and method for defense ID-theft attack security service system in claim 54, wherein said business service system further comprising: receiving message said identification information said valid credit card information from service system said bank service system said payee's bank service system over wired network; allowing said an AMPA device of user with credit card information to purchase goods or service; and calculating receipt data of customer said an AMPA device of user; saving receipt data in receipt database of service system said business service system; and transmitting message with receipt data of customer said an AMPA device to service system said bank service system said payee's bank service system over wired network.

56. A system and method for defense ID-theft attack security service system in claim 55, wherein said payee's bank service system father comprising: receiving receipt message from said business service system over wired network; and saving receipt data in receipt database of service system said payee's bank service system; and re-transmitting message with receipt data to said an AMPA device of user over wireless network.

57. A system and method for defense ID-theft attack security service system in claim 56, wherein said an AMPA device of user further comprising: receiving message said receipt information said receipt data from service system said bank service system said payee's bank service system; saving receipt data in Receipt File; and respond receipt message with answer said respond type to third service system.

58. A system and method for defense ID-theft attack security service system in claim 53, wherein said payee's bank service system further comprising after step (b): transmitting message said identification information said invalid credit card information to service system said business service system over wired network.

59. A system and method for defense ID-theft attack security service system in claim 58, wherein said business service system further comprising: receiving message said identification information said invalid credit card information from service system said bank service system said payee's bank service system over wired network; and refusing offering goods or service to said an AMPA device of user.

60. A system and method for defense ID-theft attack security service system in claim 59, wherein said an AMPA device of user further comprising: transmitting another credit card information for purchasing goods or service to service system said business service system over said wired communication until service system said bank service system said payee's bank service refusing finally.

61. A system and method for defense ID-theft attack security service system for purchasing of goods or service over the internet or by telephone; purchasing goods or service is made by said an AMPA device of user using merchant; said merchant offering goods or service over internet or by telephone; at least one computer is provided by at least one service system said business service system to merchant; and comprising: initial purchasing goods or service processing; customer said AMPA device of user provides personal information with credit card information online or by telephone to order goods or service from at least one service system said business service system; wherein said business service system transmits receipt information appending identity said credit card information and personal information to service system said bank service system said payee's bank service system.

62. A system and method for defense ID-theft attack security service system in claim 61, wherein said payee's bank service system further comprising: utilizing a determination device as part of service system said bank service system said payee's bank service system to identify whether receipt information is valid according to credit card information in credit card database and personal information in personal information database in service system database said payee's bank service system database; issuing identification information; based on identification information to reflect operation; wherein identification information comprising: (a) valid receipt; and (b) invalid receipt.

63. A system and method for defense ID-theft attack security service system in claim 62, wherein said payee's bank service system further comprising after step (a): transmitting message with valid receipt data to customer said an AMPA device of user over wireless network.

64. A system and method for defense ID-theft attack security service system in claim 63, wherein said an AMPA device of user further comprising: receiving message said receipt information said valid receipt data; saving message said valid receipt data in Receipt File; and responding message with answering said respond type to third service system.

65. A system and method for defense ID-theft attack security service system in claim 62, wherein said payee's bank service system further comprising after step (b): (a) responding message appending to said invalid receipt data to service system said business service system over wired network and (b) transmitting message appending to said invalid receipt to customer said an AMPA device of user over wireless network.

66. A system and method for defense ID-theft attack security service system in claim 65, wherein (a) said business service system further comprising: deleting receipt data in system database of service system said business service system; and canceling purchasing transaction with said an AMPA device of user.

67. A system and method for defense ID-theft attack security service system in claim 65, wherein (b) said an AMPA device of user further comprising: purchasing goods or service with merchant online or by telephone again or canceling purchasing goods or service.

68. A system and method for defense ID-theft attack security service system for receiving message said receipt data from service system said bank service system said payee's bank service system and responding message are made by of an AMPA device of user and comprising: receiving receipt information from service system said bank service system said payee's bank service system to verify whether said receipt information is valid according to purchases transaction events; and issuing identification information; based on identification information to issue respond type; based on respond type to responding receipt information to third service system; wherein purchase transaction events further comprising: (a) really purchase goods or service events; (b) returns purchasing goods or service to merchant events; and (c) without customer said an AMPA device knowledge to purchase goods or service events.

69. A system and method for defense ID-theft attack security service system in claim 68, wherein said identification information further comprising after step (a): said valid receipt.

70. A system and method for defense ID-theft attack security service system in claim 68, wherein said identification information further comprising after step (b): said invalid receipt.

71. A system and method for defense ID-theft attack security service system in claim 68, wherein said identification information further comprising after step (c): said invalid receipt.

72. A system and method for defense ID-theft attack security service system in claim 69, wherein said valid receipt further comprising: being accepted to confirmed receipt data.

73. A system and method for defense ID-theft attack security service system in claim 70, wherein said invalid receipt further comprising: being admitted to cancelled receipt data.

74. A system and method for defense ID-theft attack security service system in claim 71, wherein said invalid receipt further comprising: being admitted to denied receipt data.

75. A system and method for defense ID-theft attack security service system in claim 72, wherein said confirmed receipt data further comprising: responding message with said respond type said confirmed receipt data is transmitted from said an AMPA device of user to third service system.

76. A system and method for defense ID-theft attack security service system in claim 75, wherein said third service system further comprising: (a) said bank service system said payee's bank service system and (b) said security service system.

77. A system and method for defense ID-theft attack security service system in claim 76, wherein (a) said payee's bank service system further comprising: receiving responding message said confirmed receipt information from said an AMPA device of user instead of stored receipt data in system database said receipt database of service system said payee's bank service system; and transmitting said receipt data in receipt database of service system said payee's bank service system to service system said insures service system.

78. A system and method for defense ID-theft attack security service system in claim 77, wherein said insures service system further comprising: receiving receipt information said confirmed receipt information from service system said bank service system said payee's bank service system is stored in system database said receipt database said receipt database (A) of said insures service system.

79. A system and method for defense ID-theft attack security service system in claim 76, wherein (b) said security service system further comprising: utilizing a determination device as part of service system said security service system to receive message said confirmed receipt information from said an AMPA device of user; and storing confirmed receipt information in system database said receipt database of service system said security service system; utilizing a determination device as part of service system said security service system to identify whether receipt information said confirmed receipt information is valid according to system database said AMPA device identity database and said signature database in service system said security service system; and issuing identification information; transmitting message to third service system in order to identification information; wherein third service system based on derived information said identification information to reflect operation; wherein identification information further comprising: (a) said valid confirmed receipt; (b) said invalid confirmed receipt; and (c) said resign signature information.

80. A system and method for defense ID-theft attack security service system in claim 79, wherein said security service system further comprising after step (a): transmitting message with said valid confirmed receipt data to third service systems.

81. A system and method for defense ID-theft attack security service system in claim 79, wherein said security service system further comprising after step (b): putting said AMPA device of user's name in black list said black list database of service system said security service system and transmitting alert message with black list in black list database of service system said security service system to third service system.

82. A system and method for defense ID-theft attack security service system in claim 81, wherein said security service system further comprising after step (b): transmitting message with said invalid confirmed receipt data to third service systems.

83. A system and method for defense ID-theft attack security service system in claim 79, wherein said security service system further comprising after step (c): transmitting message said resign receipt information to customer said an AMPA device of user.

84. A system and method for defense ID-theft attack security service system in claim 80, wherein said third service system further comprising: (a) said business service system and (b) said insures service system.

85. A system and method for defense ID-theft attack security service system in claim 84, wherein (a) said businesses service system further comprising: receiving receipt information said valid confirmed receipt from service system said security service system; and storing valid confirmed receipt data in system database said receipt database of service system said businesses service system.

86. A system and method for defense ID-theft attack security service system in claim 84, wherein (b) said insures service system further comprising: receiving receipt data said confirmed receipt data from service system said security service system; utilizing a determination device as part of service system said insures service system to identify whether stored receipt data in said receipt database said receipt database (A) is valid according to receive data said confirmed receipt information from said service system said security service system; issuing identification information; and based on identification information to reflect operation; wherein identification information comprising: (a) said valid receipt data; and (b) said invalid receipt data.

87. A system and method for defense ID-theft attack security service system in claim 86, wherein said insures service system further comprising after step (a): storing valid receipt data said receipt data in receipt database said receipt database (B) of service system said insures service system.

88. A system and method for defense ID-theft attack security service system in claim 86, wherein said insures service system further comprising after step (b): transmitting complain message with invalid receipt data to service system said security service system.

89. A system and method for defense ID-theft attack security service system in claim 82, wherein said third service system further comprising: (a) said payee's bank service system; (b) said business service system service system; and (c) said an AMPA device of user.

90. A system and method for defense ID-theft attack security service system in claim 89, wherein (a) said payee's bank service system further comprising: receiving message said invalid confirmed receipt from service system said security service system; and deleting receipt data from system database said receipt database of service system said payee's bank service system.

91. A system and method for defense ID-theft attack security service system in claim 89, wherein (b) said business service system further comprising: receiving message said invalid confirmed receipt from service system said security service system; and deleting receipt data from system database said receipt database of service system said business service system.

92. A system and method for defense ID-theft attack security service system in claim 89, wherein (c) said an AMPA device of user further comprising: receiving message said invalid confirmed receipt from service system said security service system; and going to said service said register AMPA device service for solution problem.

93. A system and method for defense ID-theft attack security service system in claim 83, wherein said an AMPA device of user further comprising: receiving message said resign receipt from service system said security service system and re-transmitting confirmed receipt data with resign signature to third service system.

94. A system and method for defense ID-theft attack security service system in claim 73, wherein said cancelled receipt information further comprising: responding receipt information said cancelled receipt information is transmitting by said an AMPA device of user to third service system said payee's bank service system;

95. A system and method for defense ID-theft attack security service system in claim 74, wherein said denied receipt information further comprising: responding receipt information said denied receipt information is transmitting by said an AMPA device of user to third service system said payee's bank service system.

96. A system and method for defense ID-theft attack security service system for receiving invalid receipt information from said at least one MPA device of user are made by at least one service system said bank service system said payee's bank service system comprising: receiving invalid receipt information from said an AMPA device of user; and deleting data said receipt data in system database said receipt database of service system said payee's banks service system; and transmitting invalid receipt information to service system said business service system.

97. A system and method for defense ID-theft attack security service system in claim 96, wherein said business service system further comprising: receiving invalid receipt information from service system said banks service system said payee's bank service system; utilizing a determination device as part of service system said business service system to verify whether invalid receipt information is valid according to data said receipt data in system database said receipt database of service system said business service system; issuing identification information; and based on identification information to reflect operation; wherein identification information further comprising: (a) said true invalid receipt information; and (b) said false invalid receipt information;

98. A system and method for defense ID-theft attack security service system in claim 97, wherein said business service system further comprising after step (a): deleting data said receipt data from system database said receipt database of service system said business service system;

99. A system and method for defense ID-theft attack security service system in claim 97, wherein said business service system further comprising after step (b): transmitting messages said complain message with evidence about receipt information said receipt data in system database said receipt database of service system said business service system to service system said security service system.

100. A system and method for defense ID-theft attack security service system for dealing with no respond information from said an AMPA device of user; initial at least one service system said bank service system said payee's bank service system transmits receipt data to customer said an AMPA device of user and comprising: transmitting receipt data with time T and waiting for respond information from said an AMPA device of user according to T be less than maximum T with no respond information; transmitting receipt data to service system said security service system according to T be less then maximum T with no respond information.

101. A system and method for defense ID-theft attack security service system in claim 100, wherein said security service system comprising: transmitting receipt data with time T and wait for respond information from said an AMPA device of user according to T be less than maximum T with no respond information; putting said an AMPA device of user's name in black list said black list database according to T be great then maximum T with no respond information; and transmitting alert message appending to black list to third service system according T be great then maximum T with no respond information.

102. A system and method for defense ID-theft attack security service system for purchasing of goods or service with credit card identity and assuring payment to bank said payee's bank is made by a customer said an AMPA device of user; said credit card information is provided by service system said bank service system said payee's bank service system and comprising: transmitting said statement in addition to said total current charge to at least one customer said AMPA device over wireless network; wherein said an AMPA device of user further comprising: receiving said statement from service system said bank service system said payee's bank service system to verify whether total current charge is valid according to stored said total current charge information in electrical file said Total Charge File; issuing identification information; and based on derived identification information to reflect operation; wherein said identification information comprising: (a) said valid statement; and (b) said invalid statement.

103. A system and method for defense ID-theft attack security service system in claim 102, wherein said an AMPA device of user further comprising after step (a): transmitting message appending to digital image data said Electrical Text said Electrical Payment Check to third service systems.

104. A system and method for defense ID-theft attack security service system in claim 102, wherein said an AMPA device of user further comprising after step (b): transmitting a message said complain message with invalid statement to third service system said security service system.

105. A system and method for defense ID-theft attack security service system in claim 103, wherein third service systems further comprising: (a) said payer's bank service system; (b) said payee's bank service system and (b) said security service system.

106. A system and method for defense ID-theft attack security service system in claim 105, wherein (a) said payer's bank service system further comprising: receiving digital image data said Electrical Text said Electrical Payment Check from said an AMPA device of user; and storing digital image data said Electrical Text said Electrical Payment Check in system database said payment database said payment database (A) of service system said bank service system said payer's bank service system.

107. A system and method for defense ID-theft attack security service system in claim 105, wherein (b) said payee's bank service system further comprising: receiving digital image data said Electrical Text said Electrical Payment Check from said an AMPA device of user; and storing digital image data said Electrical Text said Electrical Payment Check in system database said payment database of service system said bank service system said payee's bank service system; and retransmitting digital image data said Electrical Text said Electrical Payment Check of said an AMPA device of user to service system said bank service system said payer's bank service system for deposit funds.

108. A system and method for defense ID-theft attack security service system in claim 107, wherein said payer's bank service system further comprising: receiving digital image data said Electrical Text said Electrical Payment Check from service system said payee's bank service system; and storing in system database said payment database said payment database (B) of service system said bank service system said payer's bank service system;

109. A system and method for defense ID-theft attack security service system in claim 105, wherein (c) said security service system comprising: utilizing a determination device as a part of service system said security service system to receive digital image data said Electrical Text said Electrical Payment Check from said an AMPA device of user; utilizing a determination device as a part of service system said security service system to identify whether digital image data said Electrical Text said Electrical Payment Check is valid; issuing identification information; and transmitting message to third service systems in order to identification information; Wherein third service systems based on the empirically derived information said message from service system said security service system to reflect operation; wherein identification information comprising: (a) said valid digital image data said Electrical Text said Electrical Payment Check; (b) said invalid digital image data said Electrical Text said Electrical Payment Check; and (c) said resign signature in digital image data said Electrical Text said Electrical Payment Check.

110. A system and method for defense ID-theft attack security service system in claim 109, wherein said security service system further comprising after step (a): transmitting message with said valid said Electrical Payment Check to service system said bank service system said payer's bank service system.

111. A system and method for defense ID-theft attack security service system in claim 109, wherein said security service system further comprising after step (b): transmitting message with invalid Electrical Payment Check to third service system.

112. A system and method for defense ID-theft attack security service system in claim 109, wherein said security service system further comprising after step (c): transmitting resign signature in said Electrical Text said Electrical Payment Check to customer said an AMPA device of user.

113. A system and method for defense ID-theft attack security service system in claim 110, wherein said payer's bank service system further comprising: utilizing a determination device as part of service system said bank service system said payer's bank service system to receive digital image data said Electrical Payment Check (EPC) information from service systems said security service system; storing digital image data said Electrical Payment Check (EPC) information from service systems said security service system in system database said payment database said payment database (C); and a determination device as part of service system said bank service system said payer's bank service system compares stored digital image data said Electrical Text said Electrical Payment Check(EPC) in system database said payment database said payment database(A) with Electrical Payment Check(EPC) in said payment database(B) and Electrical Payment Check(EPC) in said payment database(C); issuing identification information; based on derived identification information to reflect operation; wherein said identification information further comprising: (a) valid Electrical Payment Check(EPC); and (b) invalid Electrical Payment Check(EPC).

114. A system and method for defense ID-theft attack security service system in claim 113, wherein said payer's bank service system further comprising after step (a): transferring funds from personal bank account of customer said an AMPA device of user to account of bank said payee's bank.

115. A system and method for defense ID-theft attack security service system in claim 113, wherein said payer's bank said payer's bank service system further comprising after step (b): transmitting complain message with invalid Electrical Payment Check (EPC) to third service system said security service system.

116. A system and method for defense ID-theft attack security service system in claim 111, wherein third service system further comprising: (a) said payer's bank service system; (b) said payee's bank service system; and (c) said an AMPA device of user.

117. A system and method for defense ID-theft attack security service system in claim 116, wherein said payer's bank service system further comprising: receiving invalid digital image data said Electrical Text said Electrical Payment Check from service system said security service system; and deleting digital image data said Electrical Text said Electrical Payment Check in system database said payment database (A), and said payment database (B) of service system said bank service system said payer's bank service system.

118. A system and method for defense ID-theft attack security service system in claim 116, wherein (b) said payee's bank service system further comprising: receiving invalid Electrical Text said Electrical Payment Check from service system said security service system; and deleting digital image data said Electrical Text said Electrical Payment Check in system database said payment database of service system said payee's bank service system.

119. A system and method for defense ID-theft attack security service system in claim 116, wherein (c) said an AMPA device of user further comprising: receiving invalid Electrical Text said Electrical Payment Check from service system said security service system; and deleting sent Electrical Payment Check in Sent EPC file in memory of said AMPA device; and going to service said register an AMPA device service for solution problem.

120. A system and method for defense ID-theft attack security service system in claim 112, wherein said an AMPA device of user further comprising: receiving invalid Electrical Text said Electrical Payment Check from service system said security service system; resigning signature in digital image data said Electrical Text said Electrical Payment Check; and retransmitting digital image data said Electrical Text said Electrical Payment Check to third service system again.

121. A system and method for defense ID-theft attack security service system for providing credit cards to customers said AMPA device of users for purchasing goods or service are made by at least one service system said bank service system said payee's bank service system; for providing portable device to customers said AMPA device of users for purchasing goods or service are made by at least one service system said insures service system; for utilizing system said service system said business service system to offer goods or service are made by merchant; at least one bank service system said payee's bank service system ensures payment check to at least one service system said insures service system according to receipt data in service system database said receipt database of service system said bank service system said payee's bank service system and comprising: utilizing a acquisition device as part of service system said bank service system said payee's bank service system to acquire payment to sum receipt data according to receipt data in system database said receipt database of service system said bank service system said payee's bank service system for each customer said AMPA device of user each month; acquiring payment data are stored in system database said payment database of service system said bank service system said payee's bank service system; transmitting payment check to at least one service system said insures service system according to system database said payment database of service system said bank service system said payee's bank service system.

122. A system and method for defense ID-theft attack security service system in claim 121, wherein said insures service system further comprising: utilizing a determination device as part of service system said insures service system to receive payment check from service system said bank service system said payee's bank service system; and utilizing a determination device as part of service system said insures service system to audit whether payment check is valid according to receipt data in system database said receipt database of service system said insures service system; and issuing identification information; based one derived identification information to reflect operation; wherein identification information further comprising: (a) said valid payment; and (b) invalid payment.

123. A system and method for defense ID-theft attack security service system in claim 122, wherein said insures service system further comprising after step (a): storing payment check in system database said payment database of service system said insures service system.

124. A system and method for defense ID-theft attack security service system in claim 122, wherein said insures service system further comprising after step (b): transmitting complain message with invalid payment to third service system said security service system.

125. A system and method for defense ID-theft attack security service system for providing at least one portable device said AMPA device with unique device identity said AMAP identity to customer said AMPA device for purchasing goods or service with said merchant are made by at least one service system said insures service system; said merchants utilize business service system to offer goods or service to customers said AMPA device of users; said insurants charge service fee from merchants and assures payment to merchant according to receipt data of customer said an AMAP device of user in service system database said receipt database of service system said insures service system and comprising: utilizing a acquisition device as part of service system said insures service system to acquire payment data to subtract service fee from receipt data of each customer said AMPA device of user according to system database said receipt database of service system said insures service system; acquiring payment data is stored in system database said payment database of service system said insures service system; transmitting payment check to service system said business service system according to payment data in system database said payment database of service system said insures service system.

126. A system and method for defense ID-theft attack security service system in claim 125, wherein said business service system further comprising: utilizing a determination device as part of service system said business service system to receive payment check from service system said insures service system; and utilizing a determination device as part of service system said business service system to audit whether payment is valid according to receipt data in system database said receipt database of service system said business service system; and issuing identification information; based on derived identification information to reflect operation; wherein identification information further comprising: (a) said valid payment; and (b) invalid payment.

127. A system and method for defense ID-theft attack security service system in claim 126, wherein said business service system further comprising after step (a): storing payment check in system database said payment database of service system said business service system.

128. A system and method for defense ID-theft attack security service system in claim 126, wherein said business service system further comprising after step (b): transmitting complain message with invalid payment to third service system said security service system.

129. A system and method for defense ID-theft attack security service system in claim 104, wherein said security service system further comprising: receiving message said complain message with said invalid statement from said at least one AMPA device of user; a determination device as part of service system said security service system identifies whether complain message is valid according to system database said receipt database of service system said security service system; issuing identification information; transmitting message to third service system according to identification information; wherein third service system based on derived message of service system said security service system to reflect operation; wherein identification information comprising: (a) said valid complain message; and (b) invalid complain message.

130. A system and method for defense ID-theft attack security service system in claim 129, wherein said security service system further comprising after step (a): transmitting message said valid complain message to third service system said bank service system said payee's bank service system.

131. A system and method for defense ID-theft attack security service system in claim 130, wherein said payee's bank service system further comprising: receiving message said valid complain message from service system said security service system; recalculating total current charge fee; and retransmitting statement to customer said an AMPA device of user.

132. A system and method for defense ID-theft attack security service system in claim 129, wherein said security service system further comprising after step (b): transmitting message said invalid complain message to customer said an AMPA device of user.

133. A system and method for defense ID-theft attack security service system in claim 132, wherein said an AMPA device of user further comprising: receiving message said invalid complain message from service system said security service system; creating digital image data said Electrical Text said Electrical Payment Check; and transmitting digital image data said Electrical Text said Electrical Payment Check for payment to third service system.

134. A system and method for defense ID-theft attack security service system in claim 88, wherein said security service system further comprising: receiving message said complain message with said invalid receipt data from service system said insures service system; a determination device as part of service system said security service system identifies whether complain message is valid according to receipt data in system database said receipt database of service system said security service system; issuing identification information; transmitting message to third service system according to identification information; wherein third service system based on derived message of service system said security service system to reflect operation; wherein identification information comprising: (a) said valid complain message; and (b) invalid complain message.

135. A system and method for defense ID-theft attack security service system in claim 134, wherein said security service system further comprising after step (a): transmitting message said valid complain message with receipt data to third service system said bank service system said payee's bank service system.

136. A system and method for defense ID-theft attack security service system in claim 135, wherein said payee's bank service system further comprising: receiving message said valid complain message with receipt data from security service system; storing receipt data in system database said receipt database instead of stored receipt data in receipt database of services system said payee's bank service system; retransmitting receipt data to service system said insures service system.

137. A system and method for defense ID-theft attack security service system in claim 134, wherein said security service system further comprising after step (b): transmitting message said invalid complain message with receipt data to third service system said insures service system and said business service system.

138. A system and method for defense ID-theft attack security service system in claim 137, wherein said insures service system further comprising: receiving message said invalid complain message with receipt data from security service system; utilizing a determination device as part of service system said insures service system to recompare receipt data from service system with receipt data from service system said payee's bank service system.

139. A system and method for defense ID-theft attack security service system in claim 137, wherein said business service system further comprising: storing receiving message said receipt data from service system instead of stored receipt data in system database said receipt database of said service system said business service system.

140. A system and method for defense ID-theft attack security service system in claim 124, wherein said security service system further comprising: receiving message said complain message with said invalid payment from service system said insures service system; a acquisition device as part of service system said security service system acquires payment to sum receipt data according to system database said receipt database; and storing acquires payment data in system database said payment database; a determination device as part of service system said security service system identifies whether complain message said invalid payment is valid according to system database said payment database solution problem during payment process between insurant and the bank said payee's bank; issuing identification information; transmitting message to third service system according to identification information; wherein third service system based on derived message of service system said security service system to reflect operation; wherein identification information comprising: (a) said valid complain message; (b) invalid complain message.

141. A system and method for defense ID-theft attack security service system in claim 140, wherein said security service system further comprising after step (a): transmitting message said valid complain message with payment data to third service system said payee's service system.

142. A system and method for defense ID-theft attack security service system in claim 141, wherein said payee's service system further comprising: receiving message said valid complain message with payment data from security service system; recalculating payment data; and retransmitting payment check to third service system said insures service system.

143. A system and method for defense ID-theft attack security service system in claim 140, wherein said security service system further comprising after step (b): transmitting message said invalid complain message with payment data to third service system said insures service system.

144. A system and method for defense ID-theft attack security service system in claim 143, wherein said insures service system further comprising: receiving message said invalid complain message with payment data from security service system; and storing payment data in service system database said payment database of service system said insures service system.

145. A system and method for defense ID-theft attack security service system in claim 99, wherein said security service system further comprising: receiving message said complain message said invalid denied or cancelled receipt data with evidence information from business service system investigating evidence information; identifying whether complain message is valid according to evidence information during transaction process; issuing identification information; transmitting message to third service system according to identification information; wherein third service system based on derived message of service system said security service system to reflect operation; wherein identification information comprising: (a) said valid complain message; and (b) invalid complain message.

146. A system and method for defense ID-theft attack security service system in claim 145, wherein said security service system further comprising after step (a): putting said customer said an AMPA device of user's name in black list database; and transmitting message said alert message appending to black list to third service system.

147. A system and method for defense ID-theft attack security service system in claim 145, wherein said security service system further comprising after step (b): transmitting message said invalid complain message with denied data or cancelled data to third service system said business service system.

148. A system and method for defense ID-theft attack security service system in claim 147, wherein business service system further comprising: receiving message said invalid complain message said valid denied or valid cancelled receipt data from service system said security service system; and deleting receipt data in system database said receipt database of service system business service system.

149. A system and method for defense ID-theft attack security service system in claim 128, wherein said security service system further comprising: receiving message said complain message with said invalid payment from service system said business service system; a acquisition device as part of service system said security service system acquires payment to sum receipt data according to system database said receipt database; storing acquires payment data in system database said payment database; a determination device as part of service system said security service system identifies whether complain message is valid according to system database said payment database during payment process between insurant and merchant; issuing identification information; transmitting message to third service system according to identification information; wherein third service system based on derived message of service system said security service system to reflect operation; wherein identification information comprising: (a) said valid complain message; and (b) invalid complain message.

150. A system and method for defense ID-theft attack security service system in claim 149, wherein said security service system further comprising after step (a): transmitting message said valid complain message with payment data to third service system said insures service system.

151. A system and method for defense ID-theft attack security service system in claim 150, wherein said insures service system further comprising: receiving message said valid complain message with payment data from said security service system; and storing payment data to instead of stored payment data in system database said payment database of service system said insures service system; and retransmitting payment check to third service system said business service system.

152. A system and method for defense ID-theft attack security service system in claim 149, wherein said security service system further comprising after step (b): transmitting message said invalid complain message with payment data to third service system said business service system

153. A system and method for defense ID-theft attack security service system in claim 152, wherein said business service system further comprising: receiving message said invalid complain message with payment data from service system said security service system; and storing payment data in system database said payment database of service system said business service system.

154. A system and method for defense ID-theft attack security service system for dealing with black list in system database said black list database is made by service system said security service system and comprising: reducing credits degree of an AMPA device of user according to system database said black list database; transmitting a message said alert message appending said black list according to system database said black list database to third service system; wherein third service system based on derived alert message to reflect operation.

155. A system and method for defense ID-theft attack security service system in claim 154, wherein third service system further comprising: (a) said at least one bank service system said payee's bank service system; (b) said at least one bank service system said payer's bank service system; and (c) said at least one insures service system and (d) said at least one AMPA device of user who is name in black list.

156. A system and method for defense ID-theft attack security service system in claim 155, wherein (a) said payee's bank service system further comprising: receiving alert message with back list from service system said security service system; deleting credit card information of an AMPA device of user from system database said credit card database according to name in black list; release the credit card identity of an AMPA device of user according to name in black list.

157. A system and method for defense ID-theft attack security service system in claim 155, wherein (b) said payer's bank service system further comprising: receiving alert message with back list from service system said security service system; suspending payment check of an AMPA device of user according to name in black list; suspending withdrawal check of an AMPA device of user according to name in black list.

158. A system and method for defense ID-theft attack security service system in claim 155, wherein (c) said insures service system further comprising: receiving alert message with back list from service system said security service system; deleting AMPA identity of an AMPA device of user from system database said AMPA identity database according to name in black list; release the AMPA identity of an AMPA device of user according to name in black list.

159. A system and method for defense ID-theft attack security service system in claim 155, wherein (d) said an AMPA device of user further comprising: receiving alert message with back list from service system said security service system; and going to service said register AMPA device service for solution problem.

160. A system and method for defense ID-theft attack security service system for withdrawal money with personal bank account is made by an AMPA device of user using ATM machine said Changing ATM machine; said Changing ATM machine is provided by bank service system said payer's bank service system and comprising: initiating a withdrawing session with a customer said an AMPA device of user at a ATM machine said Changing ATM machine; wherein said an AMPA device of user further comprising: utilizes an embodiment device said a host interface of an AMPA device to connect with another one host interface of ATM machine said Changing ATM machine via a cable; and utilizing an AMPA device with software processing to create digital image data said Electrical Text said Electrical WithDrawal (EWD); transmitting digital image data said Electrical Text said Electrical WithDrawal (EWD) to service system said bank service system said payer's bank service system via cable said over wired communication; also transmitting digital image data said Electrical Text said Electrical WithDrawal (EWD) to service system said security service system over wireless network; saving digital image data said Electrical Text said Electrical WithDrawal (EWD) in Sent File in memory of portable device said an AMAP device.

161. A system and method for defense ID-theft attack security service system in claim 160, wherein said payer's bank service system further comprising: receiving digital image data said Electrical Text said Electrical WithDrawal (EWD) from a withdrawer said an AMPA device of user at ATM machine said Changing ATM machine over wired communication; and storing digital image data said Electrical Text said Electrical WithDrawal (EWD) in system database said withdrawal database said withdrawal database (A) of service system said bank service system said payer's bank service system.

162. A system and method for defense ID-theft attack security service system in claim 160, wherein said security service system further comprising: utilizing a determination device as part of service system said security service system to receive digital image data said Electrical Text said Electrical WithDrawal (EWD) from a withdrawer said an AMPA device of user over wireless network; and utilizing a determination device as part of service system said security service system to identify whether EWD is valid according to digital data in service system database said AMPA identity database and said signature identity database of service system said security service system; issuing identity information; based on identity information to transmit message to third service system; wherein third service system based on derived identity information said message from security service system to reflect operation; wherein issuing identity information further comprising: (a) valid EWD; (b) invalid EWD; and (c) resign signature in EWD.

163. A system and method for defense ID-theft attack security service system in claim 162, wherein said security service system further comprising after step (a): transmitting message with valid EWD to third service system said bank service system said payer's bank service system over wired network.

164. A system and method for defense ID-theft attack security service system in claim 163, wherein said payer's bank service system further comprising: utilizing a determination device as a part of service system said bank service system said payer's bank service system to receive message said valid EWD from security service system; and storing digital image data said Electrical Text said Electrical WithDrawal (EWD) in system database said withdrawal database said withdrawal database (B) of service system said bank service system said payer's bank service system; utilizing a determination device as a part of service system said bank service system said payer's bank service system to compare digital image data said Electrical Text said Electrical WithDrawal (EWD) in system database said withdrawal database said withdrawal database (A) and said withdrawal database (B) of service system said bank service system said payer's bank service system; issuing identity information; based on identity information to reflect operation; wherein issuing identity information further comprising: (a) valid EWD; and (b) invalid EWD.

165. A system and method for defense ID-theft attack security service system in claim 164, wherein said payer's bank service system further comprising after step (a): withdrawing money from bank account of withdrawer said an AMPA device of user to ATM machine said Changing ATM machine; and transmitting message said receipt data with EWD informant to withdrawer said an AMPA device of user over wired communication.

166. A system and method for defense ID-theft attack security service system in claim 165, wherein said an AMPA device of user further comprising: taking money from an embodiment device said output of ATM machine said Changing ATM machine; receiving message said receipt data with EWD; and utilizing a determination device as part of an said AMPA device to identify whether EWD is valid according to Sent EWD File in memory of said an AMPA device of user; issuing identify information; based on identify information to reflection operation.

167. A system and method for defense ID-theft attack security service system in claim 164, wherein said payer's bank service system further comprising after step (b): transmitting (a) message appending invalid EWD to service system said security service system over wired network; and transmitting (b) message appending invalid EWD to withdrawer said an AMPA device of user over wired communication.

168. A system and method for defense ID-theft attack security service system in claim 167, wherein (a) said security service system further comprising: receiving massage said invalid EWD from service system said bank service system said payer's bank service system over wired network; and deleting withdrawal data in system database said withdrawal database of service system said security service system.

169. A system and method for defense ID-theft attack security service system in claim 167, wherein (b) said an AMPA device of user further comprising: receiving massage said invalid EWD from service system said bank service system said payer's bank service system over wired communication; deleting EWD data in Sent EWD File in memory of an AMPA device of user; and recreates digital image data said Electrical Text said EWD using software with an AMPA device of user; retransmitting digital image data said Electrical Text said EWD to third service system.

170. A system and method for defense ID-theft attack security service system in claim 162, wherein said security service system further comprising after step (b): putting customer said an AMPA device of user's name in system database said black list database of service system said security service system; and transmitting a alert message appending to black list to third service system.

171. A system and method for defense ID-theft attack security service system in claim 162, wherein said security service system further comprising after step (c): transmitting message with resign signature information to a withdrawer said an AMPA of user over wireless network.

172. A system and method for defense ID-theft attack security service system in claim 171, wherein an AMPA device of user further comprising: resigns signature in digital image data said Electrical Text said EWD and retransmits to bank service system said payer's bank service system and security service system.

173. A system and method for defense ID-theft attack security service system for receiving message said receipt data said withdrawal data from service system said bank service system said payer's bank service system and responding message are made by of an AMPA device of user and comprising: receiving receipt information said withdrawal information from service system said bank service system said payer's bank service system to verify whether said receipt information said withdrawal information is valid according to withdrawal events; and issuing identification information; according to identification information to issue respond type; based on respond type to responding receipt information to third service system; wherein withdrawal events further comprising: (a) really withdrawal events; and (b) without customer said an AMPA device knowledge events.

174. A system and method for defense ID-theft attack security service system in claim 173, wherein said identification information further comprising after step (a): said valid withdrawal.

175. A system and method for defense ID-theft attack security service system in claim 173, wherein said identification information further comprising after step (b): said invalid withdrawal.

176. A system and method for defense ID-theft attack security service system in claim 174, wherein said valid withdrawal further comprising: being admitted to confirmed withdrawal data.

177. A system and method for defense ID-theft attack security service system in claim 175, wherein said invalid withdrawal further comprising: being admitted to denied withdrawal data.

178. A system and method for defense ID-theft attack security service system in claim 176, wherein confirmed withdrawal data further comprising: responding message with said respond type said confirmed withdrawal data is transmitted from said an AMPA device of user to third service system.

179. A system and method for defense ID-theft attack security service system in claim 178, wherein said third service system further comprising: (a) said payer's bank service system and (b) said security service system.

180. A system and method for defense ID-theft attack security service system in claim 179, wherein (a) said payer's bank service system further comprising: receiving responding message said confirmed withdrawal information said confirmed withdrawal data from said an AMPA device of user instead of stored withdrawal data in system database said withdrawal database of service system said payer's bank service system.

181. A system and method for defense ID-theft attack security service system in claim 179, wherein (b) said security service system further comprising: utilizing a determination device as part of service system said security service system to receive message said confirmed withdrawal information from said an AMPA device of user; and storing confirmed withdrawal information in system database said withdrawal database of service system said security service system; utilizing a determination device as part of service system said security service system to identify whether receipt information said confirmed withdrawal information is valid according to system database said AMPA device identity database and said signature database in service system said security service system; and issuing identification information; transmitting message to third service system in order to identification information; wherein third service system based on derived information said identification information to reflect operation; wherein identification information further comprising: (a) said valid confirmed withdrawal; (b) said invalid confirmed withdrawal; and (c) said resign signature information.

182. A system and method for defense ID-theft attack security service system in claim 181, wherein said security service system further comprising after step (a): saving valid confirmed withdrawal data from customer said AMPA device of user in system database said withdrawal database of service system said security service system.

183. A system and method for defense ID-theft attack security service system in claim 181, wherein said security service system further comprising after step (b): putting said AMPA device of user's name in black list said black list database of service system said security service system and transmitting alert message with black list in black list database of service system said security service system to third service system.

184. A system and method for defense ID-theft attack security service system in claim 181, wherein said security service system further comprising after step (c): transmitting message said resign withdrawal information to said an AMPA device of user.

185. A system and method for defense ID-theft attack security service system in claim 184, wherein an AMPA device of user further comprising: receiving message said resign withdrawal from service system said security service system and retransmitting confirmed receipt data with resign signature to third service system.

186. A system and method for defense ID-theft attack security service system in claim 177, wherein denied withdrawal information further comprising: responding withdrawal information said denied withdrawal information is transmitting by said an AMPA device of user to third service system said payer's bank service system.

187. A system and method for defense ID-theft attack security service system in claim 186, wherein said payer's bank service system further comprising: receiving denied withdrawal message from said an AMPA device of user; utilizing a determination device as part of service system said bank service system said payer's bank service system to verify whether denied withdrawal is valid according to data said withdrawal data in system database said withdrawal database of service system said bank service system said payer's bank service system; issuing identification information; and according to identification information to reflect operation; Wherein identification information further comprising: (a) said valid denied withdrawal information; and (b) said invalid denied withdrawal information;

188. A system and method for defense ID-theft attack security service system in claim 187, wherein said payer's bank service system further comprising after step (a): deleting data said withdrawal data from system database said withdrawal database of service system said bank service system said payer's bank service system;

189. A system and method for defense ID-theft attack security service system in claim 187, wherein said payer's bank service system further comprising after step (b): transmitting messages said complain message with evidence about withdrawal information said withdrawal data in system database said withdrawal database of service system said payer's bank service system to service system said security service system.

190. A system and method for defense ID-theft attack security service system for dealing with no respond information from said an AMPA device of user is at least one service system said bank service system said payer's bank service system and comprising: transmitting receipt data said withdrawal data with time T and wait for respond information said withdrawal data from said an AMPA device of user according to T be less than maximum T with no respond information; transmitting receipt data said withdrawal data to service system said security service system according to T be great then maximum T with no respond information.

191. A system and method for defense ID-theft attack security service system in claim 190, wherein said security service system comprising: transmitting receipt data said withdrawal data with time T and wait for respond information from said an AMPA device of user according to T be less than maximum T with no respond information; putting said an AMPA device of user's name in black list said black list database according to T be great then maximum T with no respond information; and transmitting alert message appending to black list to third service system according T be great then maximum T with no respond information.

192. A system and method for defense ID-theft attack security service system in claim 189, wherein said security service system further comprising: receiving message said complain message with said invalid denied withdrawal data from service system said bank service system said payer's bank service system; a determination device as part of service system said security service system identifies whether complain message is valid according to withdrawal data in system database said withdrawal database of service system said security service system; issuing identification information; transmitting message to third service system according to identification information; wherein third service system based on derived message of service system said security service system to reflect operation; wherein identification information comprising: (a) said valid complain message; and (b) invalid complain message.

193. A system and method for defense ID-theft attack security service system in claim 192, wherein said security service system further comprising after step (a): putting said customer said an AMPA device of user's name in black list database; and transmitting message said alert message appending to black list to third service system.

194. A system and method for defense ID-theft attack security service system in claim 192, wherein said security service system further comprising after step (b): transmitting message said invalid complain message with denied withdrawal data to third service system said bank service system said payer's bank service system.

195. A system and method for defense ID-theft attack security service system in claim 194, wherein payer's bank service system further comprising: receiving message said invalid complain message said valid denied withdrawal data from said security service system; and deleting withdrawal data in system database said withdrawal database of service system said bank service system said payer's bank service system.
